(19) United States
(12) Patent Application Publication
(10) Pub. No.: US 2009/0313853 A1
(43) Pub. Date: Dec. 24, 2009

(54) Method to capture and support a 3-D contour

(76) Inventor: Tony G. Tadin, Woodside, CA (US)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 12/214,498

(22) Filed: Jun. 19, 2008

(51) Int. Cl. A43B 7/22; A43B 7/16; A43B 13/38; A43B 23/28; B32B 3/08; A43B 7/14; A43B 7/18

(52) U.S. Cl. 36/91; 36/92; 36/44; 36/58.5; 156/62.2; 428/314.2; 428/317.9

(57) ABSTRACT

An insole for placement in or on an article of footwear to support all or a portion of a wearer's foot, comprising: a base shell support layer having an upper surface, wherein the base layer includes a heel support portion, a plurality of substantially rigid particles disposed on the heel support portion, and an upper layer, the upper layer overlying and being secured to the base layer, the upper layer overlying the particles and maintaining them in an area between the upper layer and the base layer.

### CROSS-REFERENCE TO RELATED APPLICATIONS

The present application is claiming priority of U.S. Provisional Patent Application Ser. No. 60/511,015, filed on Oct. 14, 2003, U.S. Provisional Patent Application Ser. No. 60/535,773, filed on Jan. 12, 2004, U.S. Provisional Patent Application Ser. No. 60/549,248, filed on Mar. 2, 2004, and U.S. patent application Ser. No. 10/965,666, filed on Oct. 14, 2004, the entire contents of each of which are herein incorporated by reference.

### BACKGROUND OF THE INVENTION

1. Field of the Invention

This invention relates to 3-D (three-dimensional) contour capturing and, more particularly, to a method and system for capturing and supporting a 3D contour of a subject object.

2. Description of the Related Art

In the prior art there are various known methods for capturing a 3D contour. However, the heretofore 3D capture systems do not provide an inexpensive, uncomplicated, clean, and accurate methodology for capturing the 3d contour of a subject item.

Therefore, there exists a need in many applications and contexts, such as but not limited to, the fields of customized seating, sleep surfaces, helmets, shipping containers, grips, foot supports, footwear and the like, where a 3D capture system overcoming the above-noted deficiencies would prove beneficial.

### SUMMARY OF THE INVENTION

A method and system for a 3-D (three-dimensional) capture system is provided. A three-dimensional (3-D) capture system embodiment of the present invention includes a flexible housing defining a substantially airtight reservoir therein, a plurality of particles disposed in the reservoir, a gas and/or liquid disposed in the reservoir, and a valve assembly in communication with the reservoir for regulating a quantity of the gas and/or liquid disposed in the reservoir.

In another embodiment of the present invention, regulating includes removal of at least a portion of the gas and/or liquid in response to pressure on the reservoir, and the housing substantially retains a contour formed by the pressure after the pressure is removed.

In another embodiment of the present invention, the particles are elastomeric.

In another embodiment of the present invention, the particles are solid.

In another embodiment of the present invention, the particles are spherical, cylindrical, and/or randomly shaped.

In another embodiment of the present invention, the particles are of a size from about 0.1 mm to about 10 mm.

In another embodiment of the present invention, the particles have more than one density.

In another embodiment of the present invention, the particles have more than one hardness.

In another embodiment of the present invention, the valve assembly includes a unidirectional valve to control a flow of the gas and/or liquid.

In another embodiment of the present invention, the unidirectional valve includes a bypass capability to allow the gas and/or liquid to be selectively reintroduced into the housing.

In another embodiment of the present invention, the system includes a plug to prevent leaks of the gas and/or liquid through the valve assembly.

In another embodiment of the present invention, the valve assembly includes two or more valves.

In another embodiment of the present invention, the valve assembly includes an output valve and an input valve.

In another embodiment of the present invention, the system includes an electronic control system to control an opening of the valve assembly.

In another embodiment of the present invention, the system includes a shielding layer to prevent damage to the control system due to static charges.

In another embodiment of the present invention, the electronic control system includes a processor and a battery.

In another embodiment of the present invention, the system includes a remote control device to activate the control system.

In another embodiment of the present invention, the control system is voice activated.

In another embodiment of the present invention, the system includes a heat sensor. The heat sensor activates the control system when the system exceeds a selected temperature to allow the gas and/or liquid to enter the housing and cool the housing.

In another embodiment of the present invention, the particles are doped with an adhesive.

In another embodiment of the present invention, the particles are lubricated with a high viscosity material.

In another embodiment of the present invention, the particles are anti-static.

In another embodiment of the present invention, at least a portion of the particles can be fused together by an appropriately calibrated energy source.

In another embodiment of the present invention, the energy source is selected from a heater and a microwave device.

In another embodiment of the present invention, the reservoir has opposing surfaces selectively bonded together by a barrier to form at least two partitions to limit a migration of the particles between the at least two partitions.

In another embodiment of the present invention, the gas and/or liquid is an adhesive, water, or air.

In another embodiment of the present invention, the housing includes at least one mid layer and an outer layer, wherein the at least one mid layer is disposed between the particles and the outer layer.

In another embodiment of the present invention, the mid layer is a mesh-type screen.

In another embodiment of the present invention, the housing forms a seating surface.

In another embodiment of the present invention, the seating surface is used in a chair, a wheelchair, a plane, a bicycle, a motorcycle, a train, an automobile, a bus, or a mattress topper.

In another embodiment of the present invention, the system includes a pump for pumping the gas and/or liquid.

In another embodiment of the present invention, the system includes a vacuum system for the gas and/or liquid.

In another embodiment of the present invention, the housing is configured to support a human foot.

In another embodiment of the present invention, the system is integral to footwear.

In another embodiment of the present invention, the system is integral to a helmet.

In another embodiment of the present invention, the system is integral to a gripping device.

In another embodiment of the present invention, at least a portion of the housing is elastic.

In another embodiment of the present invention, at least some of the particles are fibers

In another embodiment of the present invention, each of the at least two partitions are filled with particles having different characteristics.

In another embodiment of the present invention, the system includes pre-shaped sections in the reservoir for retaining subsets of the particles having differing binding characteristics. Each of the sections is connected to an individual valve assembly for selectively controlling a flow of the gas and/or liquid thereto.

In another embodiment of the present invention, the system includes pre-shaped sections in the reservoir. A barrier between adjoining partitions permits the flow of the gas and/or liquid therethrough.

In another embodiment of the present invention, the housing includes a footwear insole.

In another embodiment of the present invention, the housing includes a footwear midsole.

In another embodiment of the present invention, the housing includes a deformable mold.

In another embodiment of the present invention, the housing includes an erasable mold.

In another embodiment of the present invention, the housing includes a midsole or an insole. The housing has built-in supports and is filled with the particles for capturing a plantar foot impression.

In another embodiment of the present invention, the particles are lubricated, coated or treated with a tacky or sticky viscous lubricant, sealant or material having non-hardening, binding adhesive properties.

In another embodiment of the present invention, the particles have a Shore A hardness from about 10 to about 70.

In another embodiment of the present invention, the valve assembly has an end opening smaller than the particles.

In another embodiment of the present invention, the system includes a midsole cavity having a predetermined shape and support structure therein.

In another embodiment of the present invention, the system includes a midsole having a forward portion. The forward portion consists of about ⅓ of the midsole and has a lower cavity to limit an amount of particles distributed under a forefoot.

In another embodiment of the present invention, one or more areas of the housing are restricted from particle migration.

In another embodiment of the present invention, the housing includes an outlet for release of the gas and/or liquid.

In another embodiment of the present invention, the housing includes one or more holes to allow the gas and/or liquid to escape.

In another embodiment of the present invention, at least a portion of the particles are doped with a substance that can be fused together by applying an appropriately calibrated energy source.

In another embodiment of the present invention, the valve assembly has an end opening that includes a screen to prevent particles from entering the valve assembly.

In another embodiment of the present invention, the system includes an adhesive surface applied to the housing to reduce migration of the particles.

A method embodiment of the present invention for producing a custom support device includes disposing a subject item on a substantially air-tight housing that is partially filled with a plurality of particles and a gas and/or liquid, and removing at least a portion of the gas and/or liquid in the housing.

In another embodiment of the present invention, the method includes vibrating the housing.

A three-dimensional (3-D) capture system embodiment of the present invention includes a flexible housing defining a substantially airtight reservoir therein, a plurality of particles disposed in the reservoir, a volume of a gas and/or liquid disposed in the reservoir, a valve assembly in communication with the reservoir for regulating a quantity of gas and/or liquid in the reservoir, and vibrator for stimulating and distributing the particles to conform to a contour of a subject item.

A process embodiment of the present invention, for making a custom footwear from a positive foot contour, includes pre-loading loose particles into a midsole of the footwear, originating a vacuum line from within the footwear to a unidirectional air valve assembly terminating outside of the footwear, sealing the midsole airtight, placing a positive foot contour onto the midsole and pressing down firmly; and activating a vacuum system connected to the valve assembly to capture a form of the foot contour.

In another embodiment of the process of the present invention, at least a portion of the particles are fused together by an appropriately calibrated energy source.

In another embodiment of the process of the present invention, the energy source is selected from a heater and a microwave device.

A method embodiment of the present invention for producing a custom support device includes disposing a subject item on a substantially air-tight housing that is partially filled with a plurality of particles, and a gas and/or liquid, moving, forcibly, the subject item on a surface of the housing, and removing at least a portion of gas and/or liquid in response to the moving.

A midsole embodiment of the present invention for obtaining a contour impression, includes loose, distinct particles disposed in the midsole.

An insole embodiment of the present invention for obtaining a contour impression, includes loose, distinct particles disposed in the insole.

A three-dimensional (3-D) capture system embodiment of the present invention includes a flexible housing defining a substantially airtight reservoir therein, a plurality of particles disposed in the reservoir, and a gas and/or liquid disposed in the reservoir. The plurality of particles and the gas and/or liquid within the housing maintain a contour of a subject item forcibly placed on the housing.

In another embodiment of the present invention, the system includes a high viscosity substance to retain the plurality of particles in a substantially fixed position relative to one another.

In another embodiment of the present invention, the system includes a vibrator mechanism for stimulating the particles into a desired location.

A three-dimensional (3-D) capture system embodiment of the present invention includes a rigid or semi-rigid orthotic housing defining a substantially airtight reservoir therein, a plurality of particles disposed in the reservoir, a gas and/or liquid disposed in the reservoir, a valve assembly in communication with the reservoir for regulating a quantity of the gas and/or liquid disposed in the reservoir, and a vibrator for stimulating and distributing the particles to conform to a contour of a subject item.

A footwear device embodiment of the present invention includes a flexible housing defining a substantially airtight reservoir therein, a plurality of particles disposed in the reservoir, a gas and/or liquid disposed in the reservoir, a valve assembly in communication with the reservoir for regulating a quantity of the gas and/or liquid disposed in the reservoir, and a vibrator for stimulating and distributing the particles to conform to a contour of the footwear device to that of a subject item. The footwear device is a midsole or an insole.

In another embodiment of the footwear device of the present invention, the particles are beads and/or fibers.

A seating device embodiment of the present invention includes a flexible housing defining a substantially airtight reservoir therein, a plurality of particles disposed in the reservoir, a gas and/or liquid disposed in the reservoir, and a vacuum pump connected to the flexible housing for selectively removing at least a portion of the gas and/or liquid from the reservoir.

In another embodiment of the present invention, the seating device includes a valve in communication with the reservoir for selectively sealing a flow of the gas and/or liquid to/from the reservoir.

In another embodiment of the present invention, the seating device includes a controller for controlling operation of the vacuum pump.

In another embodiment of the seating device of the present invention, the controller includes a timer.

In another embodiment of the seating device of the present invention, the controller controls a direction of air flow for the vacuum pump.

In another embodiment of the seating device of the present invention, the controller causes the vacuum pump to reverse the direction of air flow.

In another embodiment of the seating device of the present invention, the controller controls the direction of airflow according to a programmed, predetermined sequence of vacuuming events.

In another embodiment of the seating device of the present invention, the controller controls the direction of airflow according to a manual input.

In another embodiment of the seating device of the present invention, the vacuum pump operates in response to a manual input.

In another embodiment of the present invention, the seating device includes a plurality of flexible housings connected to the vacuum pump.

In another embodiment of the present invention, the seating device includes a heat sensor. The controller causes the gas and/or liquid to flow into the housing when the heat sensor detects a temperature in the housing that exceeds a selected temperature.

A seating device embodiment of the present invention includes a flexible housing defining a substantially airtight reservoir therein, a plurality of particles disposed in the reservoir, a gas and/or liquid disposed in the reservoir, and a valve assembly connected to the flexible housing for selectively removing at least a portion of the gas and/or liquid from the reservoir.

In another embodiment of the seating device of the present invention, the valve assembly has an end opening that includes a screen to prevent particles from entering the valve assembly.

In another embodiment of the present invention, the seating device includes a valve in communication with the reservoir for selectively sealing a flow of the gas and/or liquid to/from the reservoir.

In another embodiment of the present invention, the seating device includes a controller for controlling operation of the valve system.

In another embodiment of the seating device of the present invention, the controller includes a timer.

In another embodiment of the seating device of the present invention, the valve system operates in response to a manual input.

In another embodiment of the present invention, the seating device includes a plurality of flexible housings connected to the valve system.

In another embodiment of the present invention, the seating device includes a heat sensor. The controller causes the gas and/or liquid to flow into the housing when the heat sensor detects a temperature in the housing that exceeds a selected temperature.

A three-dimensional (3-D) capture system embodiment of the present invention includes a flexible housing defining a substantially airtight reservoir therein, a plurality of particles disposed in the reservoir, and a liquid and/or gas disposed in the reservoir. At least a portion of the gas and/or liquid is selectively removed from the reservoir for capturing a 3-D impression of a subject item.

In another embodiment of the present invention, the 3-D capture system includes a midsole having an elevated air vacuum line in communication with the reservoir for permitting an escape of at least a portion of the gas and/or liquid from the reservoir in response to the subject item being disposed on the 3-D capture system.

In another embodiment of the 3-D capture system of the present invention, the gas and/or liquid is permitted to flow through the elevated air vacuum line in only one direction.

In another embodiment of the 3-D capture system of the present invention, the gas and/or liquid is permitted to flow through the elevated air vacuum line in both a forward and a reverse direction.

In another embodiment of the 3-D capture system of the present invention, the vacuum line is connected to a manual check valve for output of the gas and/or liquid, and an additional line for input of the gas and/or liquid.

In another embodiment of the 3-D capture system of the present invention, the 3-D capture system includes a flap integrated into the elevated air vacuum line to selectively permit gas and/or liquid to flow through the elevated air vacuum line.

In another embodiment of the 3-D capture system of the present invention, the 3-D capture system includes a seating device.

A footwear device embodiment of the present invention includes a flexible housing defining a substantially airtight reservoir therein, a plurality of particles disposed in the reservoir, a gas and/or liquid disposed in the reservoir, and a supplemental reservoir housing a supplemental gas and/or liquid supply therein. The gas and/or liquid is selectively removed from the reservoir and the supplemental reservoir provides at least a portion of the supplemental gas and/or liquid supply to the reservoir. The footwear device is a midsole or an insole.

In another embodiment of the present invention, the footwear device includes a supplemental gas and/or liquid disposed in the supplemental reservoir.

A gripping device embodiment of the present invention includes a flexible housing defining a substantially airtight reservoir therein, a plurality of particles disposed in the reservoir, a gas and/or liquid disposed in the reservoir, and a valve assembly in communication with the reservoir for regulating a quantity of the gas and/or liquid disposed in the reservoir.

In another embodiment of the gripping device of the present invention, the valve assembly includes a valve for permitting the removal of at least a portion of the gas and/or liquid disposed in the reservoir.

In another embodiment of the gripping device of the present invention, the valve assembly is connected to a source of vacuum.

In another embodiment of the present invention, the gripping device includes a layer of memory intensive material disposed about the housing.

In another embodiment of the gripping device of the present invention, the housing is disposed about a handle of an athletic tool.

In another embodiment of the gripping device of the present invention, the gripping device is adapted for use with a golf club, a baseball bat, a racquet, a pole, a steering wheel, a handlebar, a firearm handle, a power tool, or a hand tool.

In another embodiment of the gripping device of the present invention, the valve assembly has an end opening that includes a screen to prevent particles from entering the valve assembly.

A method embodiment of the present invention for producing a customized handle grip includes disposing a user's hand on a substantially air-tight housing that is partially filled with a plurality of particles, and a gas and/or liquid, applying pressure to the housing with the hand, and removing at least a portion of the gas and/or liquid in the housing.

In another embodiment of the present invention, the method includes removing the hand. A contour of the hand is retained on the housing.

In another embodiment of the present invention, the method includes vibrating the housing.

In another embodiment of the method of the present invention, removing at least a portion of the gas and/or liquid is accomplished by the pressure of the hand.

In another embodiment of the method of the present invention, removing at least a portion of the gas and/or liquid is accomplished at least by a vacuum pump.

An object of this disclosure is to provide insoles/midsoles for placement in or on an article of footwear to support all or a portion of a wearer's foot. The insole/midsole permits adaptation and customization of the insole/midsole to the wearer's foot. The insole/midsole preferably has built-in and/or molded-in anatomical contours which preferably can dynamically support, for example, an arch portion of the foot. The contour gives or extends downward under body weight, foot profile and pressure, and can be adapted to recover, rebound or spring upward and return to its initial contour.

Another object of this disclosure is to provide insoles/midsoles for placement in or on an article of footwear to support all or a portion of a wearer's foot wherein one or more of the anatomical upwardly extending contours can be tailored to the wearer's weight, foot profile and expected activities. For example, supports, cushions, posts or pads of various strengths or resistances can be secured to the under surface of the anatomical contour to tailor the arch support to the wearer's needs.

Another object of the disclosure is that the insole/midsole includes beads or particles, preferably semi-rigid, to provide the support to all or a portion or portions of the wearer's foot. The insole/midsole includes a base shell support layer, often referred to as a base layer, that has a heel support portion and, depending on the foot length of the insole/midsole, preferably also has any one or combination of arch support portions, that is, a transverse arch support portion, a medial arch support portion, a lateral arch support portion, and a metatarsal arch support portion. In accordance with the disclosure, the base shell support layer preferably is semi-rigid, although it can be flexible or rigid. The particles can be disposed directly or indirectly on the heel support portion, to support the heel, or to form, support, adapt or customize the any one or combination of the aforementioned arch support portions. The particles can form the anatomical arch support contour or they can approach, be adjacent, or partly or fully cover a, e.g., molded-in, domed, arch support. Generally, given a sufficient thickness, the more rigid the base layer, the less the need for support of anatomical contouring with particles or otherwise.

In accordance with the disclosure, the disposition of particles “on” the base shell support layer or on a portion thereof, including e.g., on the heel support portion, can include a disposition that is “about” the portion. Thus, a disposition “on”, like a disposition “about” can include a disposition around or along all or a portion of the base shell support layer or its peripheral area.

Another object of the disclosure is to secure particles to the heel support portion of the insole/midsole and dispose thereover additional particles that preferably have been coated or doped with a tacky or sticky viscous lubricant, sealant or material to allow the coated particles, when subjected to initial foot pressure, to migrate radially outward and upward and conform to the wearer's foot. The tacky or sticky viscous lubricant, sealant or material has adhesive properties. It acts as a non-hardening, binding adhesive to hold the additional particles to the secured particles. The particles can be provided to or disposed on the heel support portion in a flexible package that can be secured to the heel support portion.

Another object of this disclosure is to provide the above-mentioned and/or other insoles/midsoles of various lengths, for example, full foot length, or ⅔rds or ⅓^{rd} foot length, the latter, for example, as heel cups.

The above and other objects and advantages of the present disclosure are provided by an insole/misole for placement in or on an article of footwear to support all or a portion of a wearer's foot, comprising: a base shell support layer, preferably semi-rigid, having an upper surface, wherein the base layer includes a heel support portion, a plurality of substantially rigid particles disposed on the heel support portion, and an upper layer, the upper layer overlying and being secured to the base layer, the upper layer overlying the particles and maintaining them in an area between the upper layer and the base layer. In accordance with this disclosure, to “maintain” broadly means to keep, hold or retain in a particular area.

The heel support portion can include a central area, a peripheral area substantially surrounding the central area, and a peripheral wall substantially surrounding the peripheral area. In some embodiments, the plurality of particles can be disposed on the peripheral area of the heel support portion. The base layer can include, forward of the heel support portion, any one or combination of a transverse arch support portion, a medial arch support portion, a lateral arch support portion, and a metatarsal arch support portion, and the plurality of particles can instead or also be disposed on the any one or combination of arch support portions. Any one or combination of the arch support portions can have a built-in or molded-in anatomical contour. One or more supports can be mounted to the undersurface of the base layer in the area of the transverse arch support. Some of the plurality of particles are disposed directly on the peripheral area of the heel support portion and are adhered to the heel support portion, and some of the plurality of particles disposed on the peripheral area are coated with a tacky or sticky viscous lubricant, sealant or material and are disposed on or over and held or secured to the plurality of particles that are adhered to the heel support portion.

The base shell support layer can be comprised of a polyolefin, and a suitable length of one or both of its upper and lower surfaces can be covered with a cloth layer that is coated with a fiberglass resin. For example, a full length base support layer may have only the rear ⅔rds of its length coated with fiberglass, leaving the forward ⅓^{rd} uncoated to allow that portion to flex. The peripheral wall of the base layer can include one or more small air vent holes therethrough. The peripheral wall can be substantially vertical or disposed at from about 90 degrees to about 110 degrees relative to the upper surface of the heel support portion of the base layer. The peripheral wall of the upper layer extends upwardly and preferably has an upper edge that is higher than the upper edge of the peripheral wall of the base layer.

The upper layer of the insole/midsole has a heel support portion with a bottom wall and an upwardly extending peripheral wall that has or have a radius of curvature such that it is or they are bowl-shaped when viewed in vertical section. The substantially vertical peripheral wall of the base layer and the bowl shape of the bottom wall and/or peripheral side wall of the upper layer preferably are secured together to form a cavity therebetween. The peripheral wall of the heel support portion can include a plurality of small air holes open to ambient atmospheric pressure and which communicate with the cavity. The peripheral area can have particles disposed thereon in a substantially C-shaped pattern, with the open portion of the C-shape facing toward the metatarsal arch support portion of the insole. Alternatively, the particles can be disposed thereon in an annular shape.

Objects and advantages of the disclosure are also provided by an insole of the disclosure comprising: a base shell support layer having an upper surface, wherein the base layer includes one or a combination of a heel support portion, a medial arch support portion, a lateral arch support portion, and a metatarsal arch support portion, a plurality of particles disposed on any one or combination of the arch support portions of the base layer. The insole can have and a semi-flexible upper layer having a bottom surface that overlies and is secured to the base layer, the upper layer overlying the particles and maintaining them in an area between the upper layer and the base layer.

The particles can be selected from the group consisting of rigid, substantially rigid, semi-rigid, and resilient. Preferably, the plurality of particles are substantially rigid, they are disposed on the peripheral area of the heel support portion, there is included a transverse arch support portion and there is a smooth transition from the particles of the peripheral area to the transverse arch support portion. The smooth transition can be provided in several ways, for example, by a tape in contact with the forward area of the particles. The particles can also be disposed on the heel support portion and they can extend forward along the longitudinal axis of the base layer and cover the metatarsal arch support portion to either side of the longitudinal axis of the base layer.

The any one or combination of arch support portions of the base layer can have a built-in or molded-in raised domed contour. The particles disposed on the peripheral area of the heel support portion can be contained in a flexible package that resembles the peripheral area of the heel portion, to facilitate disposition of the particles in the periphery of the heel portion.

Objects of the disclosure are provided by heel cups for placement in or on an article of footwear. The heel cup can comprise: a base shell support layer having an upper surface and having a heel support portion in turn having: a central area, a peripheral area substantially surrounding the central area, and a peripheral wall surrounding a portion of the peripheral area, a plurality of particles disposed on and held to the peripheral area of the heel support portion, and an overlayer secured to the base layer and overlying the plurality of particles in at least the peripheral area of the heel support portion and maintaining the plurality of particles in an area between the overlayer and the base layer. The central area can include a resilient support pad having an upper adherent layer and having a bottom surface that is adhered to the upper surface of the central area. The heel cup preferably is ⅓rd the length of the wearer's foot. According to the disclosure, the base shell support layer of heel cups of the disclosure preferably is semi-rigid, although it can be flexible.

Objects of the disclosure are provided by an insole of the disclosure, wherein the base layer upper surface includes one or more built-in anatomical contours to support the wearer's foot, a plurality of particles is disposed directly or indirectly on the upper surface of the base layer, and the plurality of particles are selectively disposed and provide the one or more built-in anatomical contours, including a built-in peripheral heel support portion, any one or combination of a built-in transverse arch support portion, a built-in medial arch support portion, a built-in lateral arch support portion, and a built-in metatarsal arch support portion, and wherein one or more of these built-in support portions is or are provided by the particle-provided built-in anatomical contours.

Objects of the disclosure are provided by an insole of the disclosure, wherein the base layer upper surface includes one or more built-in, molded anatomical contours to support the wearer's foot, a plurality of substantially rigid particles disposed directly or indirectly on the upper surface of the base layer, including on or adjacent the one or more built-in, molded anatomical contours, and wherein the selectively disposed plurality of particles customize the one or more built-in molded anatomical contours. The plurality of particles can be selectively disposed on and customize the built-in molded peripheral heel support portion. One or more supports can be added to the bottom surface of the base shell under the one or more the built-in anatomical contours to strengthen the built-in anatomical contours. The one or more supports can be a solid material to prevent compression of the one or more built-in anatomical contours imparted by downward pressure of the wearer's foot. Alternatively, the one or more supports can be a semi-flexible material applied to selectively control the amount of compression, by allowing some but limited compression. One or more supports can be added to the bottom surface of the base shell under the any one or combination of the built-in molded anatomical contours to strengthen the built-in molded anatomical contours.

Objects of the disclosure are provided by a flexible package for containing a plurality of particles, comprising: a main body comprised of a flexible film and having a substantially annular-shape when seen in top plan view, the main body having a channel running therethrough for containing the plurality of particles. The channel can be triangularly or substantially triangularly shaped when viewed in vertical section.

Objects of the disclosure are provided by a heel cup for placement in or on an article of footwear, comprising a flexible package whose channel contains particles and whose main body is disposed on the peripheral area of the heel support portion.

The peripheral wall of the base layer around the periphery of the heel support portion of the insole or heel cup can be from about ⅝ inch to about 1¼ inch, and the height of the peripheral wall of the upper layer around the same area can be from about 1 inch to about 1½ inch.

Objects of the disclosure are provided by an insole comprising a base shell support layer having an upper surface, and a heel support portion that includes a central area, a peripheral area substantially surrounding the central area, and a peripheral wall substantially surrounding the peripheral area. The base layer includes, forward of the heel support portion, any one or combination of a transverse arch support portion, a medial arch support portion, a lateral arch support portion, and a metatarsal arch support portion. The insole has a plurality of particles disposed on the any one or combination of arch support portions. The insole has an upper layer overlying and secured to the base layer, the upper layer overlying the particles and maintaining them in an area between the upper layer and the base layer. In an insole of the disclosure having particles on the any one or combination of arch support portions, the peripheral area of the heel support portion can include a cushion of gel or air.

The disclosure includes methods of forming insoles/midsoles for placement in or on an article of footwear to support all or a portion of a wearer's foot, comprising: providing a base shell support layer having an upper surface that includes a heel support portion, disposing a plurality of particles, preferably substantially rigid or semi-rigid particles, on the heel support portion, securing at least a portion of the plurality of particles directly or indirectly to the heel support portion, providing a flexible upper layer that is sized to fit within the base shell support layer, and securing the upper layer to the base layer in a manner that includes maintaining the particles in an area between the upper layer and the base layer. The providing of the base shell support layer can include providing the heel support portion with a central area, a peripheral area substantially surrounding the central area, and a peripheral wall substantially surrounding the peripheral area, and disposing the plurality of particles on the peripheral area of the heel support portion. The providing of the base shell support layer can include providing a single cloth layer secured to one surface, or two cloth layers, one secured to the upper surface and the other secured to the lower surface of the base layer, and coating the upper and/or lower surface cloth layer(s) with a fiberglass resin. The step of securing at least a portion of the particles directly or indirectly to the heel support portion can be effected by applying a tacky or sticky viscous lubricant, sealant, or material that is non-hardening, and has binding adhesion properties to the particles and/or to the heel support portion, or by providing the particles in a flexible package shaped like the peripheral area, and securing the flexible package to the peripheral area of the heel support portion.

The disclosure also includes methods for custom fitting an insole for placement in or on an article of footwear to support a wearer's foot, comprising: providing a base shell support layer having an upper surface and an undersurface, the upper surface including a heel support portion with a peripheral area, and the undersurface including any one or combination of upwardly extending molded-in convex anatomically contoured arch support portions to support the arch portions of the wearer's foot. These methods include modifying the upper surface of the base layer by disposing a plurality of particles on the peripheral area of the heel support portion, securing a first portion of the plurality of particles directly or indirectly to the peripheral area of the heel support portion, and disposing a second portion of the plurality of the particles onto the first portion of the particles, the second portion of particles being coated or doped with a tacky or sticky viscous lubricant, sealant or material having non-hardening, binding adhesive or adhesion properties, to allow the second portion of particles to migrate to fit the contour of the wearer's heel upon the application of heel pressure onto the plurality of disposed particles, to hold the migrated particles in position to conform to and custom fit the heel support portion to the heel of the wearer's foot. These methods can also include modifying the undersurface of the base layer by securing one or more supports to the undersurface(s) of the any one or combination of upwardly extending molded-in convex anatomically contoured arch support portions of the base layer, to selectively support, strengthen and custom fit the molded-in anatomically contoured arch support portions to the one or more contours of the arch portions of the wearer's foot. In these methods, the plurality of particles preferably are substantially rigid and the base shell support layer preferably is semi-rigid.

Further objects, features and advantages of the present disclosure will be understood by reference to the following drawings and detailed description.

### BRIEF DESCRIPTION OF THE DRAWINGS

FIG. 1 is a top perspective view of an exemplary device, e.g., a sandal, including innnersole, i.e. insole, having beads disposed therein in accordance with the teachings herein;

FIG. 2 is a top perspective view of the sandal of FIG. 1 wherein one-half of the innersole having beads disposed therein is exposed;

FIG. 3 is a top view of the sandal of FIG. 1 wherein the innersole and beads therein are sealed within a top liner;

FIG. 4 is a top view of the sandal of FIG. 1 including a foot whose contour is to be measured and a gas removal system;

FIG. 5 is a top view of the sandal of FIG. 1 including a foot whose contour has been measured

FIG. 6 is a top perspective view of an innersole in accordance with the teachings herein located on a vibrator;

FIG. 7 is a perspective view of an innersole, in accordance with the teachings herein, showing the beads disposed therein partially exposed and a vacuum line attached;

FIG. 8 is a top perspective view of an innersole having captured a 3-D contour therein, in accordance with the teachings herein;

FIG. 9 is a top view of an innersole located on a vibrator, in accordance with the teachings herein;

FIG. 10 is another view of an innersole located on a vibrator, in accordance with the teachings herein;

FIG. 11 is a top view of an innersole located on a vibrator and having exposed beads disposed in the innersole, in accordance with the teachings herein;

FIG. 12 is a side perspective view of an innersole located on a vibrator and having exposed beads disposed in the innersole, in accordance with the teachings herein;

FIG. 13 is a top view of an exemplary vacuum line and associated filter disposed in an innersole;

FIG. 14 is a top view of an innersole having multiple types of beads disposed in the innersole thereof, the multiplicity of types of beads separated by a barrier;

FIG. 15 is a side respective view of an innersole having multiple vacuum lines attached thereto, in accordance with the present teachings;

FIG. 16 illustrates a shoe midsole having a valve system comprising a multi-point distribution layout; and

FIG. 17 discloses an elevational view of a midsole having an elevated air vacuum line to guard against foreign objects entering into the air vacuum line.

FIG. 18 depicts a perspective view of an exemplary insole having a dual valve system. Note that no 3-D impression is “locked” or captured by the insole.

FIG. 19 depicts a perspective view of the exemplary insole of FIG. 18 with a 3-D impression of a foot captured or “locked” by the insole having the dual valve system.

FIG. 20 is a perspective view of the exemplary insole with a 3-D impression of a foot captured or “locked” by the insole having the dual valve system.

FIG. 21 is a detailed view of the exemplary insole of FIG. 20, more clearly illustrating the dual valve system.

FIGS. 22A and 22B depict the inside midsole with valve and air line shows valve outlet on outerside of arch with open close air with flap system.

FIG. 23 depicts a contoured midsole with particles inside, valves attached, contour impression locked with foot resting in the impression.

FIG. 24 depicts a midsole container with foam particles inside.

FIG. 25A depicts a midsole bottom with electronic processor controls and mechanical valve control for air flow with battery power. FIG. 25B depicts remote control. It may be voice controlled or by hand.

FIG. 26 depicts the a midsole container with a bead particle injector.

FIG. 27 depicts a midsole container with a bead particle injector.

FIG. 28 depicts a midsole container with beads inside with a mid liner cover.

FIGS. 29A and 29B depict inner midsole bottom coated with sticky, adhesive material.

FIG. 30 depicts a midsole container with partitions having sections with a sticky, adhesive surface.

FIGS. 31A and 31B depict a ⅔ long orthotic with valves attached.

FIGS. 32A and 32B depict pre shaped contouring of a midsole/insole container.

FIG. 33 depicts a midsole/insole with placement of resilient material under the heel and forefoot ball.

FIG. 34 depicts a midsole with the toe end filled in with solid filler.

FIG. 35 is a perspective view of an exemplary seat cushion having a dual valve system.

FIG. 36 depicts a perspective view of the exemplary seat cushion of FIG. 35 with a subject object located thereon.

FIG. 37 is a detailed perspective view of the exemplary seat cushion of FIG. 35 with the subject object thereon.

FIG. 38 is a perspective view of an exemplary seat cushion having a dual valve system.

FIG. 39 depicts an exemplary seating cushion interfaced with a vacuum compressor via a supply hose.

FIG. 40 depicts an exemplary seating cushion employing any one of the 3-D impression systems discussed herein, interfaced with a vacuum compressor via a supply hose.

FIG. 41 depicts the exemplary seat cushion of FIG. 39, after the subject object has forced a certain volume of the gas from the seat cushion.

FIG. 42 shows a golf club having a hand grip loaded with particles and a volume of liquid and/or gas therein positioned on a golf club shaft.

FIG. 43 shows a golf club wherein the valve is located at a position along the shaft of the golf club.

FIG. 44 shows an exemplary golf club with the club head centered to a ground reference mark, and the shaft angle to the ground and to the club holder.

FIG. 45 depicts an exemplary view of the golf club connected to a vacuum compressor supply line at the proximal end of the golf club shaft.

FIG. 46 depicts a schematic of a manual mechanical pump for removing air from the hand grip. The valve may be a one-way check valve.

FIG. 47 depicts a schematic of the hand grip connected to a vacuum compressor connected to the hand grip for removing air from the hand grip.

FIG. 48 depicts a conventional golf club grip handle.

FIG. 49 depicts both a conventional golf club grip handle and the grip handle hereof that provides a 3-D impression of a user's proper, aligned hand position.

FIG. 50 depicts an exemplary grip handle hereof, including a detailed view of the two thumb reference marks thereon.

FIG. 51 depicts an exemplary grip handle hereof, including a detailed view of the upper thumb reference mark and the vacuum compressor supply line connection.

FIG. 52 depicts a baseball bat having a handle end thereof fitted with a grip handle of the present teachings.

FIG. 53 depicts the baseball bat of FIG. 52, with a locked 3-D impression in the grip handle.

FIG. 54 depicts the baseball bat of FIG. 52, juxtaposed with the hand of a user to illustrate the custom fit obtained by the personalized grip handle hereof.

FIG. 55A depicts a midsole including an opening for release of excess particles. FIG. 55B depicts the midsole of FIG. 55A including a valve system.

FIG. 56 is a bottom perspective view with portions broken away that depicts an insole container having a support portion.

FIG. 57 is a top front side perspective view of a full length midsole having a full length laminated particle sheet.

FIG. 57A is a top side perspective view of a particle sheet that includes support pads at the heel and forefoot sections of the sheet.

FIG. 57B is a top side perspective view of a particle sheet having a top layer about to be secured thereto.

FIG. 58 is a top front side perspective view of a midsole that includes a combination of a ⅔rds foot length laminated particle sheet and a forefoot section and toe section filled with particles.

FIG. 59 is a top front side perspective view of a midsole embodiment with a particle sheet folded away from an exposed base shell support layer or base layer.

FIG. 60 is a top perspective view of an embodiment of a midsole comprised of base layer, particles in its heel peripheral and arch sections, metatarsal support pads, a slip layer and a folded-away top layer.

FIG. 61 is a top side perspective view of an embodiment of an insole comprised of a ⅔ foot length base layer with a full length top layer.

FIG. 62 is a top forward side perspective view of an embodiment of a full length base layer for an insole and having built-in arch and metatarsal contours.

FIG. 63 is a bottom side perspective view of the base layer of FIG. 62.

FIG. 64 is a bottom plan view of an embodiment of the base layer of FIGS. 62 and 63 having an air valve and a plugged air line extending through the side wall of the medial arch.

FIG. 65 is a top perspective view of the base layer of FIG. 62 having particles disposed in the heel, arch and metatarsal support areas.

FIG. 66 is a top side perspective view of the base layer of FIG. 65 having the forefoot of a top layer secured to the forefoot of the base layer.

FIG. 67 is a top side perspective view of a finished insole/midsole as would be formed from a partly finished embodiment such as the insole of FIG. 66.

FIG. 68 is a bottom perspective view of an embodiment of a full length base layer of FIG. 62 having an extra support patch (dark area) added to the outer bottom metatarsal and cupoid arch support areas.

FIG. 69 is a bottom perspective view of an embodiment of a base layer of FIG. 62 having an extra support medial heel patch (dark area) secured to the outer bottom surface of the heel support portion of the base layer.

FIG. 70 is a bottom plan view of an embodiment of a base layer of FIG. 62 having extra support in the form of a patch (dark area) secured to the outer bottom surface of the metatarsal support area of the base layer.

FIG. 71 is a bottom perspective view of an embodiment of a base layer of FIG. 62 having an extra support in the form of a patch (dark area) secured to the outer bottom surface of the base layer under its first metatarsal head support portion.

FIG. 72 is a top perspective view of a ⅔ length insole or orthotic base shell support layer having particles disposed on substantially the entirety thereof.

FIG. 73 is a view similar to that shown in FIG. 72, but showing more particles disposed on the base shell support layer.

FIG. 74 is an elevated front perspective view of an embodiment of a finished ⅔rds foot length contoured orthotic insole with an extension for the big toe.

FIG. 75 is a top perspective view of an embodiment of a contoured base layer of the invention.

FIG. 76 is a rear side perspective view the bottom surface of an embodiment of a full foot length contoured base layer for an insole or orthodic.

FIG. 77 is a rear perspective view of the bottom surface an embodiment of a full foot length contoured top layer for an insole or orthotic.

FIG. 78 is a top plan view of an embodiment of a full foot length insole or orthotic, formed from the contoured base and top layers of FIGS. 76 and 77.

FIG. 79 is a top plan view with portions broken away showing particles being added to or removed from a base layer through a hole in the peripheral wall of the base layer.

FIG. 80 is a top perspective view with portions broken away showing particles being added to or removed from an insole through an opening in the peripheral wall of the insole.

FIG. 81 is a top plan view of the interior of a base shell layer of a ⅔rds insole orthotic having particles disposed thereon, and of the bottom surface of an aligned overlayer.

FIG. 82 is a top perspective view of the bottom surface of a full foot length overlayer resting on and across a base layer.

FIG. 83 is a top side perspective view showing the forefront portion of a full foot length upper or top layer adhered to the corresponding underlying portion of a base layer.

FIG. 84 is a side elevated perspective vertical cross sectional view as would be seen along the longitudinal axis of an embodiment of a full foot length insole or midsole of the disclosure.

FIG. 85 is a front perspective view of a vertical section taken across the heel support portion of the insole of FIGS. 83 and 84.

FIG. 86 is a front perspective view of a vertical section taken across the arch support portion of an embodiment of an insole.

FIG. 87 is a front perspective view of a vertical section taken across the heel support portion of an embodiment of an insole according to this disclosure.

FIG. 88 is a plan view of the bottom of an embodiment of a full length insole.

FIG. 89 is a side perspective view of an embodiment of a ⅔rds length orthotic with particles sealed inside and with anatomical contours built-in.

FIG. 90 is a top side perspective view of the bottom surface of an embodiment of a full length insole/midsole of the disclosure.

FIG. 91 is an upper front side perspective view of an embodiment of a full length insole of the disclosure having a dual hardness top layer.

FIG. 92 is an upper side perspective view of the bottom surface the full length dual hardness top layer of the insole shown in FIG. 91.

FIG. 93 is a top perspective view of an embodiment of a finished insole/orthotic as an article of footwear in accordance with the disclosure.

FIG. 94 is a top perspective view of an embodiment of a finished insole/orthotic or midsole as an article of footwear in accordance with the disclosure.

FIG. 95 is a front perspective view of an embodiment of a ⅔rds length base shell support layer, partially filled with particles in accordance with this disclosure.

FIG. 96 is an upper side rear perspective view of the bottom surface of an embodiment of a particle containing full length insole/orthotic in accordance with this disclosure.

FIG. 97 is an upper side perspective view of the upper surface of the finished full length insole/orthotic shown in FIG. 96.

FIG. 98 is a plan view of the bottom surface of an embodiment of a particle-containing ⅔rds length insole/orthotic in accordance with this disclosure.

FIG. 99 is an elevated front perspective view of an embodiment of a particle-containing ⅔rds length insole/orthotic in accordance with this disclosure.

FIG. 100 is a top perspective view of the bottom surface of an embodiment of a particle containing full length base support shell layer in accordance with this disclosure.

FIG. 101 is an elevated side perspective view of the inside surface of an embodiment of a particle containing full length base support shell layer in accordance with this disclosure.

FIG. 102 is a top perspective view of an embodiment of a particle containing base layer for forming a ⅔rds heel cup in accordance with this disclosure.

FIG. 103 is a schematic sketch of a vertical section as would be taken through an embodiment of a support pad for the heel support portion of an embodiment of a base layer of this disclosure.

FIG. 104 is a top side perspective view of an embodiment of a particle containing ⅔rds length base layer 7402 for a heel cup of the disclosure.

FIG. 105 is a top plan view of another embodiment of a particle-containing ⅔rds length insole/midsole or heel cup of the disclosure.

FIG. 106 is a top perspective view of another embodiment of a particle containing base layer for forming a ⅔rds length insole/midsole or heel cup of the disclosure.

FIG. 106A is a front perspective view of a base support shell or layer as might be employed in a method of the disclosure.

FIG. 106 B is a perspective view of a base layer as was shown in FIG. 106A, after another step in a method of forming an insole/midsole of the disclosure.

FIG. 106C is a front perspective view of the base layer of FIG. 106B after performance of another step in a method of forming an insole/midsole of the disclosure.

FIG. 106D is a front perspective view of the base layer of FIG. 106C after performance of another step in a method of forming an insole/midsole of the disclosure.

FIG. 106E is a front perspective view of the base layer of FIG. 106D after performance of another step in a method of forming an insole/midsole of the disclosure.

FIG. 107 is a top side perspective view of an embodiment of a particle heel support assembly or unit in accordance with this disclosure.

FIG. 107A is a vertical sectional view with portions broken away as would be seen along line 107A-107A through the particle heel support unit of FIG. 107.

FIG. 108 is a top perspective view of another embodiment of a particle support unit in accordance with this disclosure.

FIG. 108A is a vertical sectional view with portions broken away as would be seen along line 108A-108A of FIG. 108.

FIG. 108AA is a vertical sectional view with portions broken away as would be seen if taken through another embodiment of a heel support assembly or unit in accordance with this disclosure.

108AAA is a schematic end elevational view of another embodiment of a heel support assembly or unit in accordance with this disclosure.

FIG. 108B is a top side perspective view of an embodiment of a heel support assembly or unit in accordance with this disclosure.

FIG. 108C is an elevated front perspective view of the embodiment of the heel support assembly or unit shown in FIG. 108B.

FIG. 109 is a top plan view of an embodiment of a full length particle containing base layer (on the left side), and of the top surface of a full length top layer (on the right side), each in accordance with this disclosure.

FIG. 110 is a top plan view of the base layer of FIG. 109 (on the left side) and of the bottom surface of a full length top layer (on the right side), each in accordance with this disclosure.

FIG. 111 is a top plan view of an embodiment of a ⅔rds length particle containing base layer (on the left side), and of the top surface of a full length top layer (on the right side), each in accordance with this disclosure.

FIG. 112 is a top plan view of the base layer of FIG. 111 (on the left side) and of the bottom surface of the full length top layer (on the right side), each in accordance with this disclosure.

FIG. 113 is a top plan view of an embodiment of a finished full length insole/midsole having a cloth top layer.

FIG. 114 is a top perspective view of an embodiment of a finished full length insole/midsole having a resilient top layer.

FIG. 115 is a top plan view of an embodiment of a flexible package in accordance with this disclosure.

FIG. 116 is a split front elevational view with portions broken away of the package of FIG. 115.

FIG. 117 is a side elevational view with portions broken away of the package of FIG. 115 as would be seen along line 117-117 of FIG. 116.

FIG. 118 is a side elevational view with portions broken away of the package of FIG. 115 as would be seen along line 118-118 of FIG. 116.

FIG. 119 is a schematic front elevational view through the left arm of an empty package like that shown in FIG. 115.

FIG. 120 is a schematic front elevational view of the package of FIG. 115 having particles therein.

FIG. 121 is a schematic front elevational view of the package of FIG. 120 having particles exiting or entering an opening at the top of the package.

FIG. 122 is a schematic front elevational view like that of FIG. 121 but modified.

FIG. 123 is a top plan view of an embodiment of a ⅔rds length base support layer of the disclosure.

FIG. 123A is a top perspective view of the bottom surface of an embodiment the top layer of a full length insole/midsole of the disclosure.

FIG. 123AA is a top perspective view of the bottom surface of another embodiment of a top layer of a full length insole/midsole of the disclosure.

FIG. 123B is a side perspective view of the bottom surface of an embodiment the top layer of a full length insole/midsole of the disclosure.

FIG. 123C is a top plan view of another embodiment of a ⅔rds length base support layer of the disclosure.

FIG. 123D is a top perspective view of the bottom surface of an embodiment of a full length top layer of the disclosure.

FIG. 124 is a vertical sectional view as would be seen if taken through the heel support portion of an embodiment of a heel support assembly or unit in accordance with this disclosure.

### DESCRIPTION OF THE INVENTION

A three dimensional capture system including a substantially air-tight housing is provided. The shape of the housing is preferably flexible and compatible with the size and shape of a subject item for which a 3-D contour is to be measured. The housing defines a reservoir therein. Loose particles and a gas and/or a liquid are disposed in the reservoir. A valve system is disposed in communication with the reservoir.

In the instance the housing has a sufficient volume of the air and/or liquid inside of the reservoir allowing free movement of the particles therein, the container can be bent, formed or shaped at will. In the instance the housing is bent, formed or otherwise has attained a desired shape, then all or most of the gas and/or liquid inside the reservoir is removed via the valve system. Removal of the gas and/or liquid from the reservoir forces the loose particles in the housing into close proximity to one another. This close proximity of the loose particles prevents easy, readily redistribution of the particles. The bent, formed or desired shape of the housing is retained in the form of a 3-D contour of the housing.

The embodiments disclosed in the drawings include devices that adapt to and support the plantar surface of a foot, devices that adapt to and support a user's posterior, and devices that adapt and conform to a user's grip. The depicted embodiments are illustrative of the invention and its application, but in no way should limit the scope of the invention's application. As noted in the background, this invention can be applied to many different contoured support applications.

The teachings of the present invention may be applied in numerous contexts but will be described primarily in the context of a footwear innersole or midsole. As such, a shoe is designed with a depth sufficient to accept a midsole that incorporates a substantially airtight housing of a size and shape sufficient to fill the interior bottom of the shoe. In the instance the systems of the present invention are included in devices intended to be gripped, the airtight housing is preferably sized to accommodate the hands of the user. The housing is preferably similar in size and shape to a sock liner commonly used in the footwear industry. The housing is preferably at least partially filled with loose, distinct particles.

The midsole may be a drop-in type that is fitted into the sole cavity of a shoe. Alternatively, the midsole may be permanently molded in or glued in the shoe. A drop-in midsole provides the advantage of easy replacement should the midsole fail.

Suitable particles compatible with the present teachings include elastomeric beads with a nominal diameter in the range of about 0.5 mm to about 4 mm. The amount of particles introduced into the container is partly a function of the amount of excess space that exists under the foot inside the shoe if the foot is removed from the shoe. This excess space inside the housing could be tailored to meet the support needs of, for example, the largest numbers of possible wearers of the shoe.

In accordance with the present invention, the particles may be fibers, not beads. The fibers are preferably numerous in quantity and conducive for facilitating the 3-D contour capturing of the present invention. It is to be understood that the fibers can be used in lieu of or in combination with the beads or particles herein with respect to all of the disclosed embodiments, exemplary drawings, and claims. The fibers may be constructed of resilient material. An exemplary resilient material is rubber, which can be obtained, for example, from ground-up rubber tires. In another embodiment, the fibers, beads or particles may be dry, or coated with a lubricant, sealant or other material, or with one or more materials, sealants or coatings having specific properties, preferably having adhesive properties, more preferably non-hardening binding adhesive properties. The coating, lubricant or sealant has, in one aspect hereof, a high viscosity characteristic. The holding power of the high viscosity lubricant, coating, sealant or material is such that when coated or treated, the fibers, beads or particles provide a still, contour-holding contour mold of a subject or object, but not a firm (i.e., permanent) mold thereof.

Particles may be constructed of a variety of materials. Exemplary materials include urethanes, EVA, rubber, gels and various fibers.

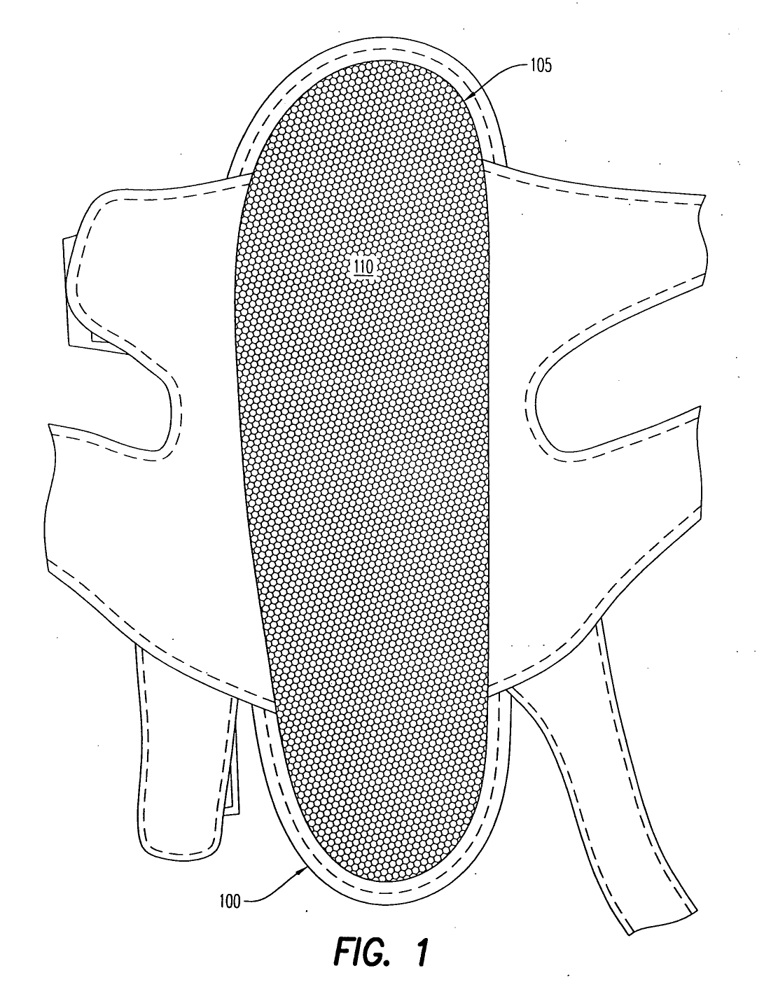

FIG. 1 is a top perspective view of an exemplary device, e.g., a sandal 100, including an innnersole 105, also referred to as an insole, having beads 110 disposed therein in accordance with the teachings herein.

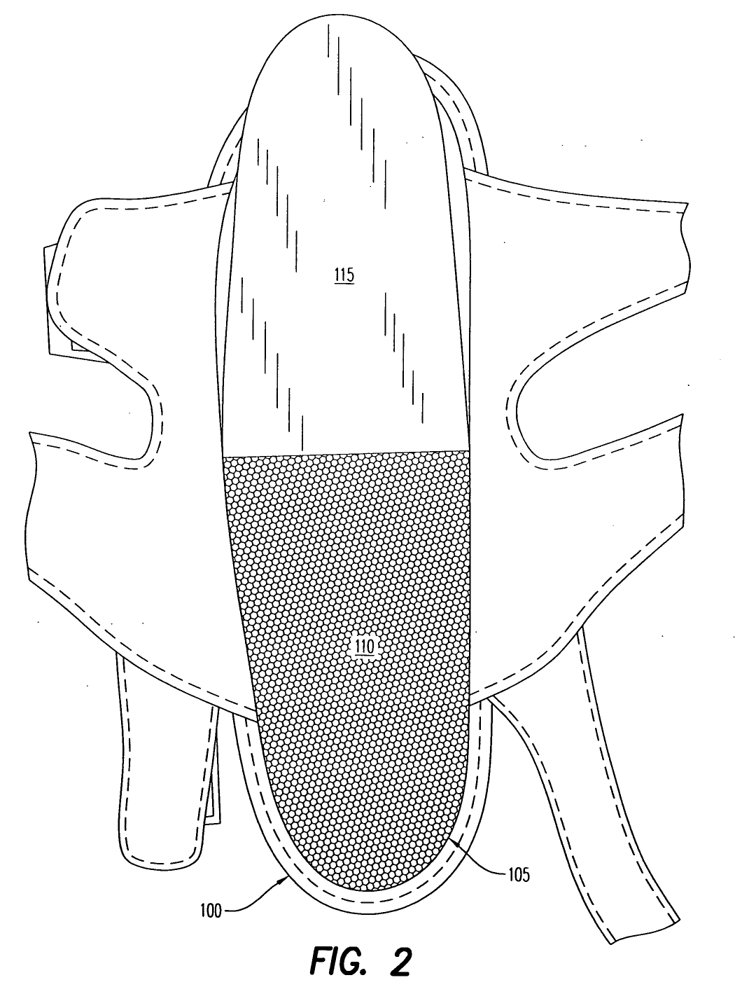

FIG. 2 is a top perspective view of sandal 100 of FIG. 1, wherein one-half of innersole 105 containing beads 110 disposed therein is exposed.

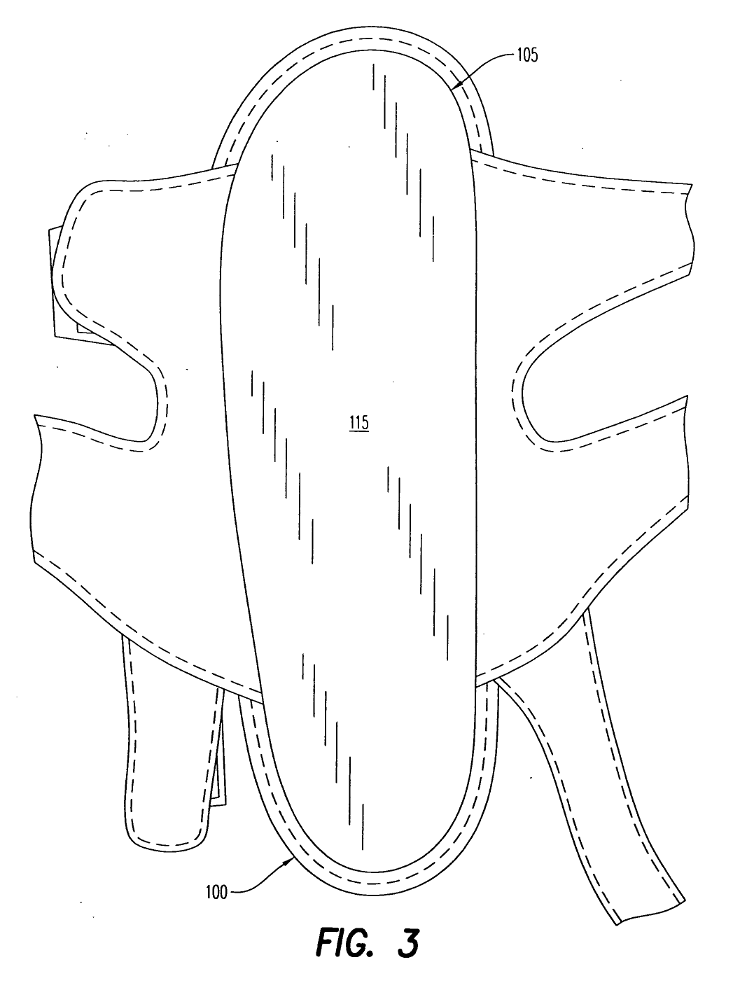

FIG. 3 is a top view of sandal 100 of FIG. 1, wherein innersole 105 and beads 110 therein are sealed within a top liner 115.

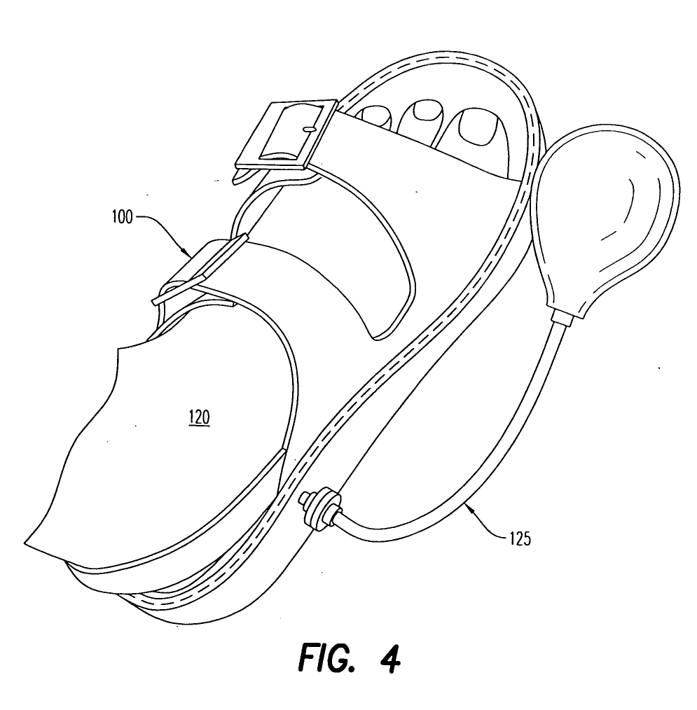

FIG. 4 is a top view of sandal 100 of FIG. 1, including a foot 120 whose contour is to be measured, and a gas removal system 125.

FIG. 5 is a top view of sandal 100 of FIG. 1 including foot 120 whose contour has been measured.

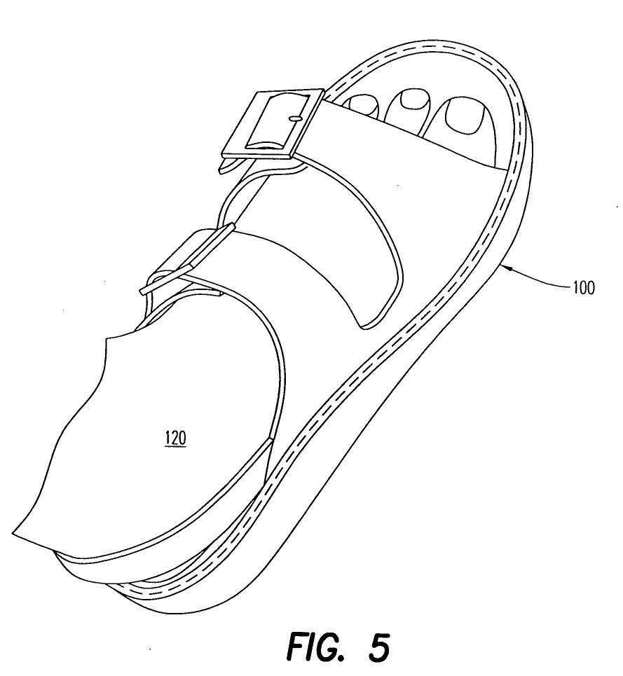

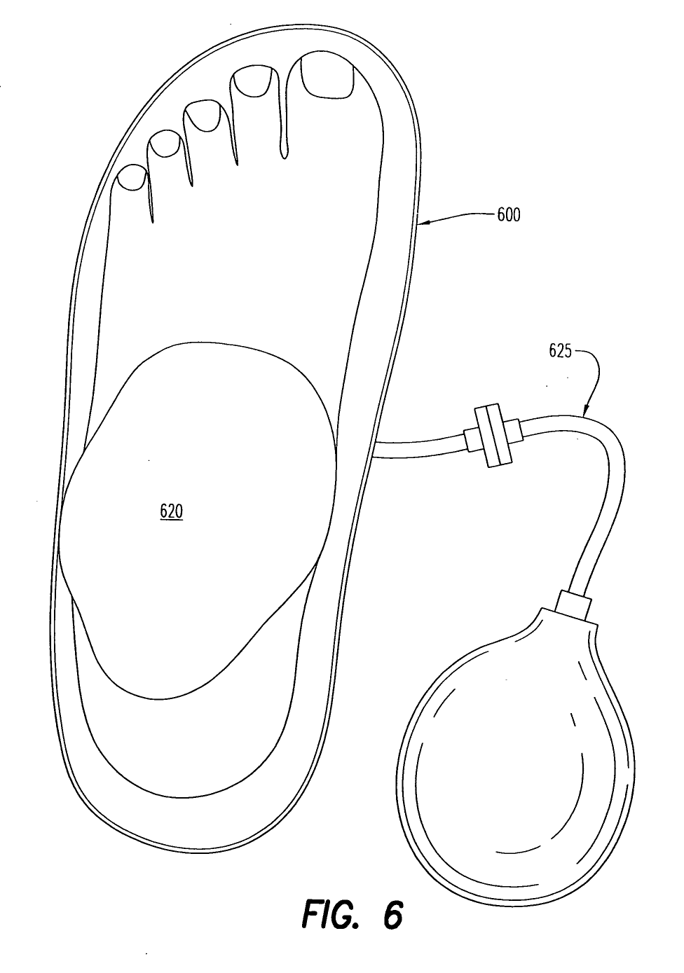

FIG. 6 is a top perspective view of an innersole 600 in accordance with the teachings herein having a gas removal system 625, and a foot 620 thereon.

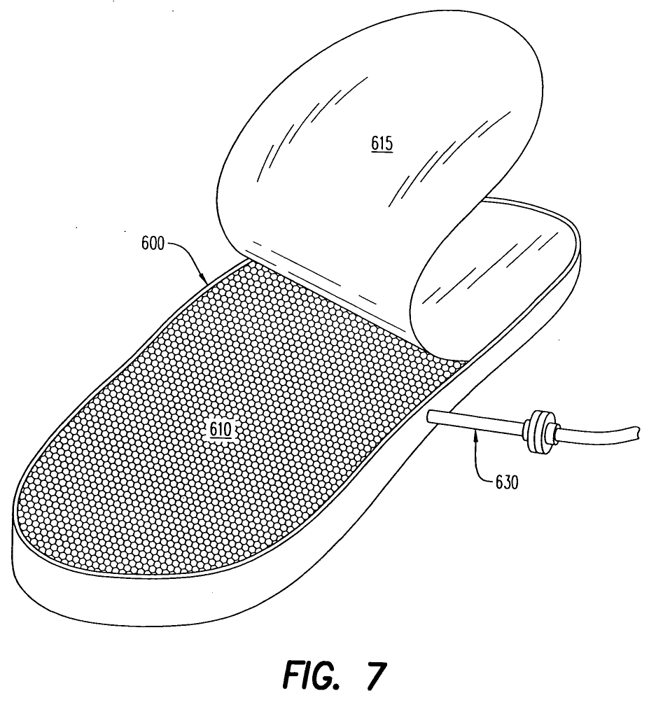

FIG. 7 is a perspective view of innersole 600, in accordance with the teachings herein, showing beads 610 disposed therein partially exposed and an attached vacuum line 630. Also shown is top liner 615, which is partially removed from innersole 600.

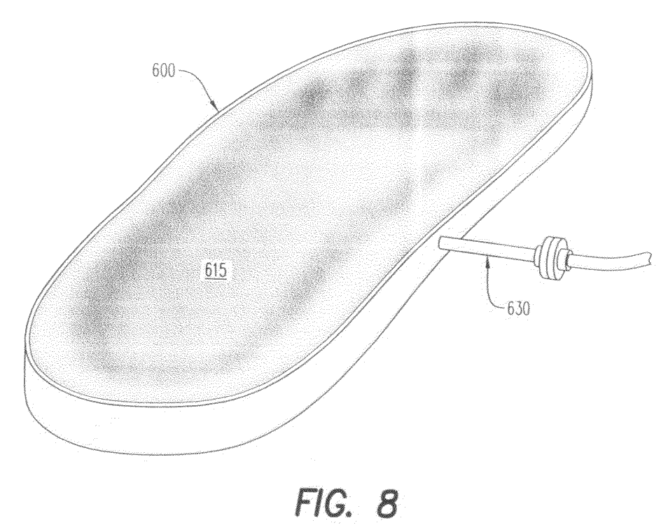

FIG. 8 is a top perspective view of innersole 600 having vacuum line 630, which has captured a 3-D contour therein.

The substantially airtight housing can be laminated on at least one surface with a material suitable for contact with the foot. Such suitable materials can include, for example, specially treated leather, cloth or synthetic materials with similar properties.

In an aspect hereof, the reservoir defined in an interior of the housing can have at least one one-way valve in communication therewith which allows for the flow of gas and/or liquid out of the substantially airtight reservoir. The unidirectional valve preferably has an air connector for connecting to a vacuum system for forcibly removing the gas and/or liquid from the housing.

In one aspect, the unidirectional valve includes a bypass capability so that air can be selectively re-introduced into the housing. In one aspect thereof, the gas and/or liquid is not reintroduced back into the housing.

In yet another aspect hereof, a blower or air introduction means may be provided to introduce or force air into the housing.

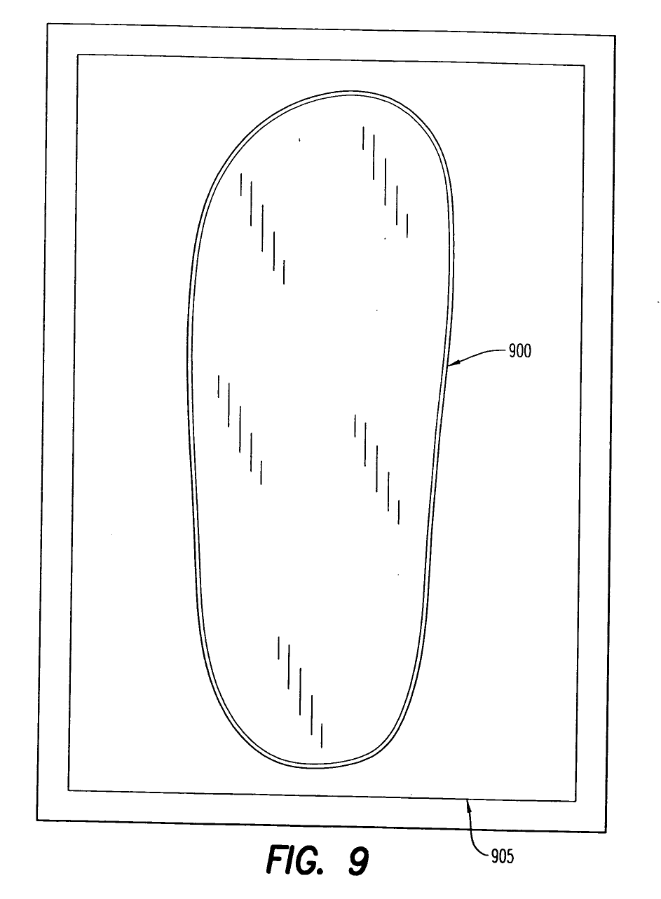

Operationally, the moldable innersole embodiment of the present invention (also referred to hereinafter as a “self customized insole”) is disposed in the midsole of a shoe. The foot is introduced into the shoe and moved about a top surface of the housing containing the loose particles to force the particles contained therein to conform to the 3-D shape of the plantar surface of the foot. In an alternate method, the shoe, self-customized insole and foot are placed against a vibrating surface or a vibrator to assist in the migration of particles around the plantar surface of the foot to take on the 3-D contour thereof. Refer to FIGS. 9-15 to see a vibrator plate in accordance with the present teachings.

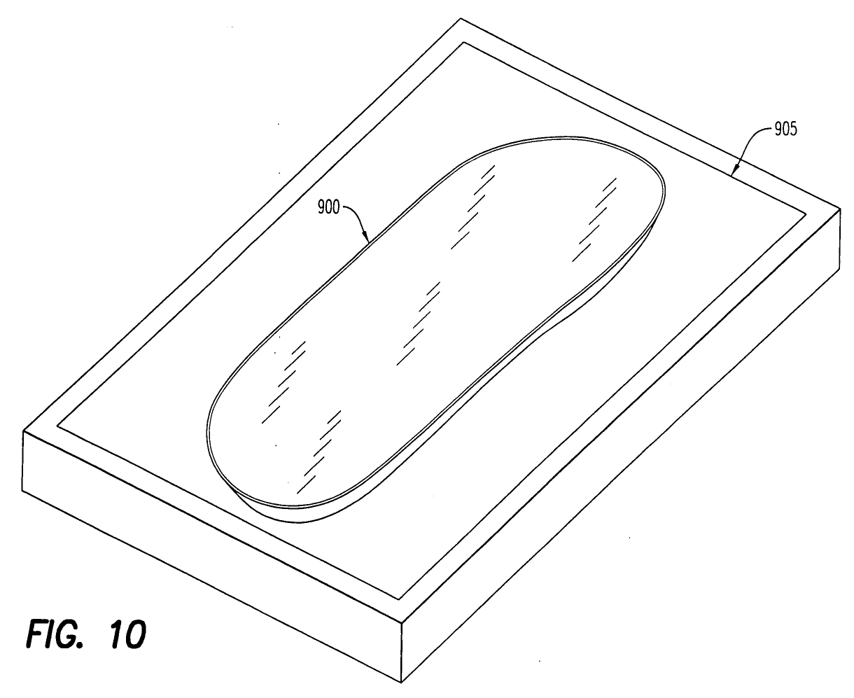

FIG. 9 is a top view of an innersole 900 located on a vibrator 905. FIG. 10 is another view of innersole 900 located on vibrator 905.

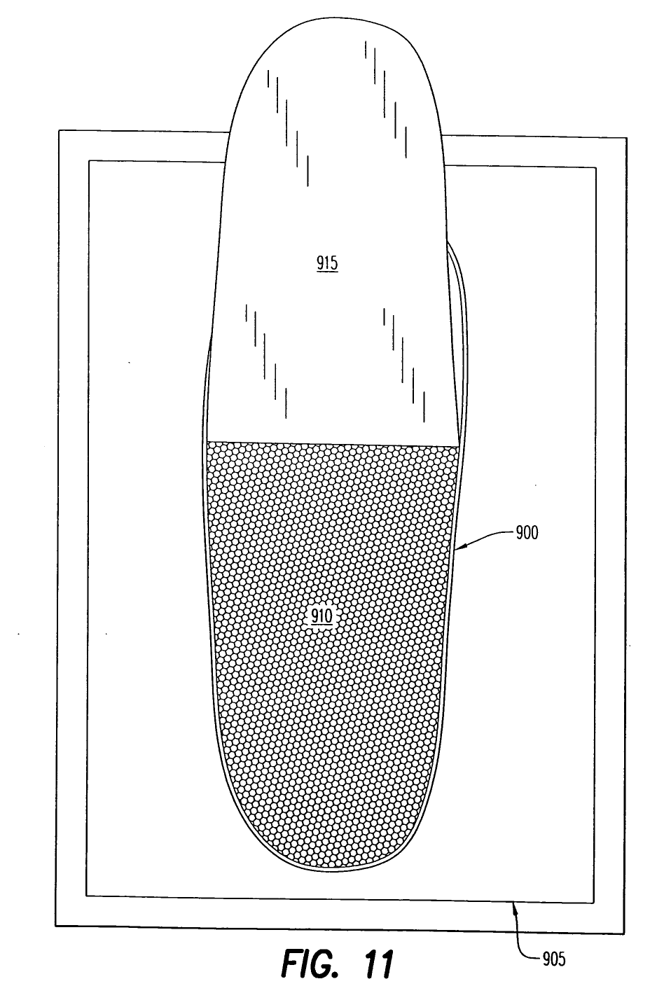

FIG. 11 is a top view of an innersole 900 located on vibrator 905 and having a top liner 915 partially removed to exposed beads 910 disposed in innersole 900.

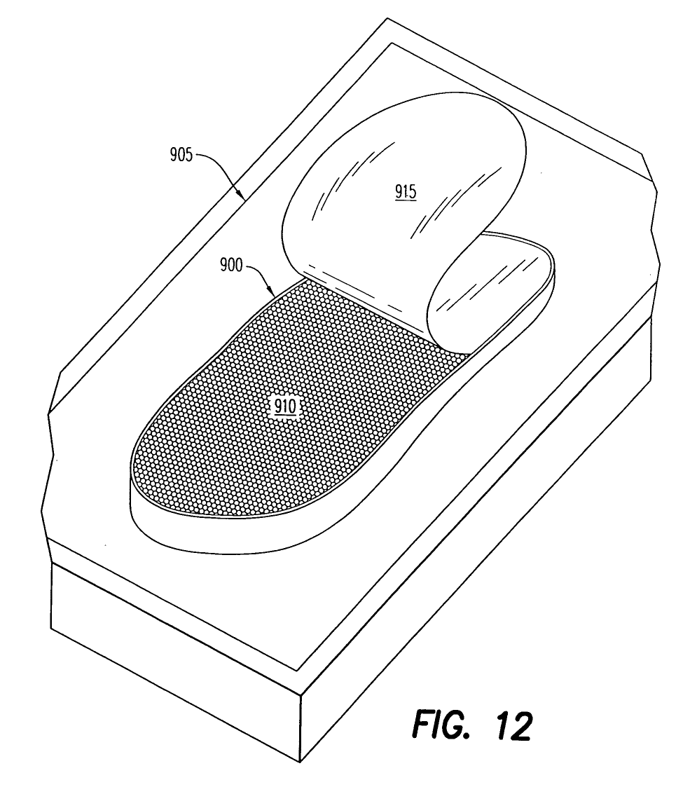

FIG. 12 is a side perspective view of innersole 900 located on vibrator 905 and having exposed beads 910 disposed in innersole 900.

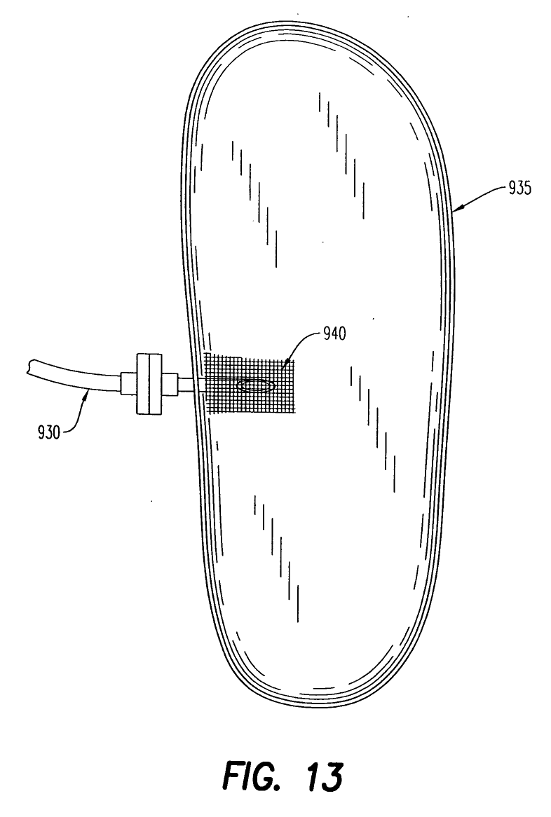

FIG. 13 is a top view of an exemplary vacuum line 930 connected with an innersole housing 935. An associated filter 940, which is in the form of a screen or wire mesh, is disposed in innersole housing 935.

The excess of gas (e.g., air) and/or liquid is removed from the housing. The removal of the gas and/or liquid can be achieved in a number of methods as detailed below. If a unidirectional air valve in communication with the reservoir retaining the particles has a light pressure break-point, and with the flow direction of the unidirectional valve going from the housing to free air, then simply pressing the foot down will expel the majority of the air out of the housing.

A unidirectional air valve is used as discovered above and an air evacuation means is connected to the free air side of the unidirectional valve in another method. The air evacuation means is activated and the majority of the air removed from the container.

The valve may be a one-way check valve. The valve may also be a simple mechanical valve having a push-pull mechanism to manually open or close the valve. A secondary plug or stem may also be included and applied to the outlet of the check valve to prevent leaks. The plug is removable and is removed during resetting of the housing contour. A push-pull valve may be on the same line with a check valve to prevent leaking.

Another method of removing gas and/or liquid from the housing retaining the particles includes using a gas and/or liquid evacuation tool in conjunction with the unidirectional valve. The gas/liquid evacuation tool is connected to the unidirectional valve and activated, thereby removing substantially all of the gas and/or liquid from the housing. This method of gas/liquid removal is highly effective in retaining or locking the shape of the particles since the air evacuation is substantially complete, thereby restricting the free motion of particles.

Once the shape is captured, it may be desirable to retain or lock that shape permanently. A number of methods are disclosed to realize this feature. For example, the action of walking on the self-customizing insole will, by virtue of the force applied by the foot upon the contoured surface force any excess air out of the unidirectional air valve incorporated into the insole with each step. This method has the advantage of being a passive or automatic feature. It will also be tolerant of slight leaks in the container. In addition, use of an airtight plug may also help to prevent leaks and typically will help to retain the contour for periods on the order of weeks. It may not be, however, perfect at retaining the shape over a long term. Particles may migrate due to the less than perfect vacuum inside the container.

According to another exemplary method, an adhesive material is used to retain the captured shape. During the manufacture (or subsequent thereto) of the particles, the particles are doped with an adhesive that is activated once the shape is retained to cause the particles to bind solidly together. The adhesive may be activated by a number of methods including, but not limited to, heat, radio frequency (RF) energy, ultraviolet (UV) energy or a captive catalyst, etc. Regarding the catalyst, a polyurethane or other materials may be used and activated for adhering the particles in a locked position.

According to yet another method for retaining or locking the 3-D shape, melting of at least some of the particles is used. Subsequent to forming the housing to the desired shape and removing excess air to retain the shape, heat is applied thereto, causing the particles to melt sufficiently to bond to one another. This heating can be radiant, ambient, electromagnetic or radio frequency in nature.

In one aspect of the present teachings it may be desirable to return the housing that has captured a 3-D contour to its original, quiescent state. This goal may be especially true for seating or sleeping surface applications, where different individuals may use the same surface. In the case of seating a completely automatic customized seating can be realized using the following embodiment of the invention.

The housing is designed sufficiently sized and shaped to approximate the size and shape of a seating surface. The housing defines a reservoir in an interior thereof for containing loose, discrete particles. There is also included at least a simple on/off valve to control the flow of a gas and/or a liquid into or out of the reservoir. In one aspect hereof, elastomeric beads are used to substantially fill the container. A subject item (e.g., a posterior surface of a person) is placed on the housing to re-distribute the particles in the housing such that the contour of the subject item is captured by the particles.

Optionally, air or liquid may be introduced into the container to unload the particles. Optionally, air or liquid may be circulated inside the container when so unloaded to assist in the free motion of the particles. Optionally, a vibrating action may be used in conjunction with, or in place of pressurization to assist in the free motion of the particles.

Once the desired shape is achieved by the housing and particles, all or part of the gas and/or liquid is removed from the reservoir. The removal of the gas/liquid may be accomplished passively or actively. If passive, a unidirectional air valve is used to allow for the expulsion of excess gas/liquid out of the reservoir. The liquid/gas is expelled due to the force applied by the subject item to the housing. The removal of the gas/liquid forces the particles into close proximity with each other, resulting in a captured 3-D contour that is resistant to movement.

If the gas/liquid is removed via an active process, an air or liquid removal pump is applied to the housing, in communication with the particle retaining reservoir. A unidirectional valve or an on/off valve may be used to prevent the undesired re-introduction of gas or liquid removed therefrom.

To return the housing to its original state, air or liquid must be reintroduced, in a sufficient volume, to allow for free movement of the particles.

In yet another aspect hereof, it may be desirable to allow for the circulation of gas and/or liquid in the reservoir (under a support surface) after the 3-D contour is fully captured. In the instance the particles are adhered to each other in the captured 3-D contour (by adhesives, melting, etc.), a volume of gas and/or liquid is allowed to flow back into and out of the container freely. This would allow, for example, a cooling effect as the subject foot walks in gait.

In an aspect hereof, more than one type and/or size of loose particle material can be retained in a common housing. For instance, different particles may be used because of the molding characteristics thereof, for instance. For example, both softer particles and harder particles may be retained in a midsole container. The harder particles protect the softer particles from collapsing or losing resiliency.

In an alternate embodiment, the housing can be divided into more than one contained compartments or sections. Each compartment may have tailored characteristics for various regions under the supported surface. Such characteristics may include limited size and shape of a supported area, different size, density, weight or hardness of particles or fibers, and differences in gas or liquid. Other characteristics of the sections may include types of coatings, particles or fibers, differences in the ability to introduce or expel gas and/or liquid, and differences in the ability to introduce or expel particles and/or doping materials.

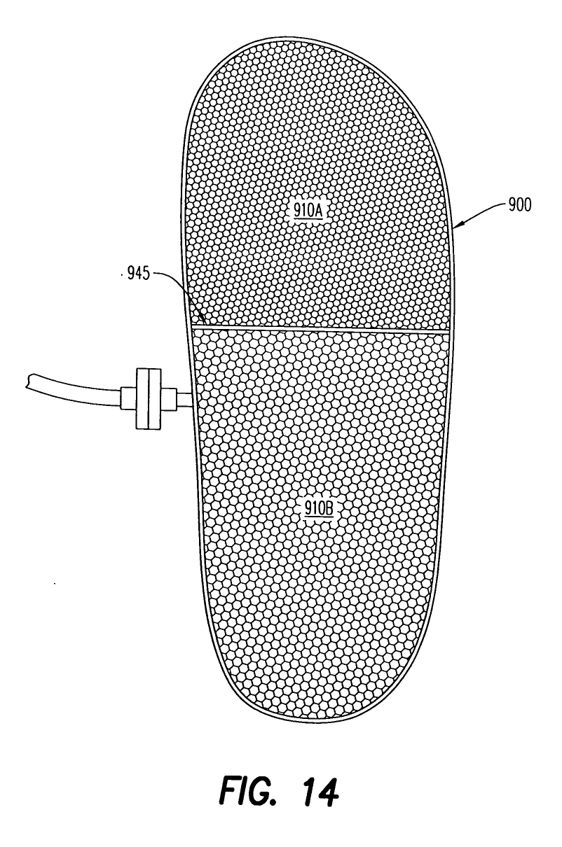

Alternatively, the housing, and in particular the reservoir defined thereby, may be partitioned into a number of sections. The sections may be desired since one part of the housing will be used to permanently capture a 3-D contour while another section will remain free to have “free” particles circulating therein. To separate multiple partitions, at least one baffle can be disposed at the junction of particle partitions. This aspect of the present teachings is shown in FIG. 14, which shows a top view of innersole 900 having multiple types of beads 910A and 910B disposed in innersole 900, the multiplicity of types of beads separated by a barrier 945.

The baffle or barrier separating partitions/sections of particle-filled sections is preferably permeable to gas (i.e., air) and/or the liquid occupying a volume of the housing, yet blocks the particles and/or fibers. The baffle may be formed of any material capable of allowing air and/or liquid to pass therethrough without allowing the particles to pass. Such materials may be, but are not limited to, wire mesh, a membrane, a fabric, and a synthetic mesh.

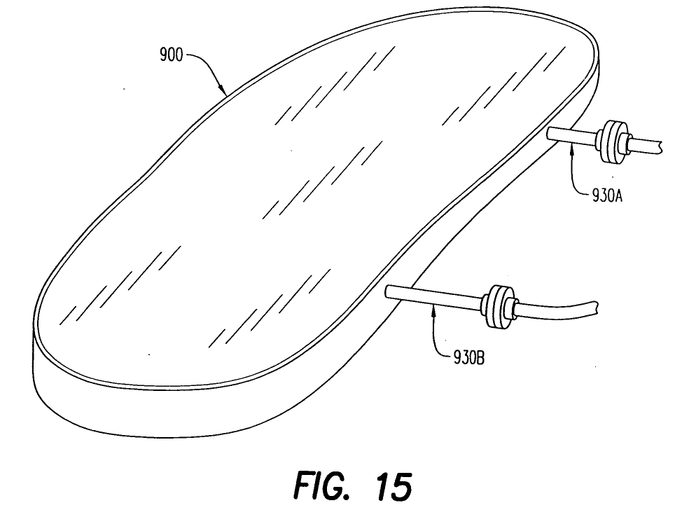

FIG. 15 is a side respective view of innersole 900 having multiple vacuum lines 930A and 930B attached thereto, in accordance with the present teachings.

The partitions may be provided to provided a predetermined contouring effect based on the shaped, size, and placement of the partitioned (i.e., compartmentalized) housing of particles. There may be numerous partitions within the housing in order to provide a highly flexible and highly customizable assembly wherein, for example, each (or at least a selective number) of the partitions or compartments are selectively vacuumed or vacuumed to a predetermined level.

In an aspect hereof, a number of holes are provided in an insole incorporating in the housing hereof. The holes, preferably small and located in an outer surface of the insole, provide an escape for air forced out of the insole by pressure from a foot. The holes are sized and located such that air is forced out therefrom when walking. The size and location of the holes do not, preferably, allow the full re-entry of the escaped air back into the insole during the course of normal walking. That is, the volume of air that is forced out during a walking step does not reenter the insole during the non-contact portions of walking.

In one aspect hereof, a selected section of particles in the housing are not in communication with a valve system that interfaces with a vacuum and/or pump for removing and inserting the gas or liquid, respectively.

In still another aspect of the present teachings, a covering such as a liner, may be attached to the housing containing the particles at the periphery of the liner. That is, the center majority is free to move above the housing due to the attachment only at the edges of the liner covering. The liner being separate from the majority of the housing provides for the migration of air into and out of the assembly. Air that becomes heated, for example in an actively worn shoe, can escape from the housing and the assembly of housing and liner covering through the liner. Further this aspect, the liner can be perforated to further facilitate the exchange of heated air.

It is also contemplated and within the scope of the present invention that the valve system or at least a portion thereof be located within a midsole/insole, outside the midsole/insole, or in the side wall of the midsole/insole and/or shoe side wall.

Key aspects of the present invention can include, but are not limited to, a deformable mold, selective locking intensity by region of the housing, a combination of a solid material to the deformable material from heel to toe in certain shoe embodiments, unidirectional and controllable (i.e., open/closed) vacuum/pump lines, varying degrees of adhesion of the tacky, viscous lubricant, sealant or material on the particles to vary and control the level of support offered by various embodiments of the device herein.

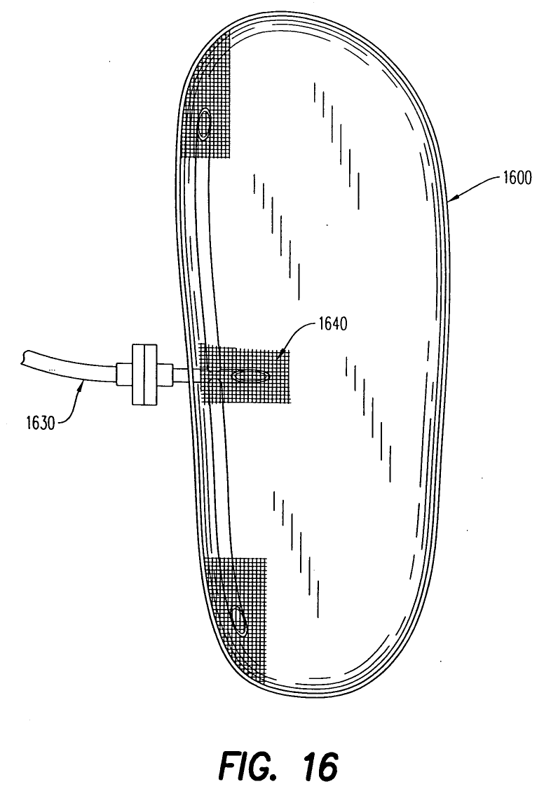

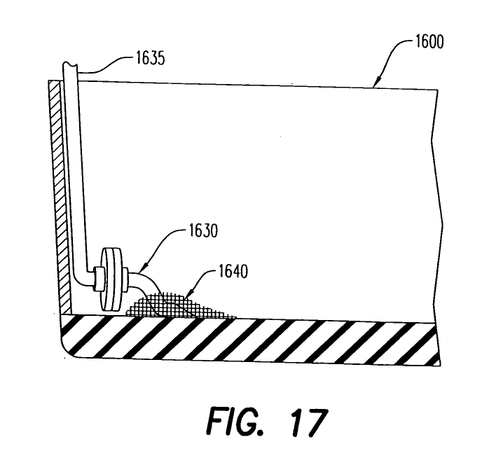

In another aspect hereof, the pump and vacuum systems that may be connected to the valve system are protected from damage and contamination, from either the particles and environmental concerns. As shown in FIG. 17, a midsole 1600 having an elevated air vacuum line 1635 to guard against foreign objects entering into air vacuum line 1635 is provided. As shown in FIG. 16, a screen material, such as, for example, a fabric, synthetic, or a metallic mesh 1640 can be disposed over the opening of the valve system and/or the pump/vacuum systems 1630.

In an aspect of the present teachings, RF sensitive particles may be disposed in the housing. The RF sensitive particles increase in temperature upon exposure to RF energy. The RF sensitive particles are re-activated and bond to each other and other components in contact therewith by being exposed to an appropriate source of RF energy.

Various materials may be used in combination with the present teachings to facilitate and improve the comfort to a user. Breathable materials, moisture-wicking materials and the like are within the scope herewith.

It one aspect hereof, the housing or a section therein may have the gas and/or liquid therein partially vacuumed or otherwise removed therefrom. That is, the removal of the gas and/or liquid need not be an all or nothing proposition. In fact, it may be beneficial to remove a certain percentage of the gas and/or liquid, for example 60%-70% by volume, to create a housing that is semi-rigid or form holding. In this manner, the contour of the subject object, e.g., a foot, will be substantially retained by the partially vacuum packed particles in the housing.

It is noted that the midsole or insole cavity of a footwear item can be pre-loaded under a partial vacuum. The same application of a partial vacuum can be extended to the implementation of an entire cavity or housing. In the context of footwear, the midsole insole comprising the housing with particles can be partially vacuumed to have a predetermined (i.e., generic) footprint contour. Upon use, the wearer's footprint would customize the midsole insole. One advantage offered by the implementation would be that the user's foot is guided to the proper fitting location.

In another aspect hereof, a two-third foot bed length particle filled insole may rest on top of a full foot bed length housing filled with particles or simply inside of a conventional shoe. Thus, customized cushioning and contouring can be obtained in only certain areas of the footwear in a specific, controlled manner as needed/desired.

In another embodiment, the particle filled housing may be disposed only under the heel, metatarsal heads and toes (i.e., forefoot) of the midsole of footwear. The particles disposed in the housing may be under a partial, complete or non-vacuumed configuration.

In an aspect hereof, the particles (e.g., beads) can act to absorb and/or dissipate shock impacts, such as though experienced when a walking foot strikes the ground.

Another embodiment in accordance with the present teachings includes a sock liner disposed inside of a shoe. The sock liner comprises a housing of particles as described in detail above. The particles may be under a complete or partial vacuum and/or disposed within partitions. The length of the liner may extend the full length of the shoe's foot bed or a portion thereof.

It is also noted that a high viscosity material with adhesive properties such as a lubricant, sealant, adhesive or other material may optionally be applied to the particles configured in an insole or midsole as a measure of making the particles less prone to migrate about the housing and/or a partition therein. The same application of a material with adhesive properties to the particles can be extended to the implementation of an entire cavity or housing. In a preferred embodiment, the material with adhesive properties is a high viscosity fluid that is used to coat the particles. An example of a preferred high viscosity material according to the disclosure of this specification is a Teflon® lubricant, commercially available from I.E. du Pont de Nemours and Company. A preferred example of a preferred material is a non-hardening particle binding adhesive.

Regarding the application of the present teachings to footwear, it is noted that the housing and quantity of particles disposed therein may be adapted to accommodate different types of feet such as, for example, those with a high arch, a low arch, and other characteristic formations. The high arch or low arch insole and/or midsole can be separately packaged for consumer and/or application use.

It is also considered herein that an impression of a subject object, for example a foot, may include a full impression of the subject object or an partial portion thereof such as a partial length impression of a foot impression.

In one aspect of the present invention, the valve system includes two valves (i.e., dual valves) operating as input and output valves for controlling the introduction and evacuation of the liquid and/or gas to and from, respectively, the flexible housing containing the reservoir of particles and gas and/or liquid. One valve operates to control the input or intake of gas and/or liquid. One valve operates to control the output or expulsion of the gas and/or liquid. The input and output valves of the dual valve system are preferably uni-directional (i.e., one-way) valve devices, or at least valve devices configured to operate in one direction. In an alternative, at least one of the dual valves may optionally be bi-directional valve devices operated to allow gas and/or liquid to flow in either direction, in accordance with the teachings of the dual valve system aspects hereof. For example, one embodiment may include a one-way check valve line to allow air to escape, and a dual valve that may be opened to allow air to re-enter the housing.

The dual valve system provides a useable 3-D contour capture system and method for selectively capturing a 3-D impression of the subject object. The dual valve system may be implemented in numerous embodiments for a variety of applications. Exemplary embodiments incorporating the dual valve system include, but are not limited to, a system and method for: a foot impression (e.g., shoe insoles, sandals, ski boots, work boots, orthotics, etc.); all types of footwear and shoes, a seat cushion/surface, optionally including a lower or lumbar back support; a sporting goods device (e.g., a golf club and racquet handle, archery bow, etc.); a tool handle; a firearm handle portion, a steering wheel cover; and etc.

The intake valve of the dual valve system can be selectively opened and closed to permit the flow of an amount of the gas and/or liquid into the flexible housing and the output valve can be selectively opened and closed to permit the flow of an amount of gas and/or liquid out of the flexible housing. For example, the intake valve may be opened or manipulated to introduce a desired volume of liquid and/or gas into the flexible housing. The subject object (e.g., foot or hand) can then be placed on the flexible housing and the outlet valve can be opened or manipulated to permit the forced expulsion of an amount of the liquid and/or gas from the flexible housing, thereby creating a 3-D impression of the subject object in the particles located in the flexible housing. The outlet valve can be closed or manipulated so that no additional liquid and/or gas can be expelled from the flexible housing once the 3-D impression of the subject object is captured. The 3-D impression will thus be captured or locked by the system having dual valves. The captured or locked 3-D impression may be used for further processing such as, for example, electronic and/or manual scanning, mechanical casting, etc.

In an aspect hereof, the outlet valve may be configured to continuously permit the expelling of gas and/or liquid while the shoe, grip handle, etc. including the dual valve system hereof is in use. Therefore, gas and/or liquid may continue to be expelled during use of the device to achieve a better, more customized 3-D impression. The outlet line connected to the outlet valve may also be plugged to prevent leakage.

In the event the 3-D impression is not acceptable (e.g., the 3-D impression contour is not fully and/or accurately captured due to user error), the input valve may be selectively opened or manipulated to allow an introduction of additional liquid and/or gas into the flexible housing, thereby un-doing or “erasing” the previously captured 3-D impression. Another (i.e., new) attempt to capture the 3-D impression of the subject object may be performed using the same system comprising the dual valve system.

In this manner, the dual valve system may be used, repeatedly if desired (i.e., reusable), to selectively capture the 3-D contour of the subject object. It is noted that repeated 3-D impressions performed by any one user provides a method of training the user in the process of taking the 3-D impression. Thus, the final 3-D impression locked into the 3-D contour system (and used for further processing) has an improved likelihood of being an accurate 3-D impression of the subject object.

Optionally, the dual valve system can be interfaced with a pump for the introduction and/or evacuation of the liquid and/or gas to and from, respectively, the flexible housing having the dual valve system.

In another aspect hereof, the inlet valve of the dual valve system (or other systems disclosed herein) may be allowed to be opened or manipulated so as to allow an additional volume of the liquid and/or gas to be introduced into the flexible housing once the subject object is remove therefrom. That is, the 3-D impression is not “locked” into the flexible housing. The 3-D impression is effectively “erased” once the subject object is removed from the flexible housing.

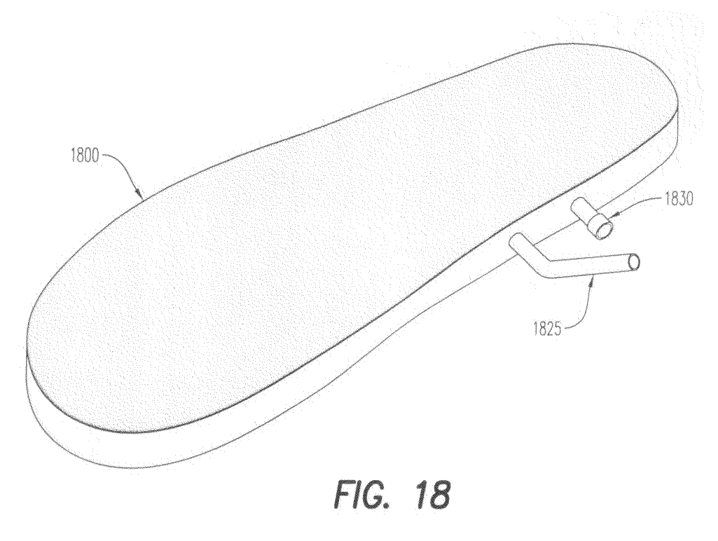

FIG. 18 depicts a perspective view of an exemplary insole 1800 having a dual valve system. The dual valve system includes input valve 1825 and output valve 1830. Note that no 3-D impression is “locked” or captured by insole 1800.

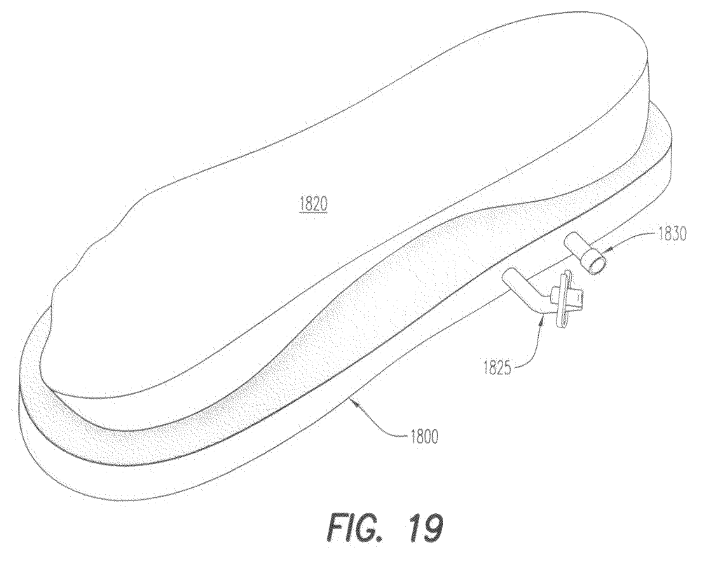

FIG. 19 depicts a perspective view of the exemplary insole of FIG. 18 with a 3-D impression of a foot captured or “locked” by insole 1800 having the dual valve system. The dual valve system includes input valve 1825 and output valve 1830. A plaster cast obtained using the 3-D impression captured by the insole is shown on top of and mating with the captured 3-D impression.

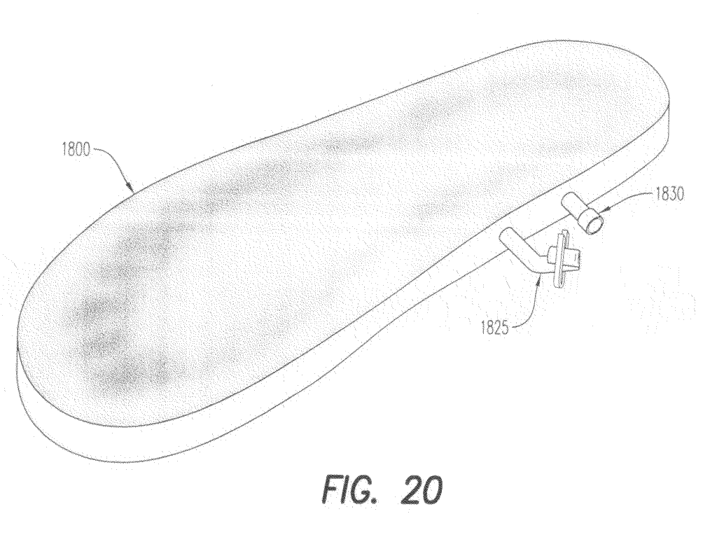

FIG. 20 is a perspective view of the exemplary insole 1800 with a 3-D impression of a foot captured or “locked” by the insole having the dual valve system.

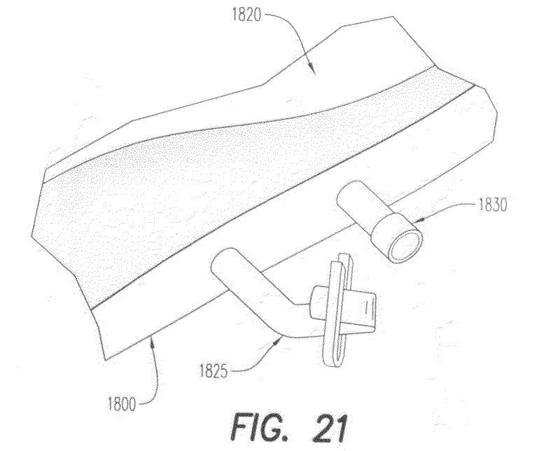

FIG. 21 is a detailed view of the exemplary insole 1800 of FIG. 20, more clearly illustrating the dual valve system including input valve 1825 and output valve 1830.

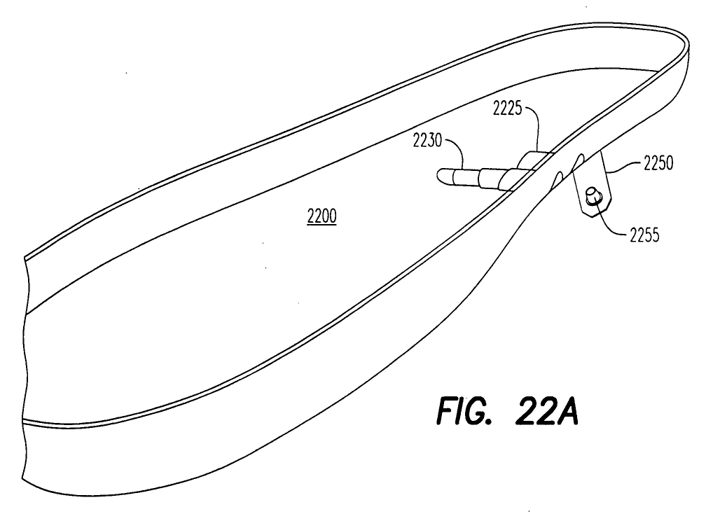

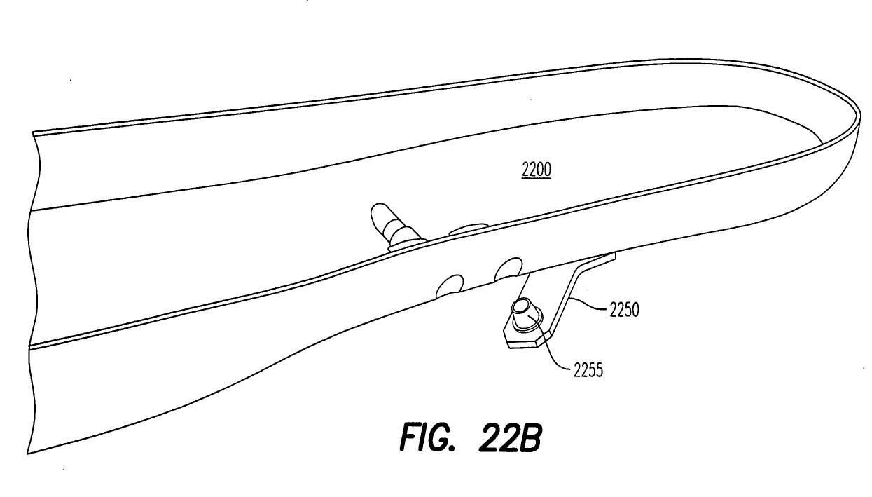

FIGS. 22A and 22B depict the inside of a midsole 2200 including an outlet valve 2230, and an inlet air line 2225 shows outlet valve 2230 on the outerside of the arch portion of midsole 2200. A flap system, including a flap 2250 and plug 2255, is included. Plug 2255 prevents air from leaking into air line 2225. An additional plug may also be applied to valve 2230.

A plug such as plug 2255 of FIGS. 22A and 22B may serve as a simple press in/pull out valve to allow air to escape. The plug may also serve to prevent dirt, water, and other debris from entering the air line.

In another embodiment, a midsole is provided having a number of holes in the side of the midsole, extending to the exterior of a shoe or other footwear. A number of plugs fit into the holes to prevent air from escaping or entering the midsole. The user may remove the plug prior to stepping on the shoe and then reinsert the plug to prevent air escaping and to retain the shape of the midsole. The plug may be made of a resilient material such as plastic, rubber or elastomer and snap in place. In another embodiment, each hole includes a metallic ring to support the hole, and the plug includes magnetic material to retain the plug in contact with the holes. The plug may be removed to allow air to re-enter the midsole and re-shape the midsole or to provide ventilation.

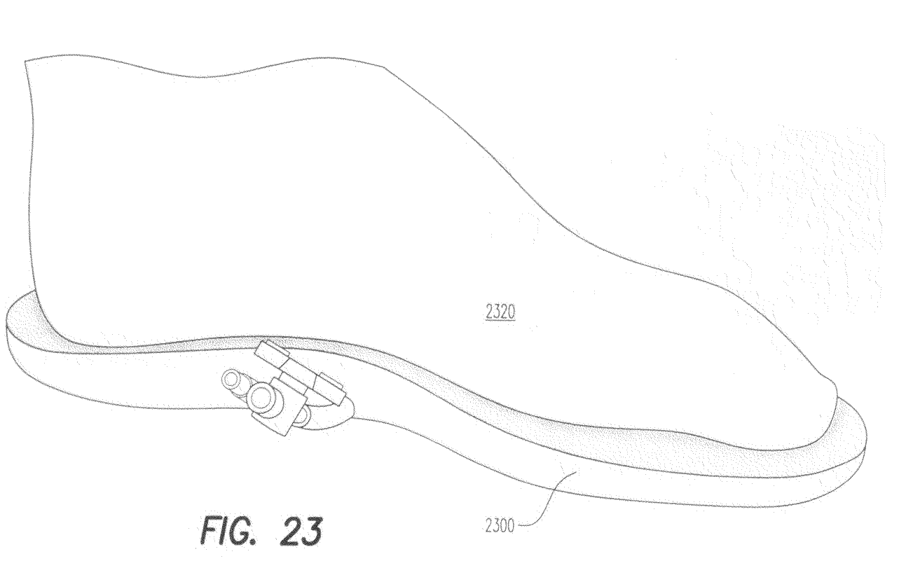

FIG. 23 depicts a contoured midsole 2300 with particles inside, valves attached, contour impression locked with foot 2320 resting in the impression.

In one embodiment, all particles are subjected to an anti-static process either during manufacture of the particles or prior to loading the particles into the housing. Removal of static charge prevents the particles from clinging to unwanted surfaces and may improve the contouring ability of the particles.

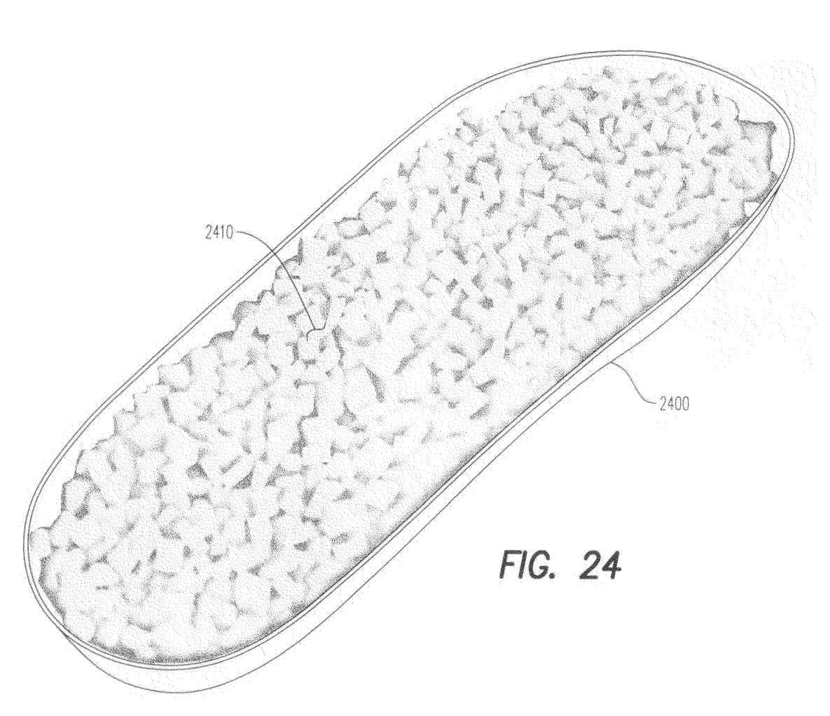

Particles or beads may come in a variety of shapes, sizes and materials. In on example, FIG. 24 depicts midsole container 2400 with foam particles 2410 inside. Bead density may also be varied to provide softer or firmer 3-D capture devices, and further a variety of densities can be simultaneously used in the device to provide varying degrees of softness or firmness.

The valves described herein may be manually activated via mechanical devices, or controlled by electromechanical systems. The valves may be unidirectional or bidirectional. A single valve or multiple valves may be utilized with the 3-D capture system.

An electromechanical system allows easy modification of a 3-D capture system, and may be used to control a single valve or multiple valves. For example, the foot contour of a midsole/insole may be modified while in a static position, while rocking the foot, or in a dynamic position such as while walking. A remote control device may be used to modify the contour. A voice activation circuit may also be incorporated into a control system.

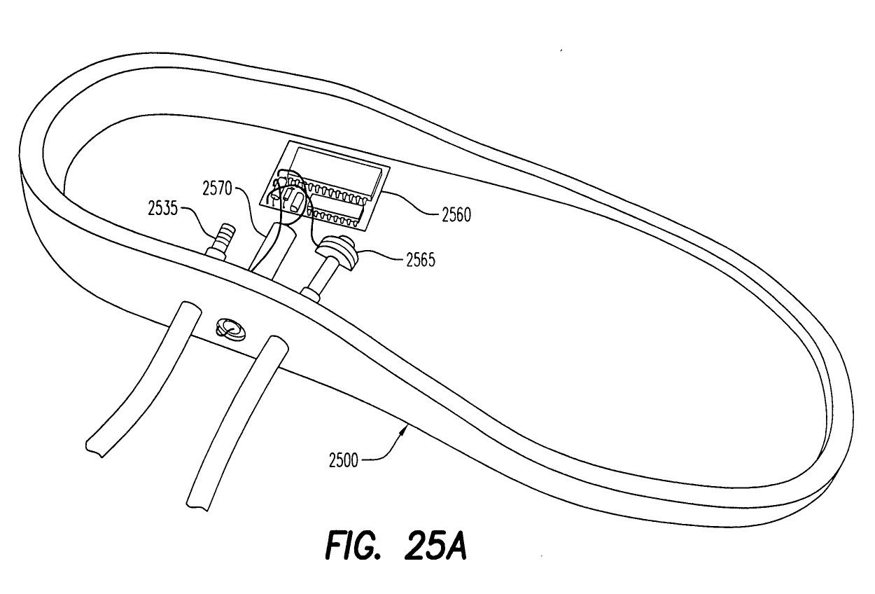

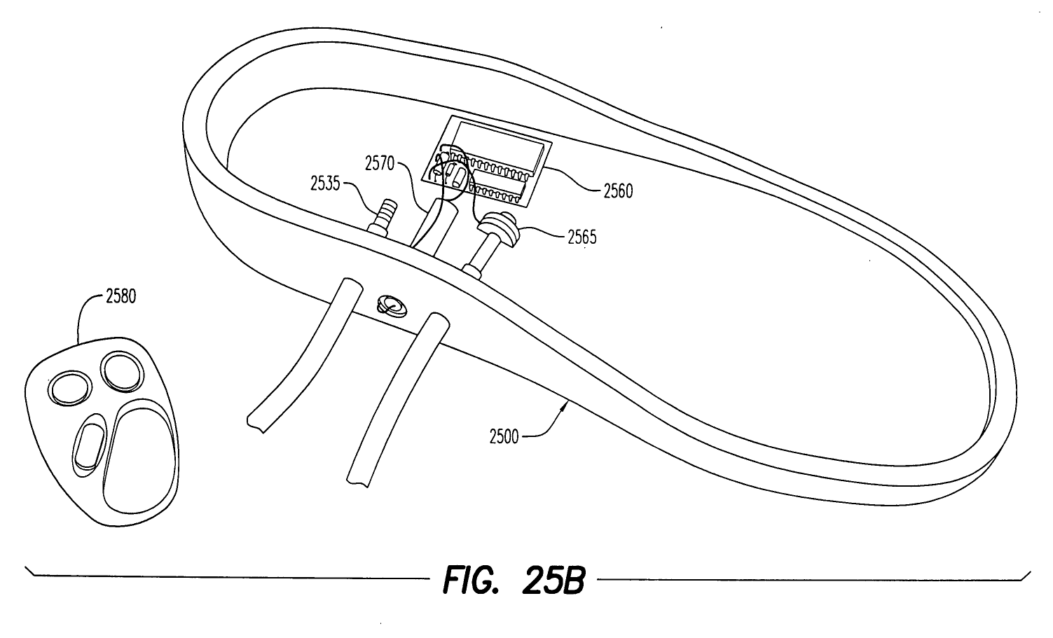

FIG. 25A depicts midsole bottom 2500 with electronic processor control system 2560 connected to bidirectional valve 2565 for mechanical control of valve 2565 to control air flow. The processor control system 2560 is powered by battery 2570. FIG. 25B additionally depicts remote control 2575. The valve may be operated remotely or by a touch button switch attached to midsole bottom 2500 or elsewhere. An additional backup valve such as outlet valve may be included, such as with a plugged end, to reset the contour of the midsole.

In another aspect, the remote control is utilized to activate preferably electrically operated air valves. A preferred battery is a CR2016 flat lithium 3.6 V battery. In order for the remote control to work, the battery must continually be connected to the processor. To preserve the battery life, a midsole side button can be installed to allow a user to disconnect the battery. The user may push the button to activate the battery and unlock the valve. Alternatively, the control system may be set to connect or disconnect the battery automatically. An associated LED is preferably included to indicate that power to the processor is “on”. The button can be pushed again to turn “off” the power and close the locking valve.

In another aspect, a receiver associated with the electronic processor is preferably customized to respond to a specific remote control frequency. In another embodiment, a distinct remote control frequency may be assigned to each midsole/insole so that the user has the option of adjusting only one insole/midsole or both simultaneously. In a further embodiment, individual pairs of insoles/midsoles are assigned different remote control frequencies to avoid accidental modification of other pairs of insoles/midsoles when two or more users are near one another.

Where a specific shoe is designed in conjunction with a specific insole/midsole, an electronic processor may also be used to ensure that the midsole/insole is not used in another pair of shoes. The designated pair of shoes contains an identification mechanism that is readable by a processor in the midsole/insole. The processor will then prevent use of the midsole/insole unless it reads the proper designated identification signal from the designated shoe.

Because particles have the potential to become statically charged, it may also be desirable to place a layer of shielding material to protect the electronic control system. A shielding layer will prevent damage to the control system due to static charges.

The control system may also automatically activate in response to inputted conditions. For example, a specific desired hardness may be set by the user, and the control system can modify the air/liquid volume to maintain the desired hardness.

In another aspect, the 3-D capture system may incorporate an electro-mechanical control system to allow the contour to periodically reset in response to movement. An example of such a system is a mattress pad or mattress topper. Additionally, a valve system may be connected to a vacuum pump which is controlled by the control system. A sensor is also included to sense movement. The control system can respond to signals from the sensor to allow air into the 3-D capture system to reset the contour. The vacuum pump may then be engaged to set a new contour based on a position of a user's body after the movement.

In another example, a heat sensor is incorporated into the control system to control the temperature of the midsole/insole, seat or other 3-D capture device. A desired maximum temperature may be set, above which the heat sensor sends a signal to the control system to open an air valve to provide circulation and cool the device. When used in a midsole/insole, the heat sensor opens a valve to allow air to circulate through the midsole/insole. Walking movement provides a pumping effect by driving out warm air and drawing cooler outside air into the midsole/insole. This embodiment may be specifically useful as insoles/midsoles for boots such as military boots, especially for use in hot climates such as a desert. This embodiment may also be useful in automatically controlling the temperature of a seat. In one example, a temperature control system including the heat sensor, control system including all control logic circuits, is utilized in a seat for a wheelchair, particularly for paraplegic users.

In another aspect hereof, a particle injector is provided to fill or inject particles such as beads into the midsole/insole housing. Particles can be injected by air pressure, mechanical force, gravity, or a combination. A gravity system may be most useful in a store or factory that manufactures devices such as footwear that include the 3-D capture device. A vibrator may also be included to move the particles and prevent them from accumulating in one area. The particle injector may also be used in reverse, to suck extra beads from the 3-D capture device.

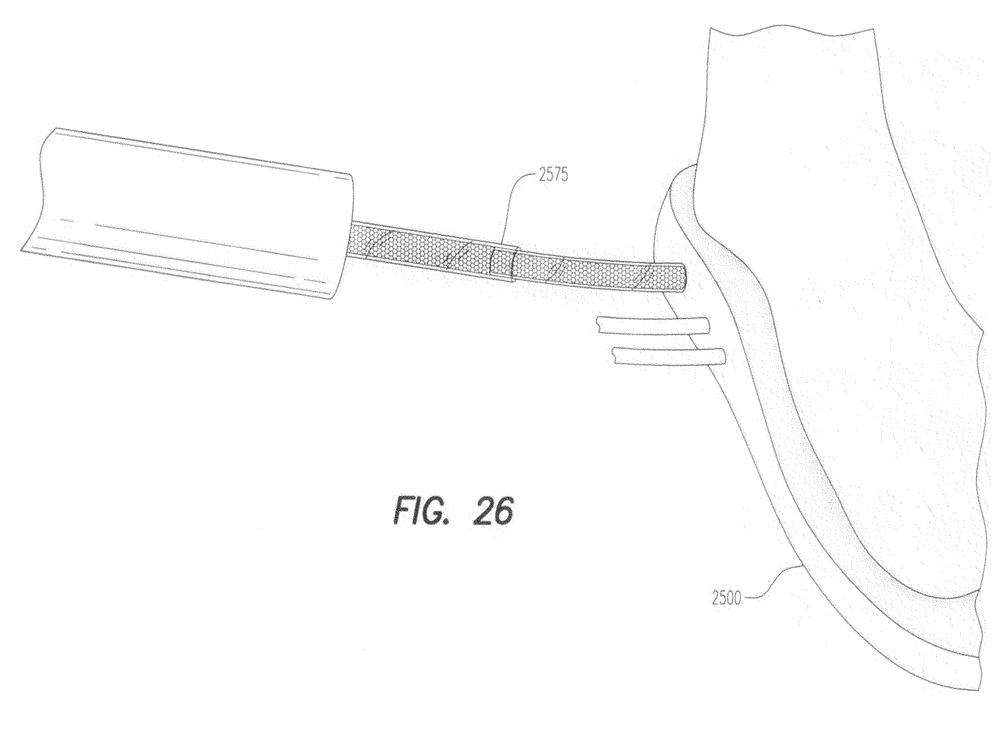

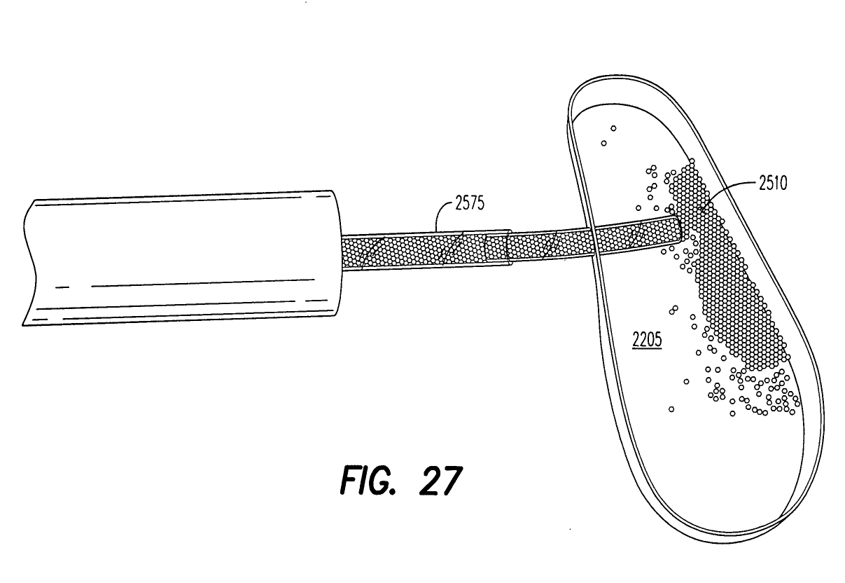

FIG. 26 depicts midsole 2500 including particle injector 2575. FIG. 27 depicts midsole container 2505 with bead particle injector 2575. Particle injector 2575 operates to force beads 2510 into midsole container 2505.

In another aspect, the container features adhesive surfaces to hold a layer of particles in place. Adhesive surfaces may be a surface of the housing coated with an adhesive, or an additional layer of material coated with an adhesive that is applied to the additional layer, such as double-sided adhesive tape.

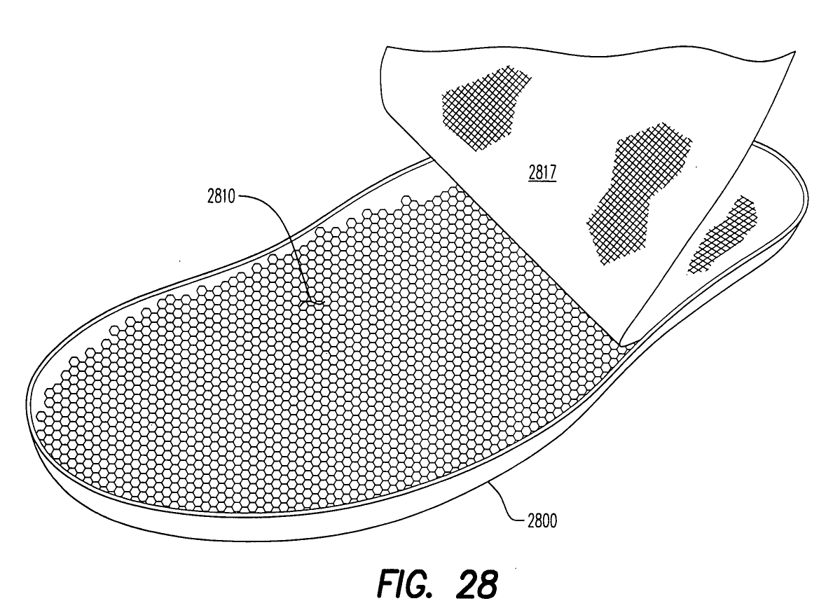

An adhesive surface applied to the housing will reduce particle migration when the vacuum hold is off or nearly off. Ah adhesive layer will also reduce particle migration due to shear forces applied by the foot's plantar surfaces when walking. In another embodiment, only the weight bearing surfaces of the container are coated with an adhesive material. For a midsole/insole, the forefoot ball and heel areas of the container, where most shearing forces are located, are coated with an adhesive to have a sticky quality. In another embodiment, the higher inside elevations of the container wall may also be coated with an adhesive to catch and hold excessive beads or particles. The undersurface of a cover of midsole/insole 2800, such as midliner cover 2817 shown in FIG. 28, may also be coated with an adhesive if desired.

In place of an adhesive surface in the bottom of a container such as a midsole/insole container, and/or on the underside of a cover, a rough, pock-marked surface may be used to reduce unwanted particle migration. The rough or pock-marked surface should be made from a resilient material.

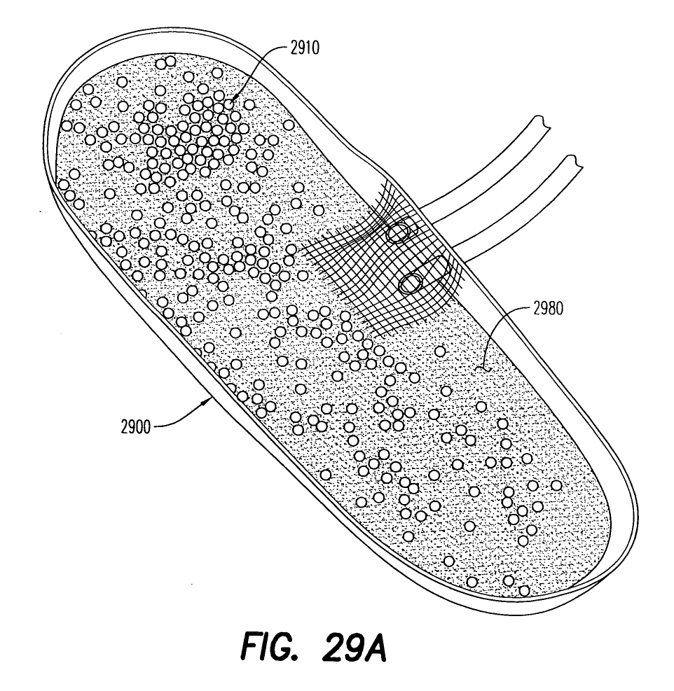

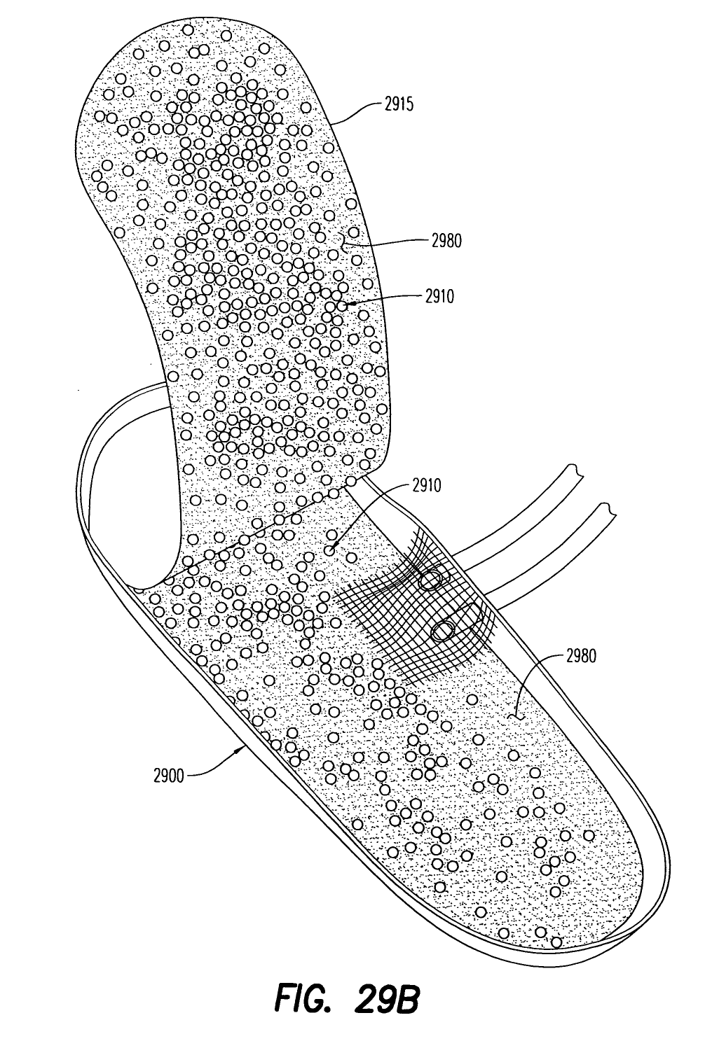

FIGS. 29A and 29B depict inner midsole 2900 having a bottom 2980 coated with an adhesive material to provide adhesive surface 2980 to more effectively hold beads 2910 when the vacuum is off and when aggressive shearing forces are applied by a foot's bottom. As shown in FIG. 29B, a top liner 2915 may also be coated or otherwise provided with adhesive surface 2980.

In another embodiment, the container bottom contains partitions to reduce migration of particles. The partitions can be included in addition to an adhesive bottom to further aid in unwanted particle migration.

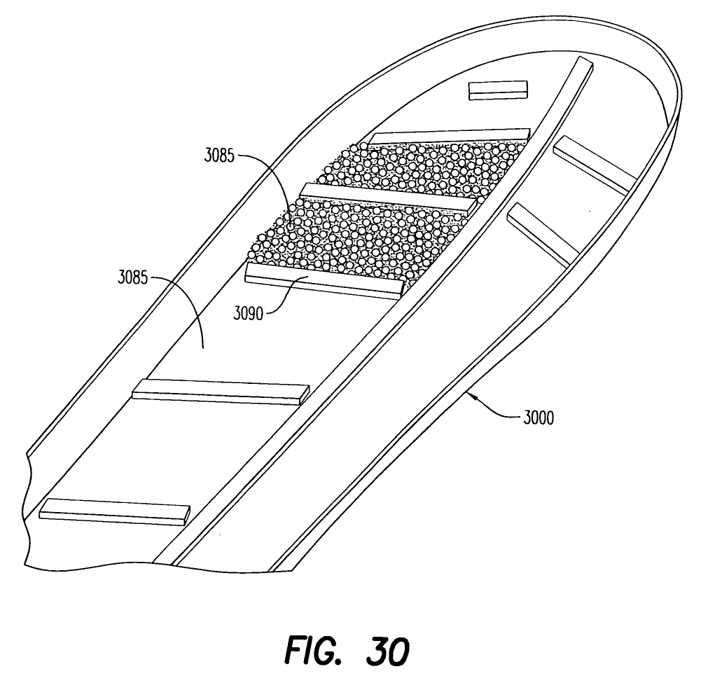

FIG. 30 depicts the inside of midsole container 3000 with partitions/barriers 3090. As shown in FIG. 30, some of sections 3085 formed by partitions 3090 are coated with an adhesive material to further help in controlling bead movement when the air vacuum is off and when the foot applies shearing forces.

In another aspect, a window-type mesh screen layer is placed on top of the beads or particles. The screen allows air to move through to the underside of the top layer to improve vacuum force. The screen also smooths the upper surface of the midsole/insole to prevent a lumpy particle surface from showing through the top layer. FIG. 28 depicts midsole/insole 2800 with beads 2810 inside including mid liner cover 2817, preferably in the form of a mesh screen layer, that provides a smoother feel and prevents any lumpy beads from showing through the top finish layer.

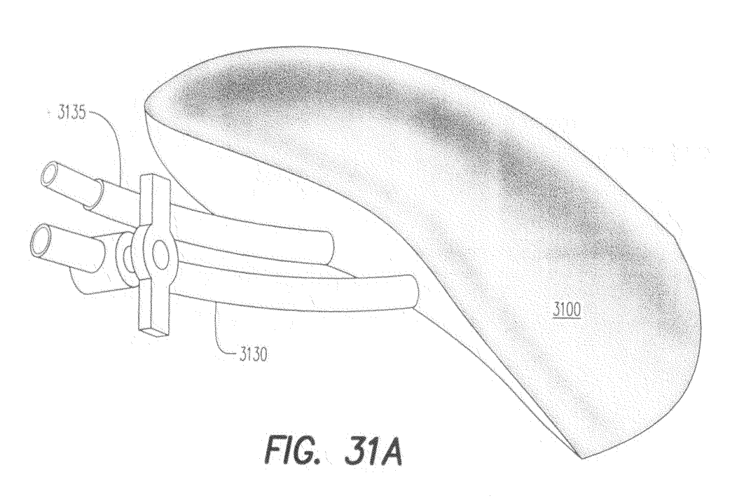

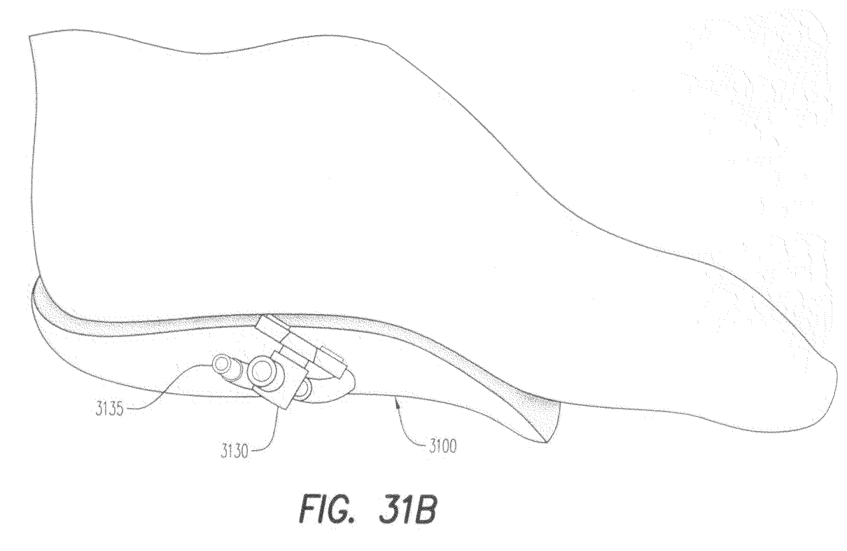

In another aspect, the 3-D capture device is in the form of an orthotic support. An example is shown in FIGS. 31A and 31B, which depict a ⅔ long, i.e. ⅔ the length of a foot, orthotic 3100 including attached valves 3130 and 3135. Valve 3130 is an inlet valve including the associated inlet line, and valve 3135 is an outlet valve including an associated outlet line.

A midsole container, insole container or orthotic container may include built in supports for the metatarsals, longitudinal arch, lateral arch and radius of the heel. The midsole container may be concave at the bottom to allow a suspension effect and spring effect to increase comfort. When used in an insole or orthotic, the bottom side of the container can also be concave. This shape will more easily mate with the built in shank curve rise inside the bottom of the shoe, especially in the case of rigid containers. This shape is illustrated in FIG. 56, which shows a container 5600 having a raised support portion 5605 to accommodate a shoe with a built-in shank.

In this disclosure, an insole includes and/or refers to an “insole/midsole”, “insole orthotic”, “midsole” or “orthotic”, or combinations of such terms. Also, an insole or midsole or insole/midsole includes and/or refers to a heel cup.

FIGS. 32A and 32B depict pre shaped contouring of the midsole/insole container to add extra support to the metatarsal arches, lateral arch and heel radius with the bottom of the midsole/insole container having a concaved radius to provide give when extra force is applied to the arch. FIG. 32A shows a toe portion 3202 of a contoured container 3200 that provides metatarsal support. FIG. 32B shows contouring of the remainder of container 3200 showing support region 3205.

In another aspect, instead of molding supports directly into the midsole/insole container as in FIGS. 32A and 32B, resilient pads such as a resilient metatarsal pad can be positioned on the container. This embodiment provides resilient compression and provides a slight spring effect. FIG. 33 depicts midsole/insole container 3300 with placement of resilient material 3395 under the heel and forefoot ball for extra shock absorbing. The resilient material lays under the beads in a completed midsole/insole.

FIG. 34 depicts midsole container 3400 with toe end filled in with solid filler 3496. The filler serves the purpose of minimizing extra space to prevent any air from being retained. This in an option, especially in those cases where the toes do not reach the inside end of the midsole. Alternatively, the vacant toe end space fills in with extra beads/particles, if any, when air/liquid is evacuated.

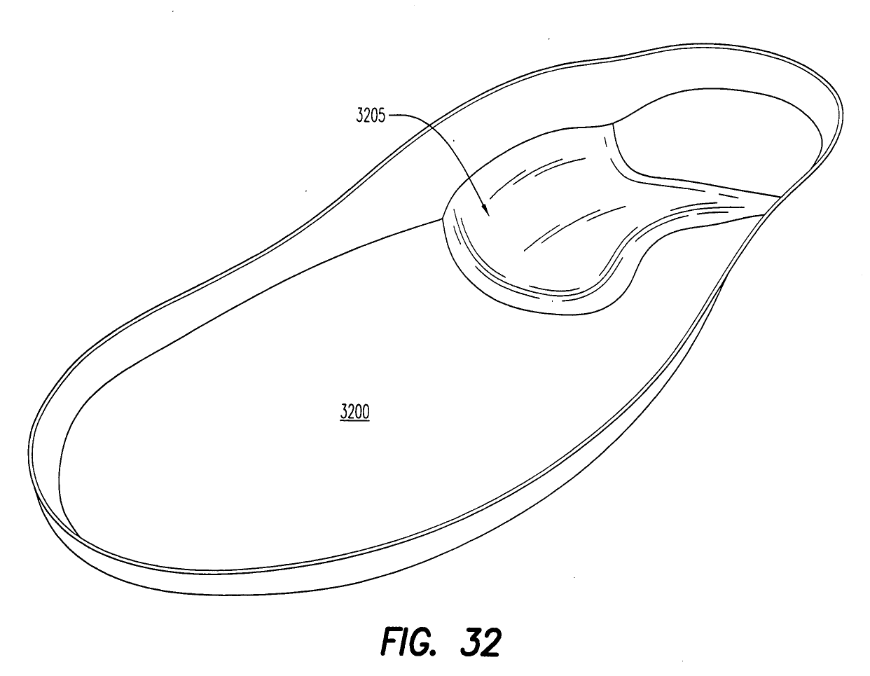

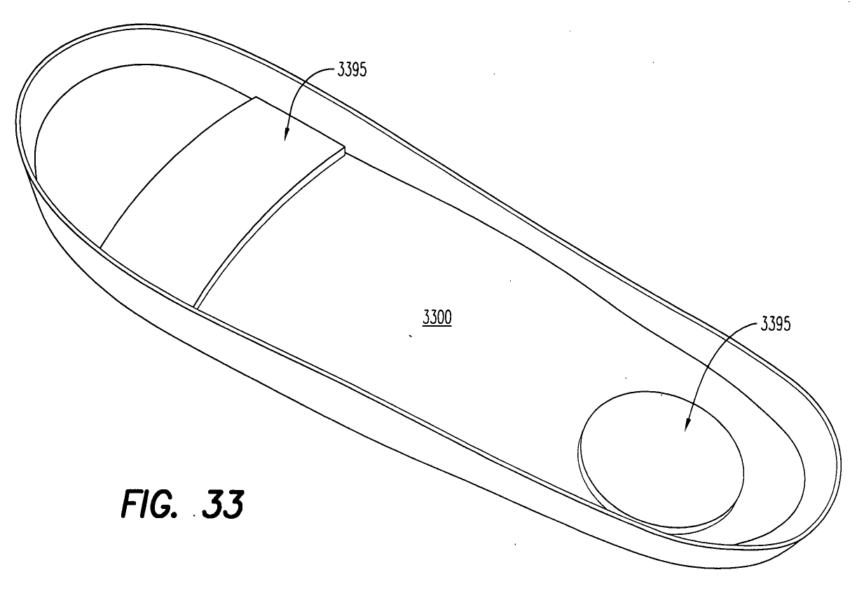

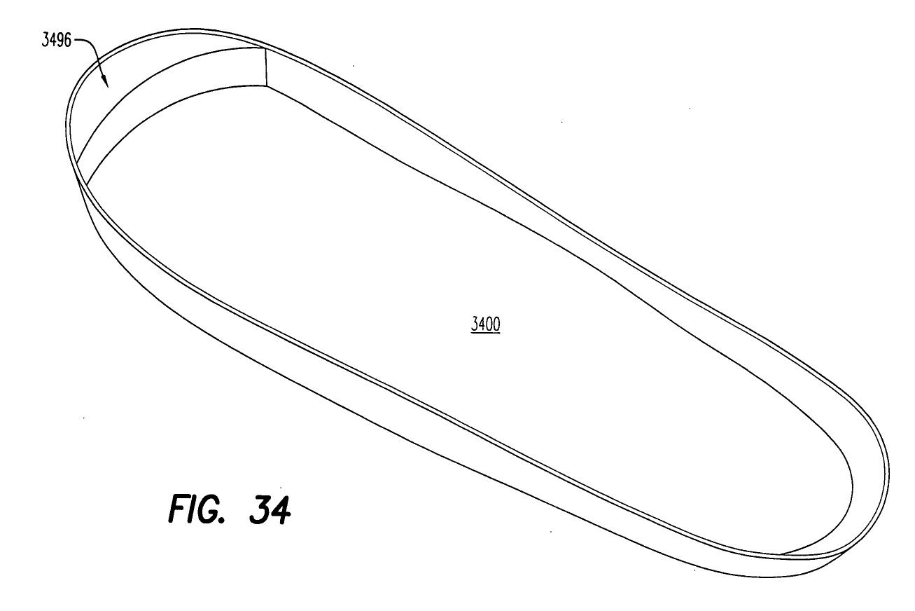

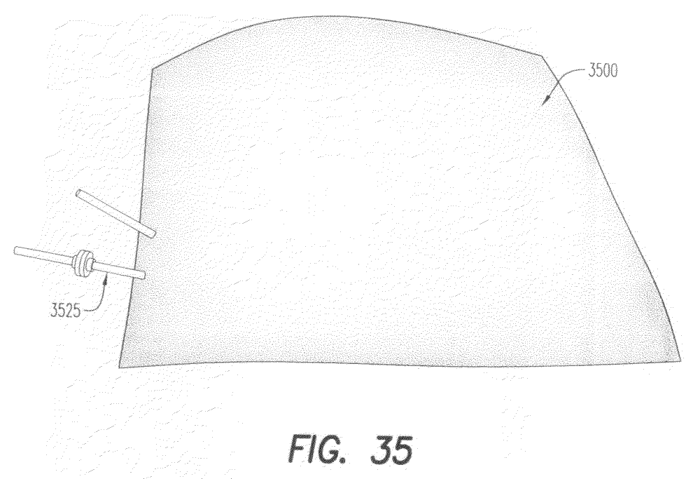

FIG. 35 is a perspective view of an exemplary seat cushion 3500 having a dual valve system 3525. Note that a 3-D impression is not “locked” or captured by seat cushion 3500.

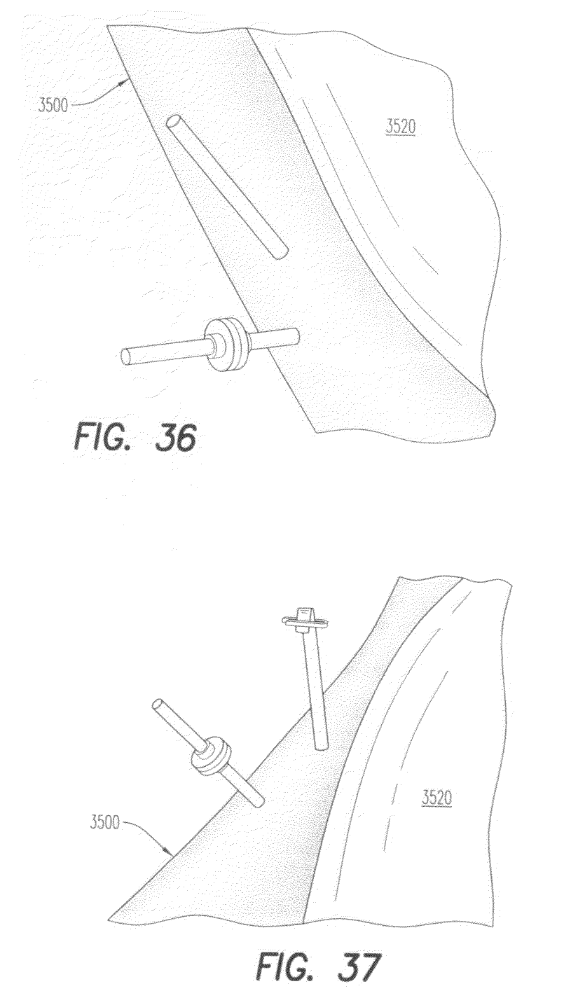

FIG. 36 depicts a perspective view of the exemplary seat cushion 3500 of FIG. 35 with a subject object 3520 located thereon.

FIG. 37 is a detailed perspective view of exemplary seat cushion 3500 of FIG. 35 with subject object 3520 thereon.

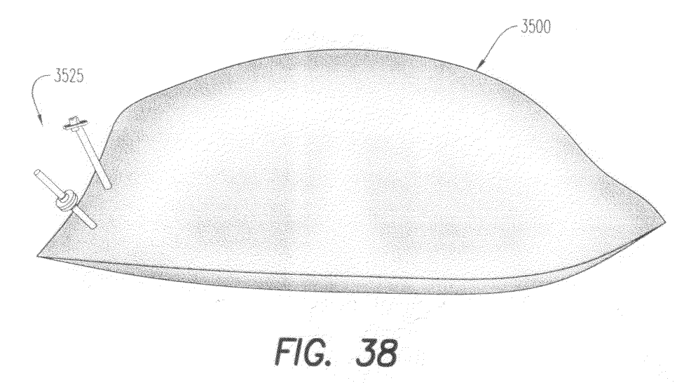

FIG. 38 is a perspective view of exemplary seat cushion 3500 having a dual valve system 3525. Note that a 3-D impression is shown “locked” or captured by seat cushion 3500.

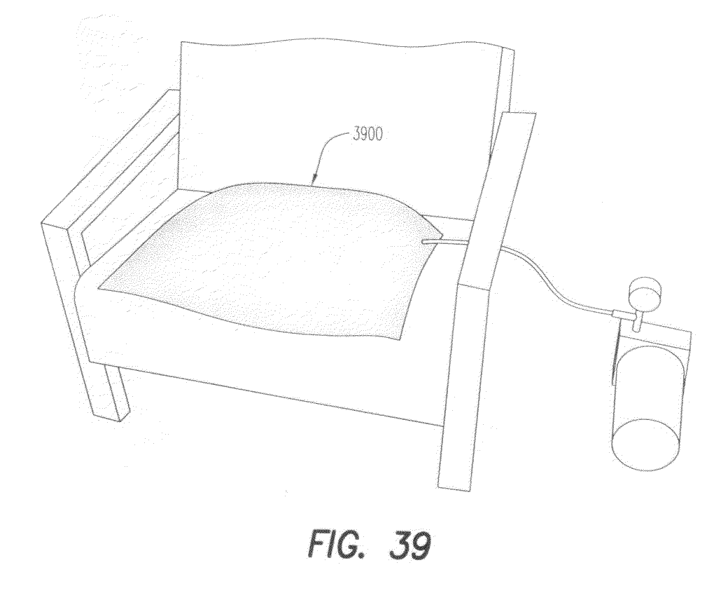

FIG. 39 depicts an exemplary seating cushioned 3900 interfaced with a compressor via a supply hose. Seating cushion 3900, containing particles therein, is shown prior to being compressed by a subject object. Seating cushion 3900 may employ the dual valve system discussed hereinabove. Seating cushion 3900 may also include at least a lower back or lumbar support section (not shown).

FIG. 40 depicts an exemplary seating cushion 3900 employing any one of the 3-D impression systems discussed herein, interfaced with a compressor via a supply hose. As shown, the subject object 3920, a person's posterior end, is seated on seat cushion 3900 containing the particles and gas (e.g., air).

FIG. 41 depicts the exemplary seat cushion of FIG. 39, after the subject object has forced a certain volume of the gas from the seat cushion. Visible in FIG. 41 is the captured 3-D impression of the user's posterior end in the seat cushion.

In another aspect, the seat cushion includes an electronic control system where the air, vacuum lock system is at least partially controlled with a heat sensor. When the temperature of the seat cushion is above a desired level, the sensor may trigger air valves to open and permit fresh air to enter the seat cushion. Air can also be forced in by a suitable pumping device such a compressor. In an example of a seat cushion used in a vehicle, the compressor from the vehicle's engine may be utilized. In the example of a wheelchair cushion, a compressor may be positioned on the wheelchair. A remote control may also be used in a wheelchair system to set and release the seat contour.

In another aspect for use in a midsole/insole, seating configuration, or other configuration, an interior airtight covering or skin covers an inside container. For example, in a seating configuration, an outer covering such as a leather covering may not be airtight. An airtight skin or covering layer, such as a vinyl material, may be used. Use of a separate covering allows air to be circulated without “erasing” the contour of the seat.

In another aspect hereof, a golf club (and other exercise equipment and sporting goods having a gripping handle or portion) may include a handle coupled to and/or part of a 3-D capture system for providing a customized or personalized grip. An intake and/or output valve (implemented as either a single valve, a combination valve, or two discrete valves) need not be employed but can be unobtrusively incorporated into the shaft of the, for example, golf club. If employed, the input and/or output valve(s) are preferably located in a distal end of the shaft or at any point along the length of the shaft. The valve may be connected to the club shaft by being screwed, friction fitted, snap-fitted or otherwise operatively coupled to the club shaft. The valve may also be plugged to prevent leaks.

Regarding the valve mechanism, the valve may have an external manually operated air flow control mechanism or an internal automated valve mechanism. The valve mechanism is provided to allow the passage of the gas and/or liquid into and/or out of the hand grip.

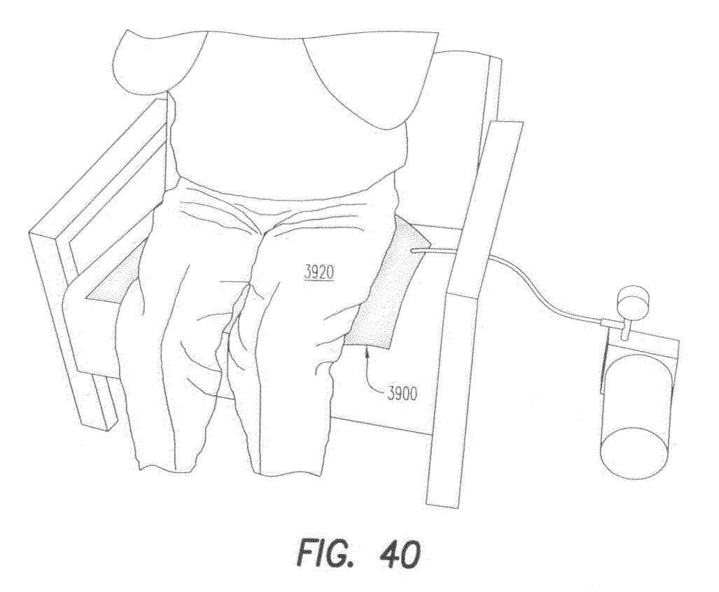

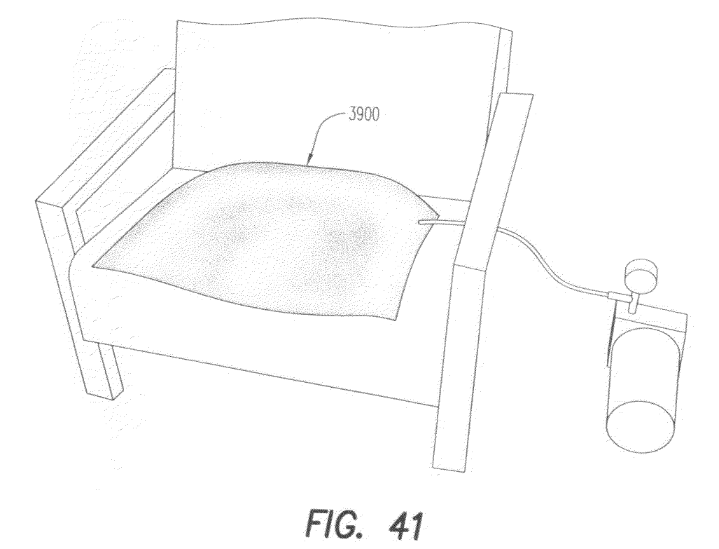

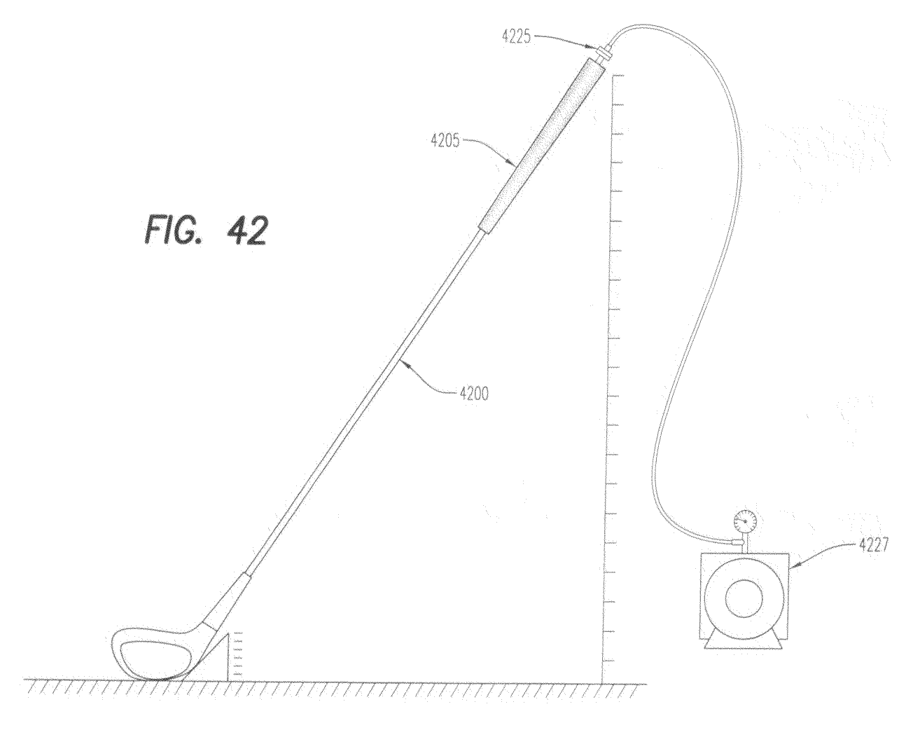

FIG. 42 shows a golf club 4200 having a hand grip 4205 loaded with particles and a volume of liquid and/or gas therein positioned on a golf club shaft. A valve 4225 is located at the proximal end that is operatively gripped by a golfer. The particles are preferably about 1 mm to about 2 mm in diameter, though other sizes of particles may be used. As shown, exemplary golf club 4200 is interfaced with a vacuum compressor 4227 for removing at least a portion of the liquid and/or gas from the particle loaded hand grip 4205.

The shaft of the golf club being fitted with the particle-filled hand grip may be modified internally such that the vacuum line introduce to the interior of the golf club shaft is in clued communication with the particle-filled hand grip. This may be accomplished making at least one aperture, and preferably multiple, in the golf club's shaft in the area covered by the particle-filled hand grip. As shown, the handgrip is sealed at a distal end thereof by a clamp or other method/device and sealed at the proximal end by the handgrip. The handgrip may have a valve located at the proximal end for connecting to the vacuum compressor. The valve can be located at the proximal end of the club shaft by sealing a hollow club shaft with an end cap having a valve port or aperture located therein for receiving the valve that is connected to the vacuum supply line. The clamp and valve operate to provide a sealed environment that can be sufficiently vacuumed to capture a 3-D impression made in the particle-filled hand grip.

The hand grip device hereof also provides the benefit of reducing shock to the user of the club, bat, tool, racquet, firearm, etc. The shape of the particles, for example beads 2 mm in diameter and greater, tend to disperse the force of an impact shock laterally, thus limiting the force transferred to the user. The shape, size, and material of construction of the particles can be varied to enhance the shock absorbency and/or shock dispersing characteristics of the hand grip.

Although the internal surface of the hand grip preferably mimics the surface area of the club's shaft, the hand grip need not follow the size and shape of the club shaft exactly. For example, in the instance of a tapered club shaft, the hand grip may not taper, at least to the extent of the club's shaft. The tapering hand grip can be limited to preserve a sufficient volume in the hand grip for the particles disposed therein in the area of the tapered shaft.

In one aspect, a layer, preferably a thin layer, of memory intensive material such as, for example, urethane foam can be placed or laminated to an underside of the hand grip's outer cover (i.e., skin). The memory intensive material provides an added layer of impression capturing material on top of the particles. The memory intensive material preferably adds to the gripping comfort of the grip handle.

The hand grip, at least the outer contact surface (i.e., skin) thereof, may be constructed of a leather, vinyl, urethanes, etc.

In an aspect hereof, only a portion of the shaft is subject to the vacuuming power of the vacuum compressor connected to the golf club shaft. For example, only that portion of the golf club shaft covered by the handle grip is subject to the vacuuming pressure. This may be accomplished by dividing the golf club shaft into at least two sections using air and liquid-tight seals.

In an aspect herein, the golf club handle including the 3-D capture system may be applied to new golf clubs during the manufacture thereof or applied to retro-fit previously used golf clubs.

The golf handle of the present invention can be implemented as a flexible handle grip having particles contained therein. The shaft of the golf club may be used as a conduit for vacuuming the air from the flexible hosing of the particle-filled hand grip placed on the shaft of the golf club. To facilitate such a vacuuming operation, a number of air passage holes can be made in the golf club shaft, in fluid communication with an inner surface of the particle-filled hand grip. Thus, when the vacuum pressure is applied through a valve connected to the shaft of the golf club, air can then be drawn out of the particle-filled handle grip, thereby capturing a 3-D contour impression of the golfer's grip.

The 3-D impression taking process may be improved by using a vibrator to stimulate (e.g., vibrate) the particles. In this manner, a higher resolution impression may be obtained.

A bead port may be provided to further customize the hand grip by providing an input/extraction port for adding and removing, respectively, additional particles to the hand grip.

The golf club embodiment may but need not include a dual valve system for providing the capability of selectively capturing and erasing the captured 3-D impression until an acceptable impression is obtained, as discussed hereinabove with regard to the dual valve system.

In another aspect of the golf grip embodiment, the flexible housing of the handle grip may be constructed as layers of a sheet-like material having particles disposed therebetween. The sheet-layered, particle filled flexible housing is then wrapped around the shaft of the golf club and secured thereto by any number of methods such as an adhesive, hook and loop fasteners, etc. The layered configuration of the hand grip may have the particles therein located in partitions of the flexible housing. The inner surface of the hand grip that opposes the golf club shaft may be perforated to allow the passage of liquid and/or gas therethrough under the influence of the vacuum compressor. In this embodiment, the vacuum line is placed between the top layer of the hand grip and the bottom layer of the hand grip, thus obviating the need to modify the shaft of a conventional golf club.

The golf club is shown juxtaposed with a scale that is referenced in the “fitting” of the golf club to the user. As shown in FIG. 42, there is a scale for determining the angle between the golf club's shaft relative to the floor or ground (i.e., a reference surface), and a scale for determining the angle between the golf club's head relative to the floor or ground (i.e., a reference surface). Additionally, a reference scale can be used to determine and fix the angle between the club shaft and the golfer's body and/or arms when the golfer is in position for addressing a golf ball.

To facilitate the fitting of the golf club to the individual golfer, a holder, block, and/or guide may be used to assist in determining and maintaining the golf club in a desired position to “fit” the individual golfer.

Optionally, a thumb positioning mark or reference may be placed on the hand grip to provide a tactile and/or visual cue to alert the golfer that their hands are properly aligned with, preferably, the center of the club's head. By virtue of properly aligning their hands with the club, a club that is preferably fitted to the golfer, there is an increased likelihood that the golfer is properly aligned with the golf club to execute a properly aligned golf shot. The thumb positioning mark may have reference indicators for one or both thumbs of the users hands. Optionally, grooved gripping channels may be used as an aid in providing tactile and visual cues for alignment of the user's hands on the hand grip.

The desired and proper alignment of the thumb positioning mark or reference relative to the club's head can be maintained by gluing, pinning, screwing, clamping, or otherwise affixing to the shaft of the club so as to prevent a change in the relative position between the club head and the thumb positioning mark. In one aspect hereof, a slip-resistant material such as a rubber layer of material having a coefficient of drag greater than the club's shaft is disposed between the club's shaft and the hand grip. The slip-resistant layer of material provides additional drag and thus tends to resist the turning of hand grip on the club's shaft.

The grip handle may be partitioned internally to maintain a certain volume of the particles within the various partitioned sections thereof. This provides, for example, a substantially uniform distribution of the particles over the area of the grip handle.

Once the golf club is properly gripped and aligned by the golfer, using the scales shown as reference markers, the excess liquid and/or gas is vacuumed out using the compressor. In this manner, the golf grip handle locks in a placeholder for the golfer's hands in the proper “aligned” position. Therefore, the locked 3-D contour of the golfer's grip obtained by the 3-D compression capture system herein can be used as an alignment mechanism for aligning the golfer in not only the proper grip, but the overall aligned and proper golf swing alignment position.

The grip handle may also be partitioned into two separate component grips, which may minimize excess space in the grip. This embodiment may make it easier to evacuate air/liquid that is not directly under the hand during fitting. In this embodiment, each of the two component grips may have its own valve system.

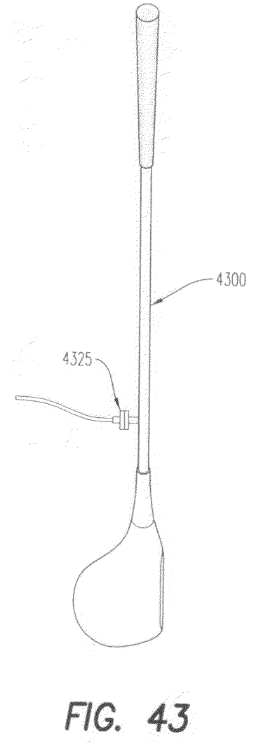

FIG. 43 shows a golf club 4300 wherein a valve 4325 is located at a position along the shaft of golf club 4300.

Although the hand grip is discussed primarily in the context of a golf club grip, the grip handle may be applied to a golf club, a baseball bat, an archery bow, all forms of sport racquets, ski pole handles, pole vault poles, race car steering wheels, bicycle handlebars, a firearm handle (e.g., a pistol grip), power tools, hand tools, etc.

A benefit of the customized grip handle is that the personalized grip handle having the 3-D impression contour of the user's hands in an optimum, aligned position can be used to guide the user's hands to the proper positioning location each time the user picks up the golf club. In the event the user's optimum alignment position changes and/or needs correcting, the current impression can be erased by re-introducing a volume of liquid and/or gas into the grip handle and then making a new 3-D impression of the user's grip.

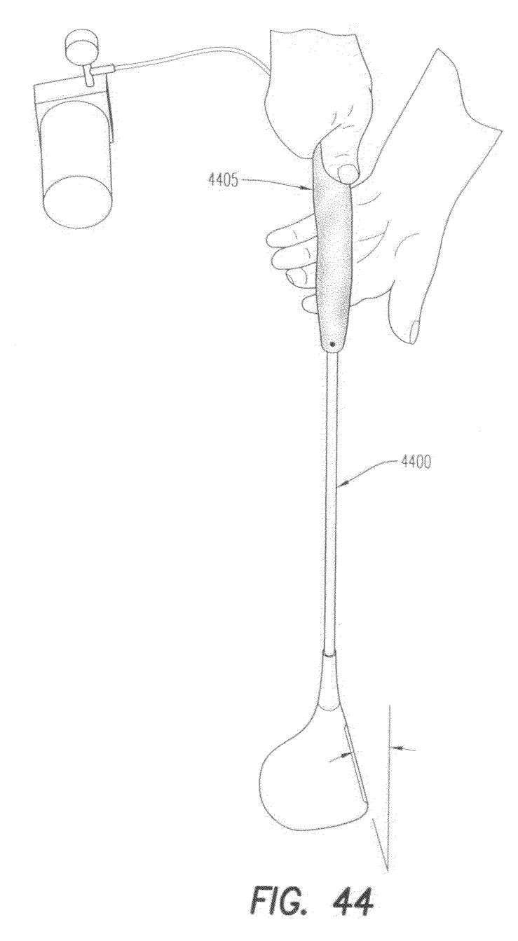

FIG. 44 shows an exemplary golf club 4400 with the club head centered to a ground reference mark, and the shaft angle to the ground and to the club holder. The thumb positioning reference is made on a grip handle 4405 after the angle of the club shaft and head are fitted to the golfer and an impression is made. Of note, the thumb positioning reference is centered to the golf head. In the event the impression is erased, the thumb positioning reference marks can be used to obtain the proper hand alignment with club 4400 prior to taking a new impression. In this manner, the “fitting” of club 4400 will not have to be repeated.

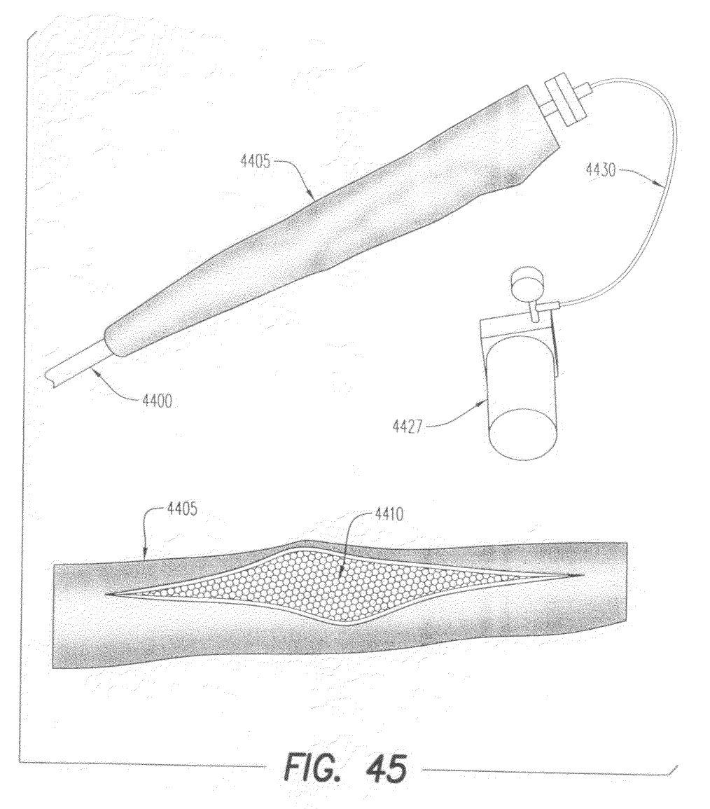

FIG. 45 depicts an exemplary view of golf club 4400 connected to a vacuum compressor 4427 via a supply line 4430 at the proximal end of the golf club shaft. Also shown are impression markings on grip handle 4405. Also shown is a detailed view of grip handle 4405, with the internal particles 4410, here beads, visible.

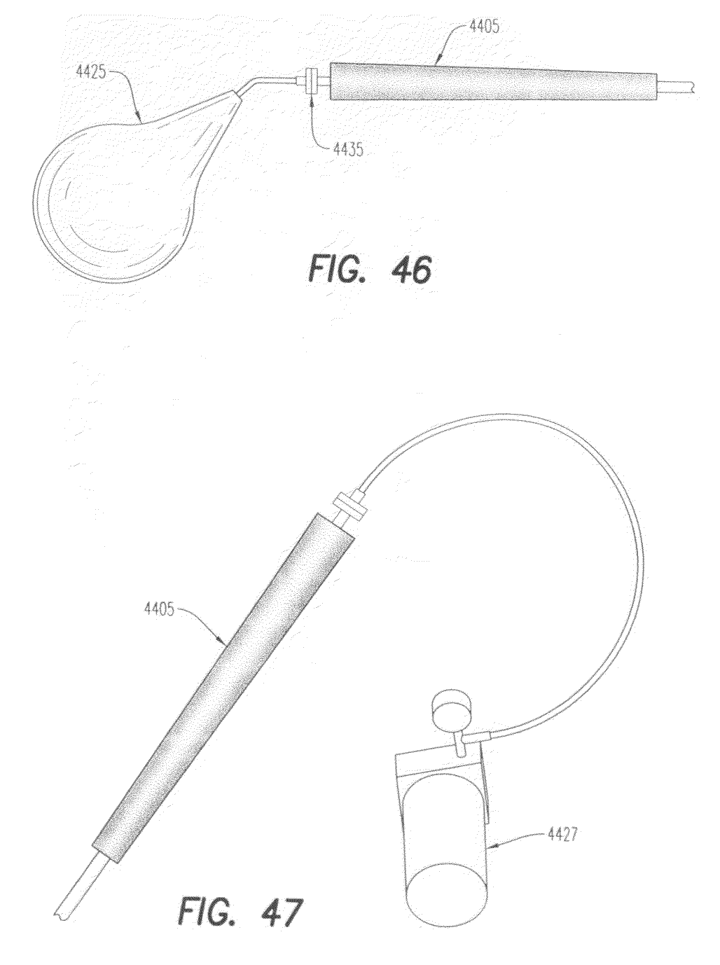

FIG. 46 depicts a schematic of a manual mechanical pump 4425 for removing air from hand grip 4405. Valve 4435 may be a one-way check valve.

FIG. 47 depicts a schematic of hand grip 4405 connected to vacuum compressor 4427, which is connected to hand grip 4405 for removing air from hand grip 4405.

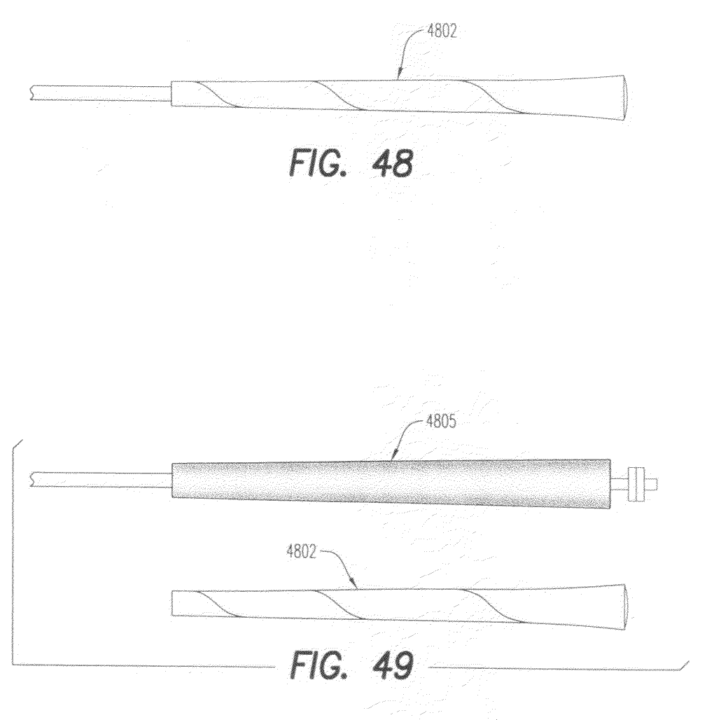

FIG. 48 depicts a conventional golf club grip handle 4802.

FIG. 49 depicts both conventional golf club grip handle 4802 and a grip handle 4805 hereof that provides a 3-D impression of a user's proper, aligned hand position.

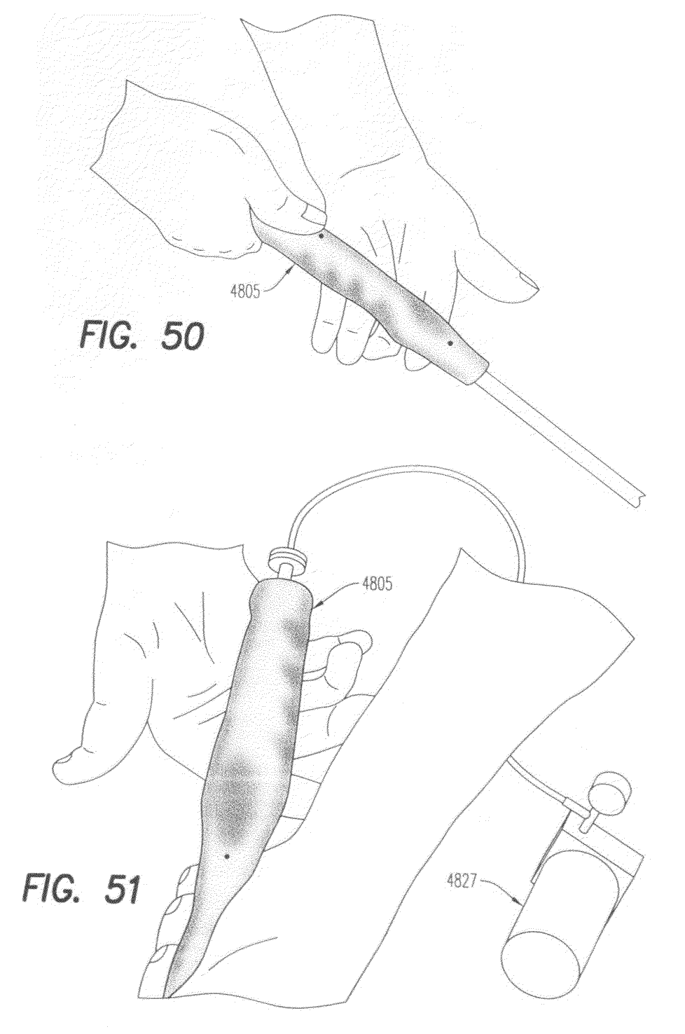

FIG. 50 depicts exemplary grip handle 4805 hereof, including a detailed view of the two thumb reference marks thereon.

FIG. 51 depicts exemplary grip handle 4805 hereof, including a detailed view of the upper thumb reference mark and the vacuum compressor 4827 supply line connection.

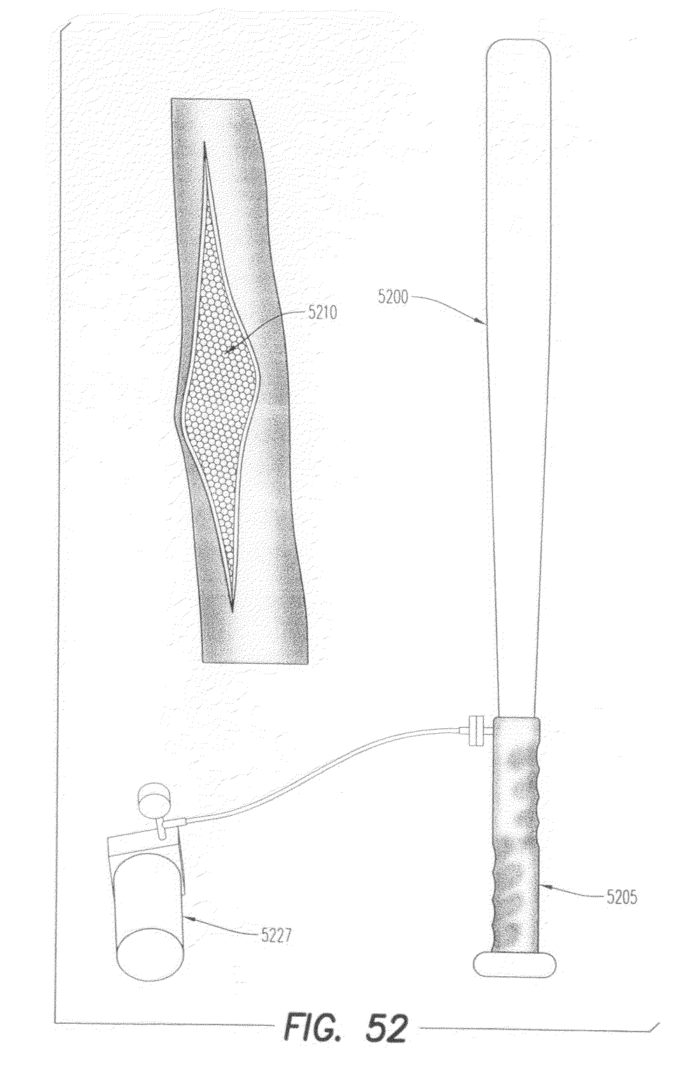

FIG. 52 depicts a baseball bat 5200 having a handle end thereof fitted with a grip handle 5205 of the present teachings. Grip handle 5205 is shown connected to a vacuum compressor 5227. Also shown, there is a detailed view of beads (particles) 5210 disposed on the interior of grip handle 5205.

In the instance of a wood baseball bat, it is preferable that a reference mark for aligning the user's hands with the handle of the bat considers the grain of the bat. The hands should be positioned on the bat during the 3-D impression making process so that when the bat is gripped per the 3-D impression, the grains of the wood bat are aligned to minimize the risk of breaking the bat when hitting a baseball.

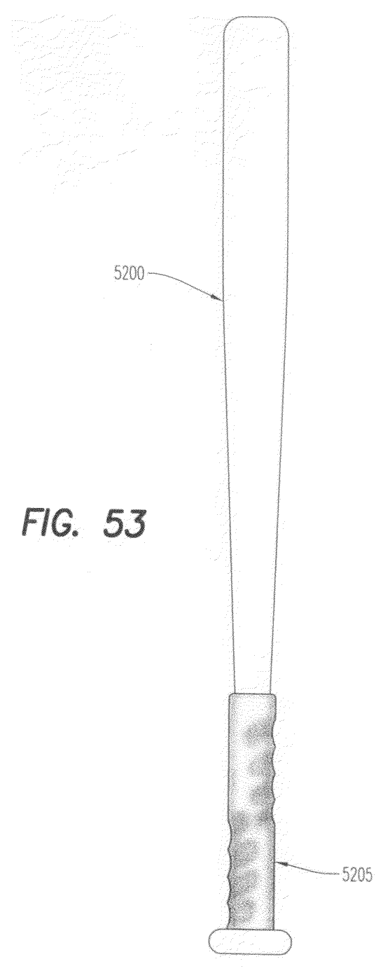

FIG. 53 depicts baseball bat 5200 of FIG. 52, with a locked 3-D impression in grip handle 5205.

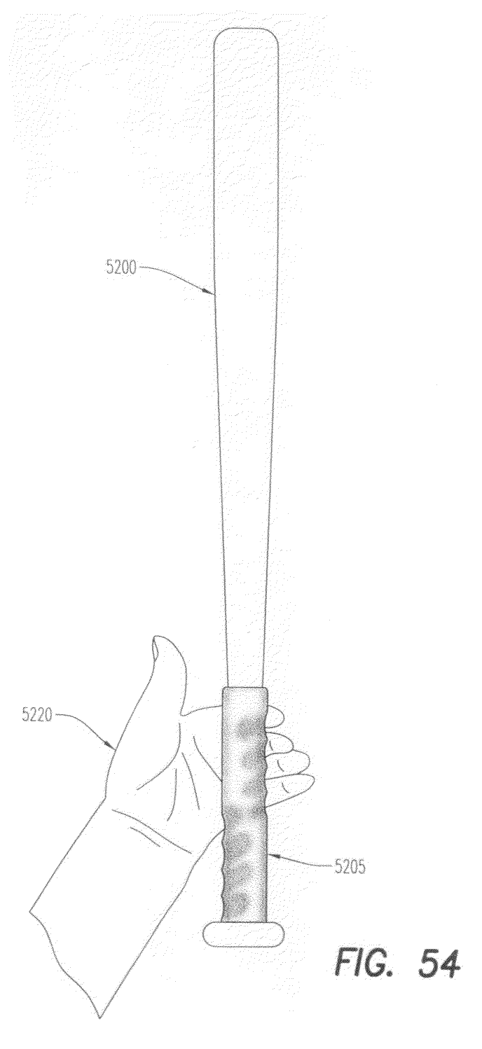

FIG. 54 depicts baseball bat 5200 of FIG. 52, juxtaposed with a hand 5220 of a user to illustrate the custom fit obtained by personalized grip handle 5205 hereof.

In embodiments of customized hand grippers of the disclosure, the containers of the particles or beads can be devoid of air lines and/or valves. For example, flexible gripper containers can be made of micro-porous material or material that has small perforations and/or air holes therethrough to ambient atmosphere. This is to allow the user, in gripping the container, to force resident air and/or liquid out of the container and thereby permit a customized or personalized gripping contour of the gripper container to be formed. Some or all of the particles or beads in the container need not be, but can be and preferably are, pre-coated, doped or treated with a viscous, preferably highly viscous, sticky lubricant, sealant or other material having the disclosed adhesive properties to prevent non-user forced or random migration of the particles out of their personalized or customized orientation. The lubricant per se or on and/or about the particles, or the particles can plug the perforations and thereby prevent air from entering or re-entering the container. The size of the perforations preferably is from micro-porous to less than the size of the smallest particles.

Another aspect includes a self customizing inflatable metatarsal arch support. The arch support can include an airtight shaped metatarsal arch shaped support pad and an attached air line. The support pad is inserted inside a shoe and/or midsole or innersole, so that the air line outlet is positioned outside of the shoe. Air can be forced or allowed into the support pad through the air line to increase support. The device may include open cell foam inside the support pad which is compressed when pressure is added and expands when pressure is released to draw air into the support pad through the air line.

In another aspect, the self customizing inflatable metatarsal arch support is manufactured with the support pad filled with air. A one-way valve is attached to the air line. When pressure over a certain amount, e.g. 1 LB, is applied, air is expelled. When the pressure reaches the comfort support level, the line may be plugged to prevent further air from escaping.

Another footwear embodiment includes beads that are laminated, i.e., adhered, into a single sheet. The beads may be formed into a midsole or insole shape, or a midsole/insole shape may be cut from a section of laminated beads. In one embodiment, the beads are permanently adhered together to form a midsole/insole shaped mass, such as a sheet of laminated beads cut into an insole/midsole shape.

In another embodiment, a midsole or insole is provided that includes both laminated beads and loose beads. The loose beads may be coated with a viscous adhesive or lubricant with the disclosed adhesive properties to inhibit migration. For example, a combination insole having sections with coated or uncoated beads, such as the heel section, and sections having laminated bead-sheets, such as the midfoot and forefoot sections, may be used. Such insoles/midsoles may be easier and less time consuming to manufacture than an insole/midsole fully consisting of loose beads.

The beads, also referred to as particles, either loose or sheet beads, may consist of one or a combination of various materials including gels, urethanes, polyethylene, polypropylene, polyurethanes, EVA (ethylene vinyl acetate), sponge rubber, leather and vinyl.

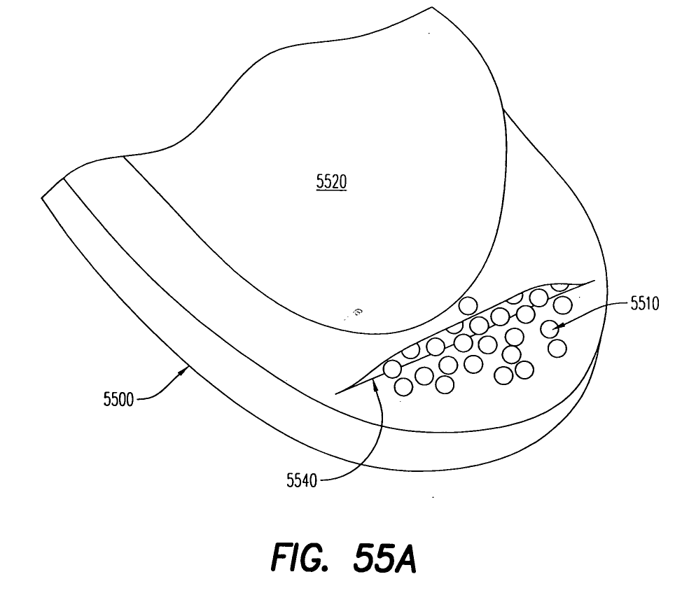

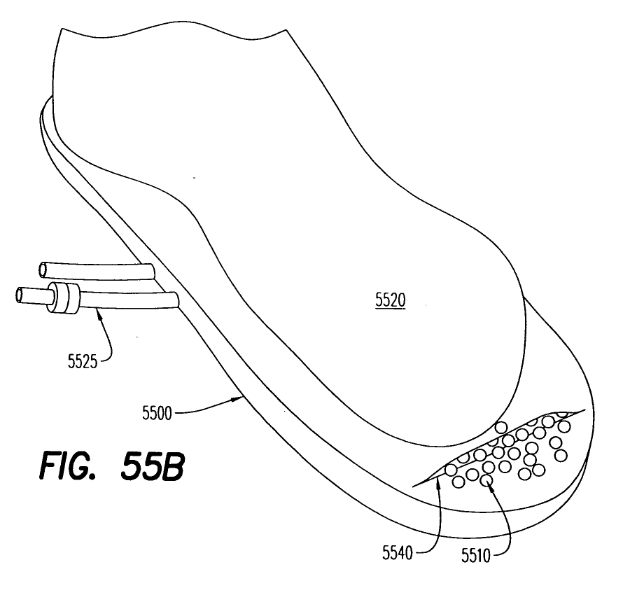

In another aspect, an opening, such as a slit, is located on the container to allow excess beads to escape from the container when pressure is applied. FIGS. 55A and 55B illustrates an example of this aspect. Midsole 5500 is shown having an opening 5540 through which excess beads 5510 escape midsole 5500. FIG. 55B also shows valve system 5525.

A patch is located over the opening to allow excess beads to escape but prevent air from entering. The patch may be a logo. In the embodiment of a sandal or an innersole, the opening should be located on an area of the sandal or innersole that would not be covered by a foot when worn. When pressure is applied to the foot, the opening and patch allow excess beads to escape but does not allow air to re-enter when pressure is removed.

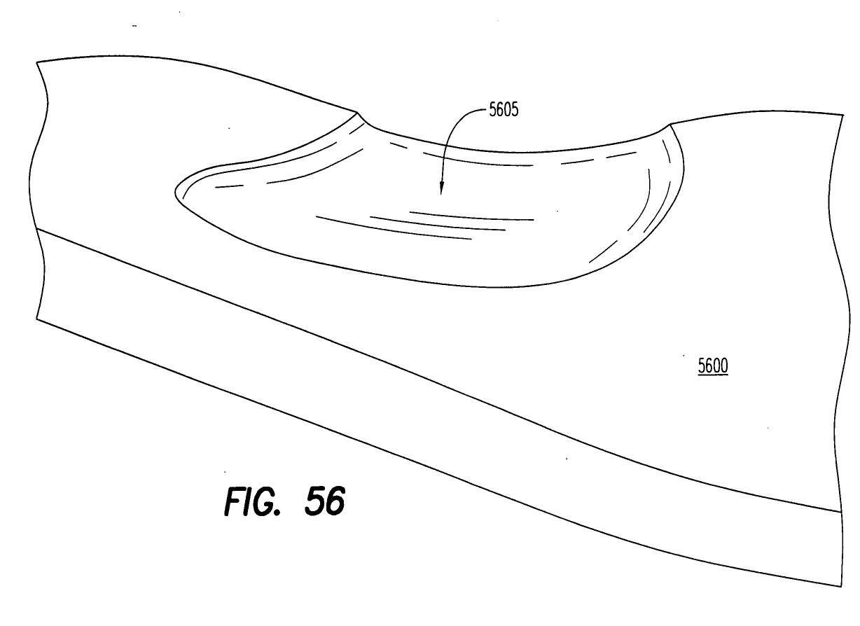

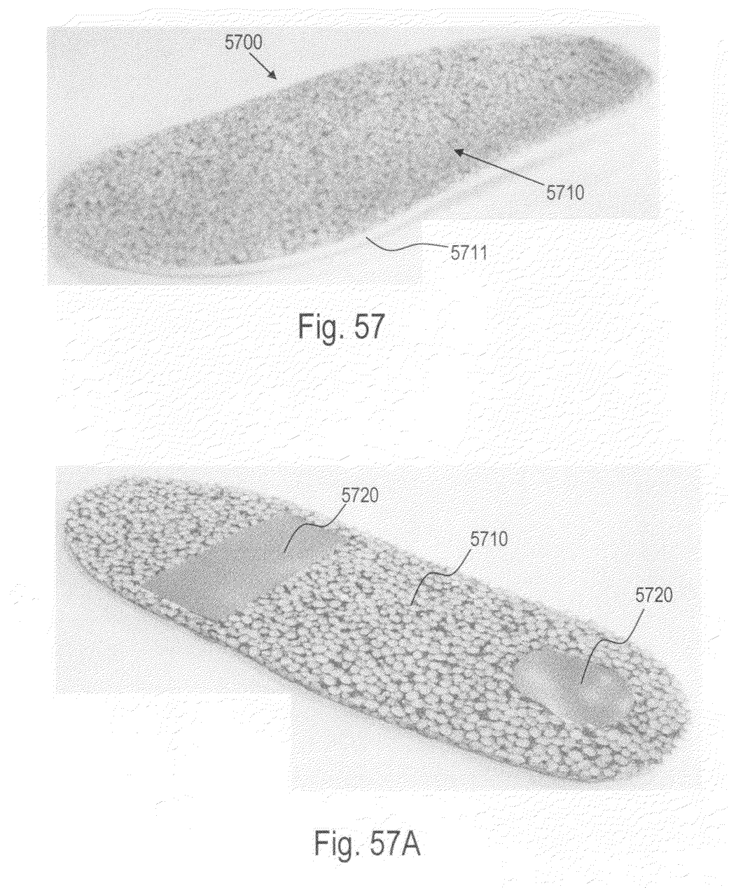

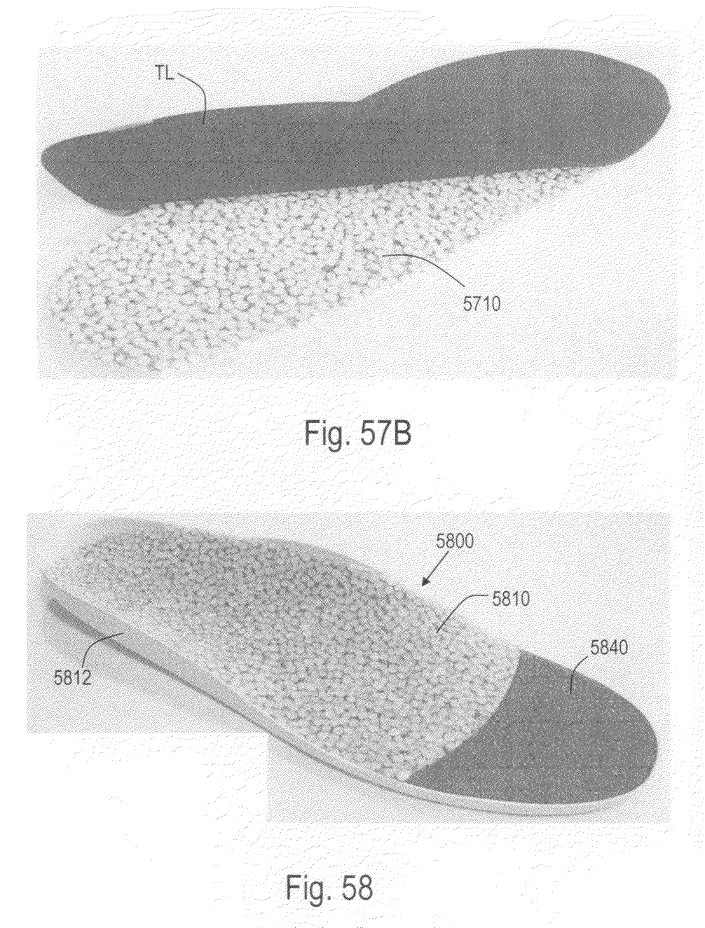

FIG. 57 is a top perspective view of an insole or midsole 5700 showing an exposed full-length laminated particle sheet 5710 comprised of portions of compressible polyurethane beads whose lower surfaces are adhered to a backing 5711. In this embodiment, the particles, originally circular, have upper and lower segments of their circular shape cut off and removed so as to present individual upper and lower bead surfaces and overall laminated sheet surfaces that are substantially flat.

As shown in FIG. 57A, particle sheet 5710 may also include selected cutouts, preferably on the bottom surface, that can be filled in with selected resilient support pads 5720, here shown in the heel and forefoot sections of particle sheet 5710. Particle sheet 5710 may be included in an insole, midsole or other configuration. Resilient pads 5720 may consist of various materials or substances such as urethanes or EVA, gels or air. FIG. 57B shows a top layer TL about to be secured to a particle sheet 5710.

FIG. 58 is a top perspective view of a midsole 5800 having the heel and midfoot sections of a base layer or base support shell 5812 covered by a ⅔rds foot length laminated particle sheet 5810, and a forefoot section and toe section filled with coated or uncoated particles 5840. Additional layers and an airtight top layer can be employed but are not shown.

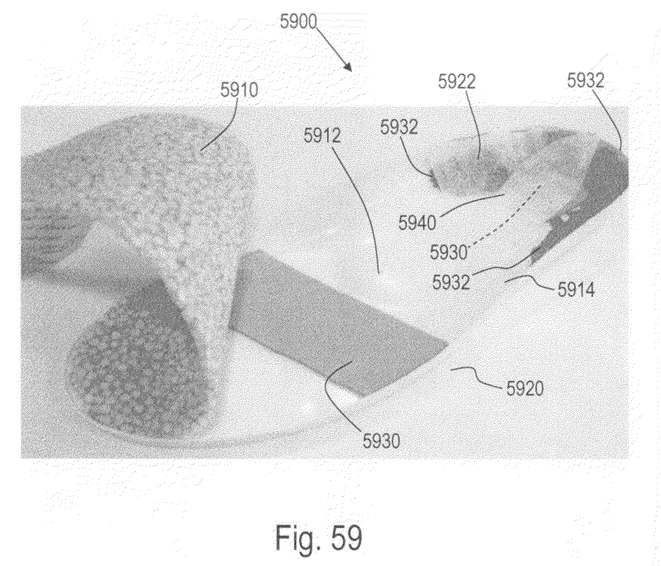

FIG. 59 is a top perspective view of midsole 5900, in which particle sheet 5910 is partially removed. Midsole 5900 includes base layer or base shell support layer or container 5920 that has molded metatarsal and lateral arch supports, 5912, 5914, a resilient pad 5930 respectively in the heel and forefoot sections of container 5920, and lubricant-coated or uncoated beads/particles 5932 partially surrounding cushioning or support pad 5930 under slip layer 5940 in the heel section. Slip layer 5940 is constructed of a material that does not adhere to the coated or uncoated beads/particles 5932. Non-adhesive thin slip layer 5940 is shown with a portion of it folded up toward the center of the heel, away from and to show beads/particles 5932.

As shown in FIG. 59, thin slip layer 5940 is laid over beads 5932. In this example, a preferred one, slip layer 5940 allows beads 5930 are allowed to migrate to the heel center area and preferrably also toward the forefoot by, for example, adhesively attaching slip layer 5940 in the or a selected mid-heel area and about the periphery 5922 of the heel section or cup. It has been found that one or more lubricants does not stick to the slip layer as well as they stick to other surfaces. This assures that each midsole has the same heel elevation to prevent disparities in leg length. In other less preferred embodiments, a bead or a plurality of beads may, for example, be present, or a layer of beads may be loosely provided in or secured to the center of the heel in place of or on top of a resilient pad. In such an embodiment, an adhesive layer may be included in the mid-heel section to hold the beads in place. A mid layer such as slip layer 5940 may also be adhered to the layer of beads to prevent migration of beads around the heel center. In other less preferred embodiments, an equal amount of beads is provided in the center and periphery of the heel section of a midsole. If beads are provided or are present in the or a center area of the heel support portion, preferably they do not present discomfort to the wearer's foot. Accordingly, the beads that are present preferably are very small, or fine, for example about 0.5 mm and/or are covered with a firm, substantially firm or dense top layer, or upper layer or portion thereof that does not allow the beads to protrude or form upward protruberances in the upper surface of the top layer that would cause discomfort to the wearer's foot.

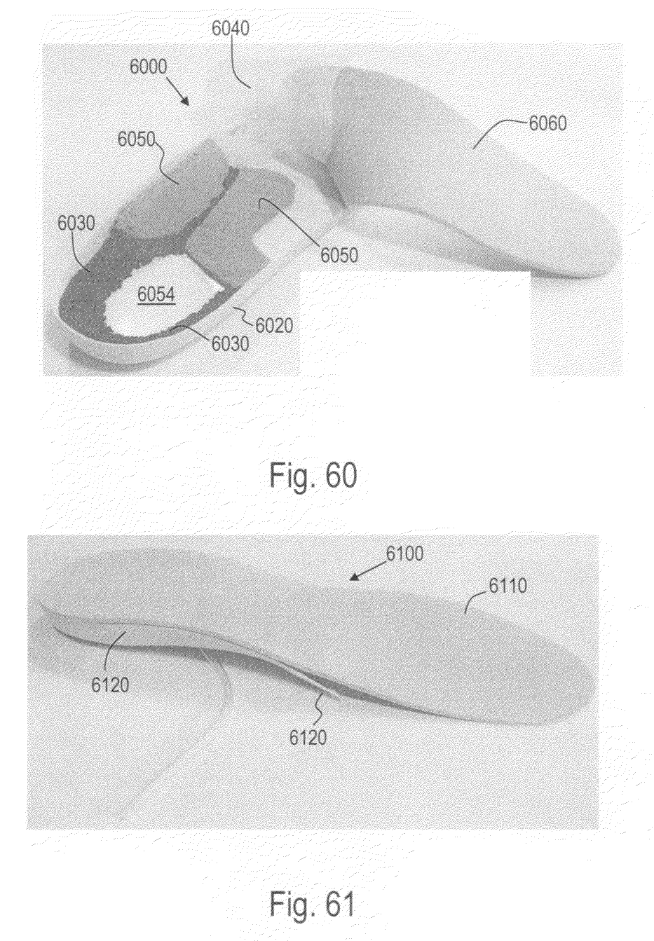

FIG. 60 is a top perspective view of a midsole 6000 comprised of base layer or support shell or container 6020 and top sponge or resilient layer 6060 (partially removed). Container 6020 has beads/particles 6030 in the heel peripheral and arch sections, and shows arch and metatarsal support pads 6050 and a slip mid line layer 6040. Beads 6030 are located about the periphery of heel support pad 6054 and under forward heel support pads 6050. Slip layer 6040 is to overlie the beads and forward pads to prevent the beads from excessively migrating.

FIG. 61 is a top perspective view of an insole 6100 including a full length air-sealing top layer 6110 and a ⅔ length insole base or base layer 6120.

In another embodiment, footwear may include one or more layers of thermal material, i.e., a thermoformable material. A thermal material layer may be of varying thicknesses and hardnesses. For example, a thermal material layer having a thickness ranging from 1 mm to 6 mm, and may have a hardness ranging from firm, e.g., about Shore A 50 to 100, or soft, e.g., about Shore A 10 to 50. The thermal material layer may be single layer film or structure, or a multilayer film or structure, e.g., extruded with or laminated to an additional thermal material layer, or an additional layer of any other suitable material, having a similar or different thickness or hardness.

In another embodiment, thermal material, e.g., thermoplastic, layers are included in conjunction with particles for conforming to the shape of an impression. For example, a full length midsole layer of thermal material may be included with a ⅔ length orthotic. The orthotic includes particles to conform to the shape of the heel and hold the shape upon evacuation of air. The thermal layer offers additional conforming to the toe area. The heat-activated thermal material is activated by the heat of, and deformed by the pressure of, a foot. Upon removal of the foot, the thermal material retains the impression of the toe and forefoot, as well as an impression on that portion of the thermal layer over the orthotic. In another embodiment, the thermal material is included over a portion of the insole/midsole, such as over the forefoot. If a thermal layer and/or plastic type, e.g., thermoplastic beads or particles are employed, caution must be used in connection with exposure of one or more layers thermal layers or materials to radiant energy such as, for example, microwave or other high temperature ovens. The high heat may cause the thermal material or plastic-type beads to shrink or melt. Accordingly, high heat resistant materials and beads are preferred, or must be used.

In another embodiment, a midsole or insole is provided that includes particles and a thermal material layer. No evacuation of air is necessary, and thus there is no need for a valve system. Air may be evacuated from the midsole/insole during manufacture. Upon pressure from a foot, the thermal material will conform to the shape of the foot and retain the shape after the foot is lifted. In other embodiments, air holes are employed in the base support layer and/or the upper layer, or overlayer material is porous to air and therefore a valve or valves are not needed or employed.

In another embodiment, a midsole insert is provided consisting of coated or uncoated particles within an airtight flexible layer of material. For example, the particles may be within a thin sealed plastic layer. The plastic layer does not serve as a midsole container, but rather is inserted into a midsole or midsole cavity of a shoe or sandal. The midsole/midsole cavity dictates the shape formed by the insert. Also included is a valve system including an airline and valve for evacuating air. The valve system may extend through a side of the shoe/sandal, or upward toward the top of the shoe/sandal.

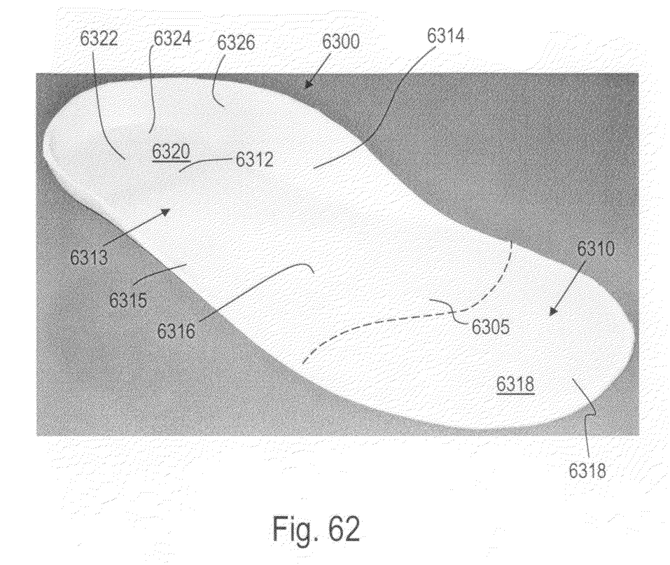

FIGS. 62-66 depict an orthotic or insole comprised of a base shell support layer, herein also referred to as a support, base, or base layer, for example, 6300 comprising a first section 6305 having a shell or container in which particles are contained, and, shown delineated from the first section by a dashed line, a forefoot or second section 6310 that is a solid or integral section which in the embodiment of FIGS. 62-67 contains no particles. First section 6305 can be in any configuration as described herein, and may also include an air line or valve system to introduce or remove air, gas and/or liquid from section 6305. In this embodiment, first section 6305 has a length of approximately ⅔ of the length of support or base layer 6300. Preferably, first section 6305 is of a length approximating the heel and metatarsal sections of a foot. Second section 6310 provides support to the forefoot including the toes, and is preferably a solid layer or multiple integral layers of material. In this embodiment of second section 6310, there is no cavity or container in which particles can be inserted or to which particles could migrate. In this embodiment, the particles, and thus the contouring portions, of support or base layer 6300 are restricted to the approximately ⅔ length section 6305.

Because particles are restricted in this embodiment to first section 6305, forefoot second section 6310 has no side wall and may be of a relatively small thickness compared to the heel/metatarsal section 6305. This relatively small thickness can be from about 1/16^{th} inch to about ⅛^{th} or to about 3/16ths of an inch or slightly greater. This feature provides low forefoot sections of base layer 6300 which can be inserted into and comfortably fit in the forefoot sections of many varieties of or most footwear.

FIG. 62 shows a top forward side perspective view of a full length insole base layer 6300. The insole is for placement into an article of footwear to support the planter surface of a wearer's foot. Base layer 6300 preferably is semi-rigid. It has an upper surface and includes a heel support section or portion 6312, a transverse arch support 6313, a medial arch support portion 6314, a lateral arch support portion 6315, a metatarsal support portion 6316, a transverse arch support and also, in the full length version, a forefoot support portion 6318. Arch support portion 6314 and metatarsal support portion 6316 are shown as built-in upwardly arched or domed contours.

Heel support portion 6312 of base layer 6300 has an upwardly facing preferably substantially flat interior bottom wall 6320, the bottom wall having a central area 6322, and a peripheral area 6324 substantially surrounding central area 6322. Base layer 6300 also has a peripheral wall 6326 that extends upward from the outer periphery of the bottom wall. In a preferred embodiment, peripheral wall 6326 of heel support portion 6312 is substantially vertical relative to the bottom wall of heel support portion 6312.

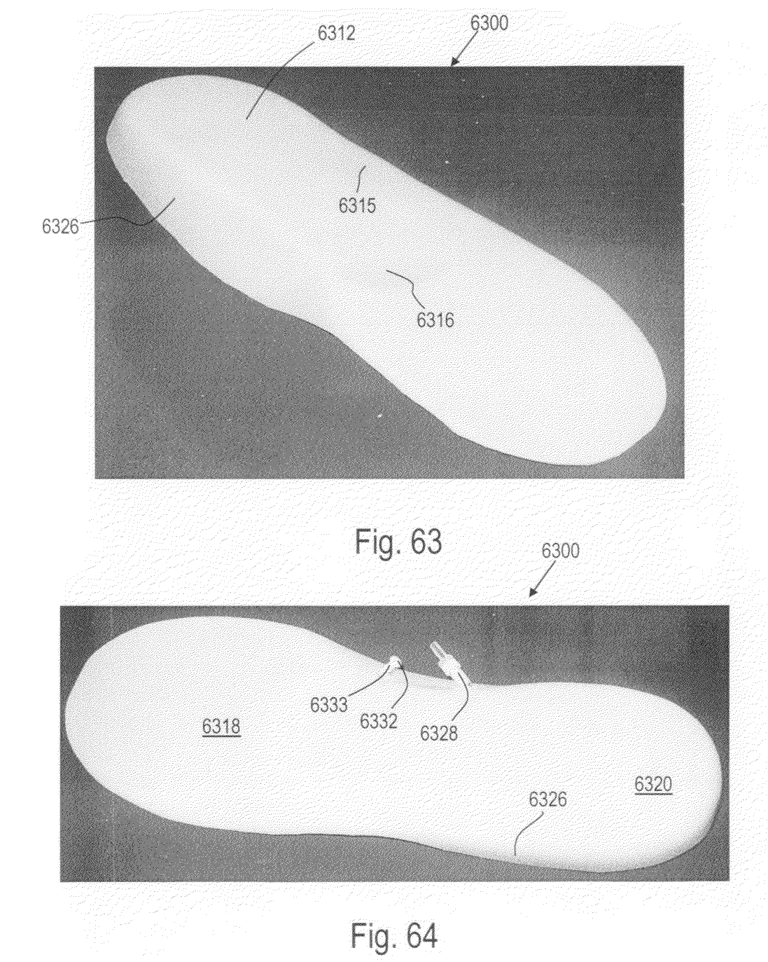

FIG. 63 depicts a bottom side perspective view of support or base layer 6300, showing lateral arch support 6315 just forward of heel support portion 6312 (not shown), and well forward of that, built-in recessed or concavely formed and contoured metatarsal arch support 6316.

FIG. 64 is a bottom view of an embodiment of base layer 6300 that includes an optional one-way valve 6328, and an optional air line 6333 that includes a plug 6332. FIG. 64 also shows substantially vertical side wall 6326 of heel support portion 6320.

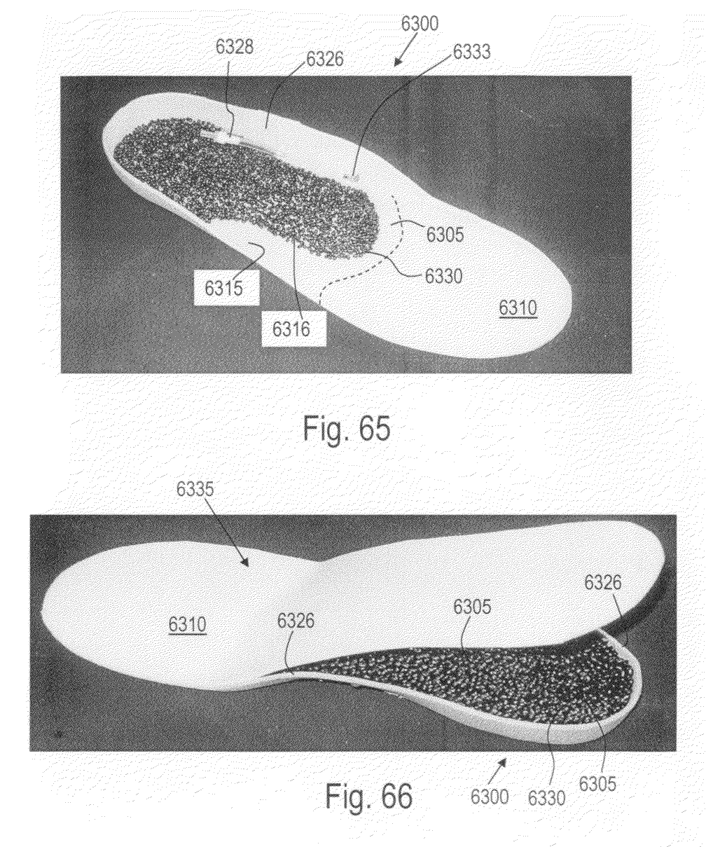

FIG. 65 shows an interior view of support or base layer 6300. A single layer of particles 6330 is disposed in and secured, here, e.g., adhered, to first section 6305, here including heel support portion 6312 (not shown) and extending forward into lateral arch support portion 6315 and metatarsal arch support portion 6316. Preferably, the bottom of first section 6305 has a layer of adhesive, for example a layer of double adhesive sided tape (not shown). FIG. 65 shows the optional interior ends of the line for valve 6328 and of air line 6333 protruding through side wall 6326 into the interior of the medial arch portion of base layer 6300. FIG. 65 also shows that in this embodiment, the forward portion of base layer 6300 is flat and does not have a peripheral rim.

FIG. 66 shows an upper layer, here shown as the top layer 6335 that is added to support or base layer 6300 of FIG. 65. The roughly ⅓^{rd} foot length of forefoot second section 6310 of support or base layer 6300 is shown secured, in this embodiment adhered to top layer 6335, thereby sealing off that section of the insole and also securing particles 6330 in the approximately ⅔^{rds} first section 6305, when that section of the top layer is secured to that section of the underlying support or base layer 6300 in accordance with this disclosure. In this embodiment, top layer 6335 is, as shown, preferably of a length and profile substantially equal to the length of a foot, or the length and profile of support 6300. When top layer 6335 is secured as described above and is secured to base layer about the periphery of first section 6305 of base layer 6300, first section 6305 forms a shell or container for particles 6330. Sealed second section 6310 forms a flat integral layer preferably having no space therein. Section 6310 is thus a relatively thin section. In the embodiment shown, forefoot second section is about ⅛″ thick. In this or other embodiments, preferred thicknesses of section 6310 include 1/16″-⅛″, 3/16″, and thicker, as suitable to fit into the forefoot section of the footwear with which or in which the insole or midsole is to be employed.

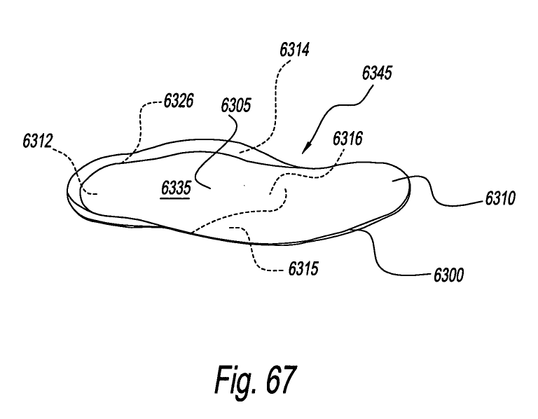

FIG. 67 shows a side perspective view of a finished insole 6315 as might be formed from the partially completed insole of FIG. 66. More particularly, FIG. 67 shows an upper layer, such as flexible top layer 6335 of the partially completed insole of FIG. 66 after it has been placed on and secured, e.g., adhered, to base layer 6300, overlying, for example, transverse arch support portion 6313 (not shown), medial arch support portion 6314, lateral arch support portion 6315, metatarsal arch support portion 6316, and heel support portion 6312 (dashed lines). Preferably, top layer 6335 is fully secured, preferably fully adhered, to the interior surface of peripheral wall 6326 and the remaining peripheral areas of base layer 6300 of FIG. 66, to thereby provide a finished full length insole 6345. FIG. 67 shows a top layer 6335 that has a radiused or bowl shaped heel portion. The arcuate dashed line shows the distal edge of the raised, domed contour formed as the metatarsal arch support 6316 in the top layer of the finished insole. Top layer 6335, preferably being flexible, preferably follows or takes the shape of the underlying contours of base layer 6300, although top layer 6335 can have molded-in shapes or contours that correspond to those of underlying base layer 6300.

In FIG. 67, all particles are disposed in first section 6305. Finished insole 6345 has a second forward section 6310 that is secured to an approximately ⅛ inch thick base layer toe support portion. As will be disclosed herein, full length insoles can be provided without use of a full length base layer. They can be provided by use of a ⅔rds length-of-a-foot support or base layer, or with a ⅔^{rd} length or shorter, e.g., a ⅓^{rd} length heel cup.

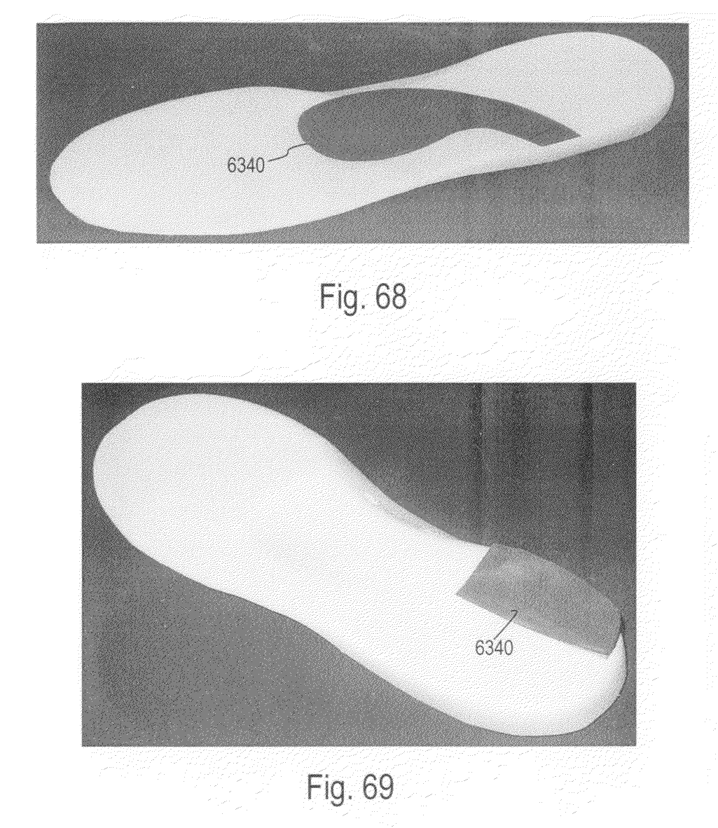

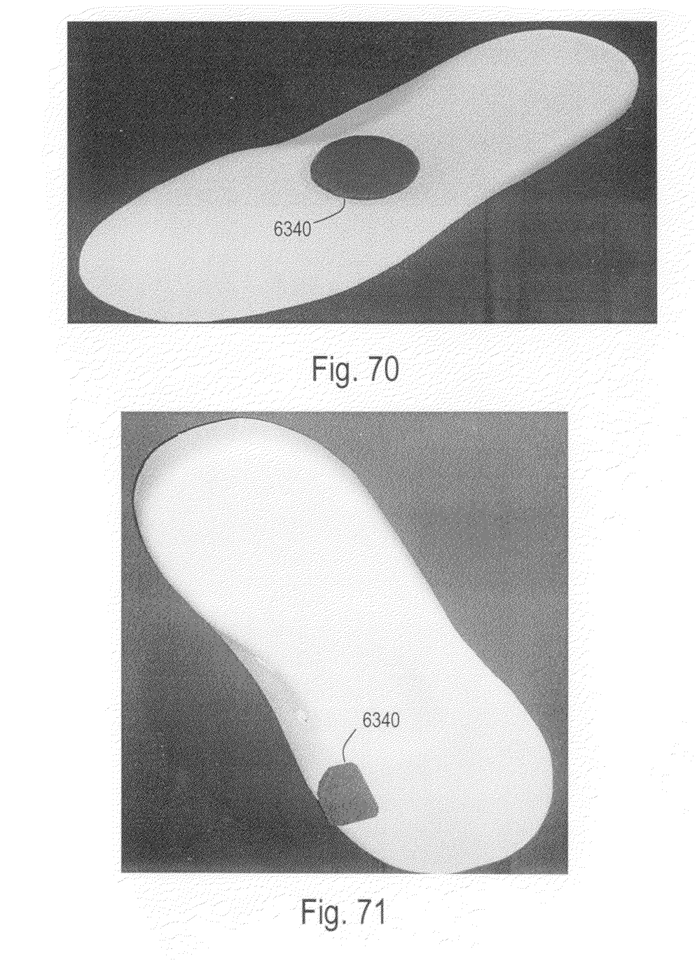

In other embodiments, support or base layer 6300 can include one or more additional support pads, posts, wedges or patches, generally designated 6340, to provide general or specific additional support to any one or more areas of the base layer, a few examples of which are shown in FIGS. 68-71A. FIG. 68 depicts a support pad or patch 6340 extending under the metatarsal arch to the lateral arch. FIG. 69 shows a heel wedge form of support pad 6340. FIG. 70 shows a metatarsal arch support pad 6340, and FIG. 71 shows support pad 6340 under the first metatarsal head portion of support or base layer 6300.

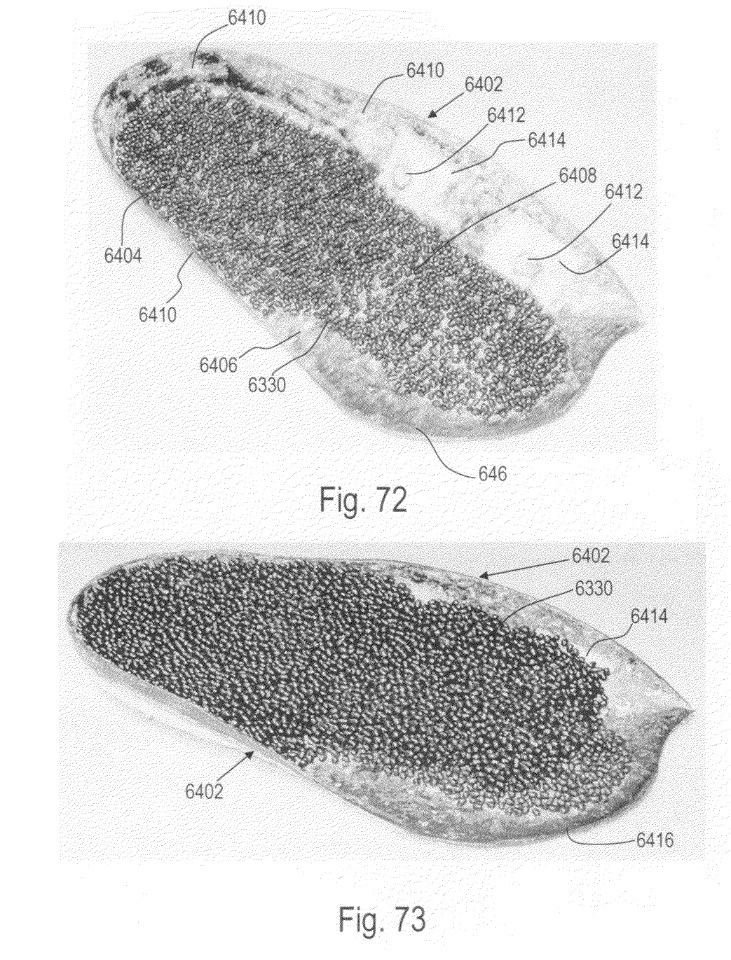

FIG. 72 is a top perspective view of a ⅔ length base shell support layer 6402 for forming an insole or orthotic 6400 (not shown). Base layer 6402 is comprised of a heel support portion 6404, a lateral arch support portion 6406 and a metatarsal arch support portion 6408. Base shell support layer 6402 includes a peripheral side wall 6410 that communicates with and surrounds the aforementioned support portions. In the embodiment shown, the medial portion of peripheral wall 6410 has optional holes 6412 that can communicate, for example, with a vacuum air line or an air line (not shown), or serve as air holes to communicate with ambient atmosphere. Holes 6410 are shown covered with an air permeable membrane 6414 each of which prevents egress of particles 6330 through holes 6412. The upper surface of base layer 6402 is substantially covered with an adhesive, preferably a two sided sticky tape (not shown) and particles 6330 are adhered thereto over substantially the entire upper surface of base layer 6402. In the embodiment shown in FIG. 72, the area of the lateral arch 6406 and the forward or distal edge 6416 of base layer 6402 does not have particles disposed thereon. Preferably, the forward or distal edge of the ⅔rds length base layer and of heel cups of the disclosure is skived in one or more of the manner(s) disclosed herein to provide a smooth transition to and/or from the edge for the comfort of the wearer's forefoot relative to the underlying supporting footwear. Also preferably, all or a portion of the upper edge of peripheral side wall 6410 of base layer 6402 or 6402″ along the edge of the medial arch can be skived to smooth the edge for securement to and comfort relative to the upper edge of the adjoining peripheral wall of a top layer (not shown). These preferences also apply to other embodiments and FIGs. of the disclosure, for example, FIG. 73 below.

FIG. 73 is a view similar to that shown in FIG. 72, except that more particles 6330 are disposed on and secured to base layer 6402, for example, such that in FIG. 73 particles 6330 are deep enough to substantially cover membranes 6414. The base layer 6402 having particles disposed thereon are ready to receive a flexible or semi flexible top layer or overlayer (not shown) to be laid over and secured to base layer 6402 to form a finished insole. The top layer or overlayer can extend to and be secured to distal edge 6416 of base layer 6402. Alternately, as will be disclosed, the top layer or overlayer can extend beyond the distal edge of the ⅔rds length base layer for example, to and be secured to a toe support portion (not shown) of a base layer forward extension that renders or converts the ⅔rds length base layer into a full foot length base layer.

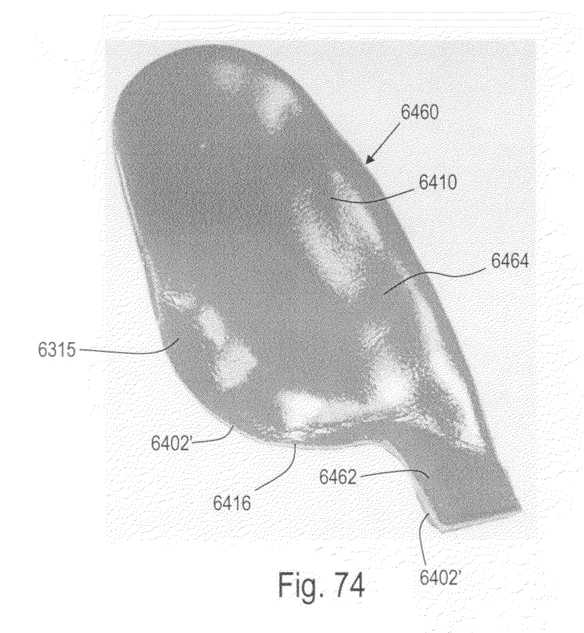

FIG. 74 shows an embodiment of a ⅔rds foot length finished insole or orthotic 6460 having an extension 6462 for supporting a big toe. Orthotic 6460 includes a base layer 6402′ having an extension for the big toe (not shown) and having particles 6330 similarly disposed on substantially the entirety of the base layer, except for toe extension 6462, the lateral arch and the forward or distal edge which do not contain any particles. Although not shown, the medial peripheral side wall 6410 can have holes in communication with the inside of the insole or orthotic 6460 and ambient atmosphere. Top layer 6464 is comprised of a semi flexible or flexible material. It is secured, preferably adhered, to the periphery of base layer 6402′, including to an upper portion of peripheral side wall 6410, to toe extension 6462, and to the peripheral area forward of lateral arch support portion 6315 and forward of distal edge 6416. Particles 6330 and top layer 6464 have born the weight of the plantar surface of a wearer's foot and have taken the contour of that surface.

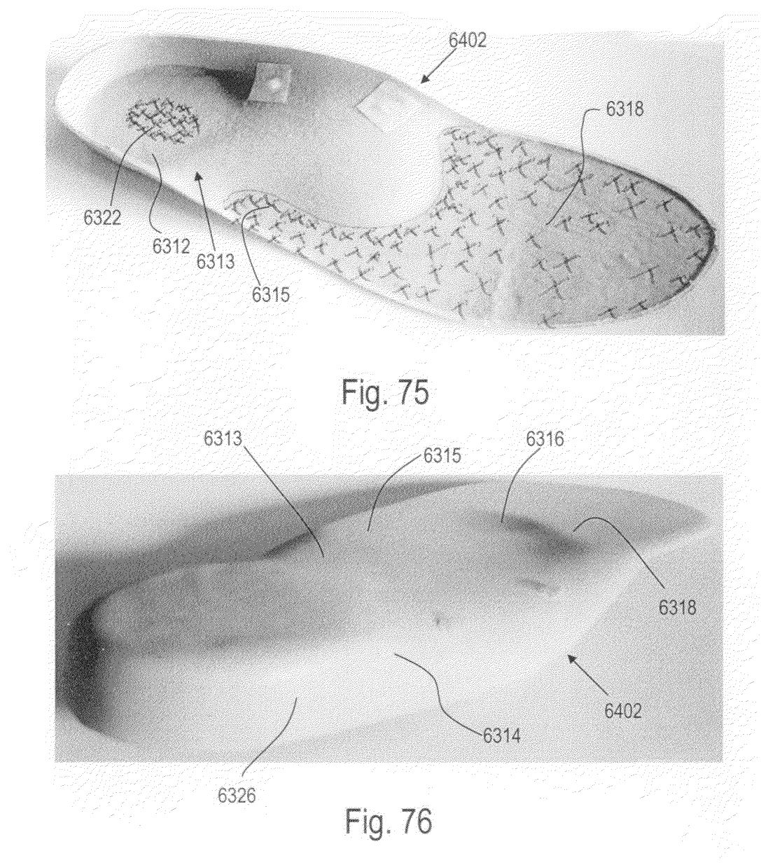

FIG. 75 is a top perspective view of an embodiment of a full length contoured base layer 6402 of the invention. More particularly, FIG. 75 shows by the X's, the general area or pattern of preferred placement of adhesive on the upper surface of the base layer 6402 for securing to itself, a full foot length top layer, e.g., 6416 (not shown), or a full foot length upper layer that may be below the top layer and next adjacent to the base layer. As shown, heel support portion 6312 has a flat upper surface and a central area 6322 that has an adhesive XX thereon for securing thereto the lower surface of the corresponding central area of the top layer. Adhesive is also disposed on the portion of the base layer marked with XX's that extends forward of the lateral arch support portion 6315 and of the molded-in contour of metatarsal arch support portion 6316. As shown, the pattern of XX's extends to the peripheral edge of the toe or forefoot support portion 6318 of the base layer. Preferably, particles 2330 are not present in or allowed to migrate into the adhesively secured areas. Although not shown, and as will be described herein, upper edge portions of adjacent peripheral wall or walls of respective base layer 6402 and of top layer 6414 (not shown), or of an upper layer, will also have adhesive therealong to secure the peripheral walls together. This overall pattern of adhesive has been found to snuggly hold a top or upper layer onto a base layer. It is understood to be within the scope of the disclosure that securing of one member to another can be effected by any suitable means, for example, by heat, laser light or ultrasonic welding or sealing, adhesive tape (single or double sided) an adherent, stapling, tacking or pinning, stitching or sewing.

FIG. 76 is a rear side perspective view of the bottom surface of an embodiment of an overturned full foot length contoured base layer 6402 for an insole or orthodic (not shown). FIG. 76 shows that base layer 6402 has a substantially flat bottom that communicates with a substantially perpendicular or vertical peripheral wall 6326, and forward of that, a transverse arch support portion 6313, a medial arch support portion 6314, a contoured lateral arch support portion 6315, forward of that, a depressed molded-in, contoured metatarsal arch support portion 6316, and forward of that a substantially flat forefoot support portion 6318. Peripheral wall 6326 tapers downwardly as it extends forward and communicates with forefoot support portion 6318.

FIG. 77 is a rear side perspective view of the bottom surface of an embodiment of an overturned full foot length contoured top layer 6502 for an insole or orthodic (not shown). FIG. 77 shows that top layer 6502 has, at the heel support portion 6512, a radiused or arcuate peripheral wall 6526 that merges through a radiused or arcuate peripheral area 6527 of bottom wall heel support portion 6512 into a relatively small, substantially flat central area 6522 of heel support portion 6512. As will be seen herein, the radius of curvature of the peripheral wall and of the merging portion of the bottom wall appear bowl-shaped when viewed in vertical section. Forward of the bottom wall, FIG. 77 also shows a depressed contoured lateral arch support portion 6515, a depressed contoured metatarsal arch support portion 6516, and forward of that a substantially flat forefoot support portion 6518. Peripheral wall 6526 tapers gradually shorter as it extends forward and communicates with forefoot support portion 6518. If contoured areas are employed, preferably contoured lateral arch support portion 6315, medial arch support portion 6314, and metatarsal arch support portion 6316 of base layer 6402 are employed, and preferably they correspond in size and shape to contoured lateral arch support portion 6515, medial arch support portion 6514, and metatarsal arch support portion 6516 of top layer 6502. Base layers and top layers of embodiments of the invention need not be contoured, or the base layer can be contoured and the top layer not contoured, or the base layer may include one or more contours and the top layer may include one or more of the same or other contours, as desired.

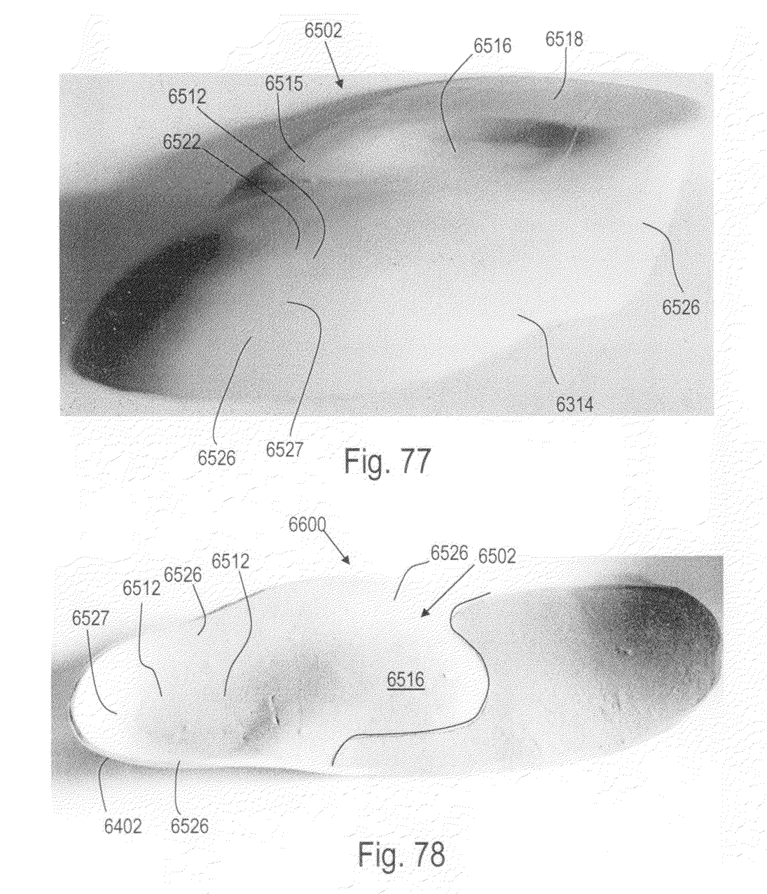

FIG. 78 is a top plan view of an embodiment of a full foot length insole or orthotic, generally designated 6600, formed from the respective contoured base and top layers 6402 and 6502 of FIGS. 76 and 77. FIG. 78 mainly shows the features of contoured top layer 6502, including particularly the radiused or arcuate peripheral wall 6526 that merges through a radiused or arcuate peripheral area 6527 of bottom wall heel support portion 6512 into a relatively small, substantially flat central area 6522 of heel support portion 6512. FIG. 78 also shows domed metatarsal arch support portion 6516 of top layer 6502 that corresponds to underlying domed metatarsal arch support portion 6416 of base layer 6402 (not shown).

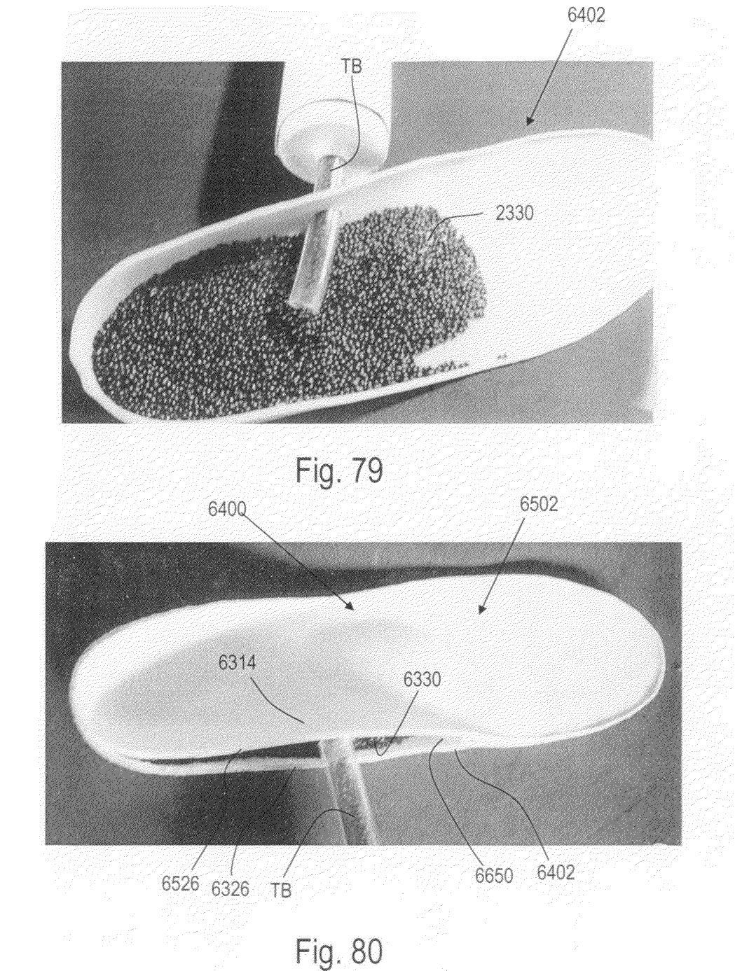

FIG. 79 shows a source, for example, a container C of particles 2330 connected to a tube t passing through an orifice in the medial arch wall and through which particles are being added to or removed from the rear ⅔rds of base layer 6402 for custom fitting a prospective wearer's foot.

FIG. 80 shows the distal open end of tube t in an opening 6650 between a portion of peripheral wall 6326 of base layer 6402 and a portion of peripheral wall 6526 of top wall 6502 of an insole/orthotic 6400, for adding particles to or removing them as required to custom fit the medial arch support portion 6314 to a prospective wearer's foot. Alternatively, particles 6330 may merely be squeezed out or the insole as needed or desired. After the addition or removal, the peripheral wall portions may be resealed together by an adhesive or by two-sided adhesive tape.

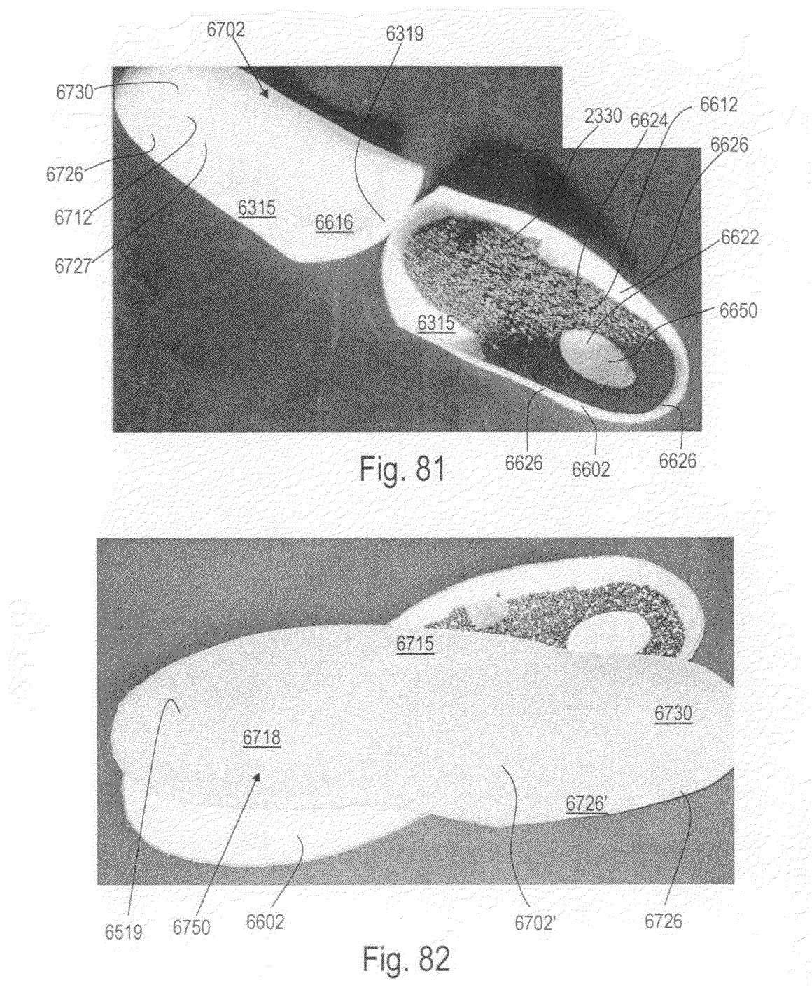

FIG. 81 is a top plan view of the interior or upper surface of base shell layer 6602 for a ⅔rds insole/orthotic 6600 having particles 2330 disposed thereon, and a top plan view of the bottom surface of an inverted overlayer 6702, the base layer 6602 and the overlayer 6702 being axially aligned toe portion to toe portion. More particularly, FIG. 81 shows base layer 6602 having a heel support portion 6612 with a central area 6622 that has a resilient support pad 6650 adhered thereto to provide a resilient shock absorber for the heel. Particles 2330 are disposed on peripheral area 6624 about resilient support pad 6650 and on the contoured lateral arch support portion 6615 and contoured dome portion (not shown) of metatarsal arch support portion 6616. The lower portion of particles 2330 is adhered to the underlying surface of base layer 6602. Particles 2330 are contained about heel arch support portion by substantially perpendicular peripheral wall 6626. It is understood that overlayer 6702 can be or include the top layer (i.e., the uppermost layer) or an upper layer, which can be directly above the base layer.

FIG. 81 also shows that the ⅔^{rd}s foot length overlayer 6702 for an insole/orthotic 6600 has a contoured bottom surface, and adhesive strips 6730, 6732 and 6734 respectively aligned with and sized to correspond and adhere to respective base layer heel resilient support pad 6650, arcuate forward edge 6319 and lateral arch support portion 6315 of base layer 6602. In accordance with a preferred embodiment of this disclosure, FIG. 81 shows that while peripheral wall 6626 of base layer 6402 preferably is substantially perpendicular relative to heel bottom wall 6613 (not shown), peripheral wall 6726 about heel support portion 6712 of overlayer 6702 is bowl-shaped, since it is radiused or arcuate and merges through a radiused or arcuate peripheral area 6727 with bottom wall heel support portion 6712. As will be explained, the shapes of these juxtaposed peripheral wall portions advantageously create a cavity (not shown) therebetween for holding particles 2330.

FIG. 82 shows the bottom surface of a full foot length overlayer 6750 resting on and across a full foot length base layer 6602′. FIG. 82 shows that in this embodiment, the bottom surface of top/upper or over layer 6702′ has an adhesive strip or patch 6730′ on the heel arch support portion, an adhesive strip or patch 6519 on the forefoot support portion 6718 and which extends rearward to cover the lateral arch support portion 6715, and an adhesive strip 6726′ on the bottom surface that runs along a portion of the top edge portion of peripheral wall 6726. This arrangement of adhesive strips can but generally need not prevent air from entering through top/upper or over layer 6702′, and if air does enter, the air will not lift layer 6702′ or separate the base and top/upper or over layers. The weight of the wearer of the insole orthotic maintains pressure on the adhesive bonds.

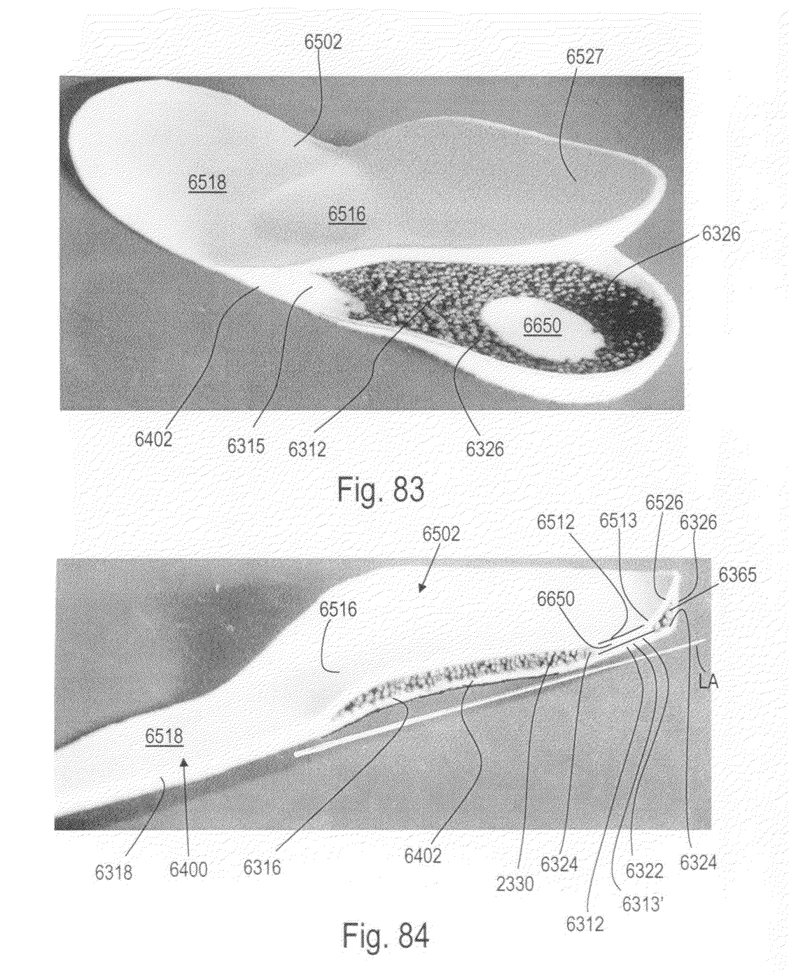

FIG. 83 shows the roughly ⅓^{rd} forefoot support portion 6518 of a full foot length upper or top layer 6502 adhered to the corresponding underlying forefoot portion 6318 (not shown) of a full foot length base layer 6402. This prevents particles from migrating from the metatarsal support portion 6516 into the forefoot portion. FIG. 83 shows metatarsal arch support portion 6516 and the radiused or bowl-shaped heel support portion 6527 of upper/top layer 6502 each lying above particles disposed on respective underlying metatarsal, lateral and heel arch support portions 6316, 6315 (neither shown) and 6312 of base layer 6402. Heel arch support portion 6312 has in its central area a resilient support pad 6650. Particles 2330 are disposed on heel peripheral area 6324 around resilient support pad 6650. It is preferred that the top of the resilient pad be kept clear of particles.

FIG. 84 is a side elevated perspective vertical cross sectional view as would be seen along the longitudinal axis LA of an embodiment of a full foot length finished insole (or midsole) 6400 of the disclosure, e.g., of FIG. 83. Upper/top layer 6502 and base layer 6402 can be secured together in the manner described above in connection with FIGS. 82 and 83. FIG. 84 shows upper/top layer 6502 of the partially completed insole of FIG. 83 after its metatarsal arch support portion 6516, lateral arch support portion 6315 and heel support portion 6512 formed from the upper/top layer 6502 and base layer 6402 components of partially completed insole (herein understood to include “or midsole”) 6400, 6312, (referred to earlier as its first section 6305), have been lowered onto and upper/top layer 6502 has been secured to base layer 6402. Preferably, upper/top layer 6502 is secured to base layer 6402 by their respective forefoot support portions 6518 and 6318 being adhered together, their lateral arch support portions 6315 and 6515 being adhered together (not shown), their heel portions (adhesive strip 6730 and elevated heel resilient support pad 6650) being adhered to each other, and by portions of, or, less preferably, the full length of upper edge portions of respective peripheral wall 6526 of upper/top layer 6502 and of peripheral wall 6326 of base layer 6402 being adhered to each other, to thereby form finished full length insole 6400.

Particles 2330 are shown disposed on base layer 6402 on the metatarsal arch support portion 6316, lateral arch support portion 6315 (not shown) and bottom wall peripheral area 6324 surrounding and peripheral to central area 6322 and to resilient support pad 6650. FIG. 84 shows that at the proximal (heel) end of insole 6400, peripheral wall 6326 of heel support portion 6312 of base layer 6402 is substantially vertical relative to heel bottom wall 6313, and peripheral wall 6526 and preferably also a peripheral area of bottom wall 6513 of upper/top layer 6502 have a radius of curvature and are bowl-shaped. FIG. 84 shows that the top edge portions of peripheral walls 6326 and 6526 are frictionally engaged with each other or secured together and form a cavity 6365 therebetween. A plurality of particles are disposed in cavity 6365. As will be explained, cavity 6365 with particles therein allows insole 6400 to be custom fit to and to adjust to and support the contour and shape of the wearer's heel and arches.

Although peripheral wall 6326 of base layer 6402 or other base layers of the disclosure preferably are substantially vertical to the heel bottom wall 6313′ or other bottom walls, peripheral wall 6326 can have greater angles, for example, angles of from substantially vertical to about 110 degrees or more relative to heel bottom wall 6313′. Alternatively, the junction of heel bottom wall 6313′ and peripheral wall 6326 about the periphery of the heel of base layer 6402 can be a curve formed by a radius of from 0 to about 25 mm, more preferably from 0 to about 12 mm, and most preferably from 0 to about 6 mm.

The height of peripheral wall 6326 of base layer 6402 can be any suitable height. Preferably, the height of peripheral wall 6326 of base layer 6402 around the periphery of the heel for many applications generally is from about ⅝ inch to about 1¼ inch, and in the area of the medial arch, the wall height generally will be about 1¼ inch, measured from heel bottom wall 6313. Sidewall elevations can be about 30 mm, e.g., in the heel area, to about 33 mm, e.g., in the medial arch area, to allow particles to move upward when excessively wide heels are pressing downward on particles. Preferably, the upper portions of the respective peripheral walls of the upper layer and of the base layer are sewn together to prevent the upper portions from opening up and particles from escaping between the upper edges of these layers.

FIG. 84 shows a solid line drawn alongside of and parallel to the longitudinal section to show that there is an elevation suspension space of, for example, approximately about 7 to about 8 mm between the substrate on which the insole rests and the bottom surface of the mid-section of base layer 6402, e.g., along and under the metatarsal and arch support portions and the forward peripheral areas or portions of the heel support portion of insole 6400, which space allows those portions of the base layer to flex downwardly to accommodate the weight of, or a low arch of the insole wearer's foot. Also, if there is discomfort because of too many particles 2330 being disposed on base layer 6402, the built-in suspension space below the base layer will allow the base layer to yield downward to alleviate the discomfort.

During assembly of the insole and base layer components, adhesion of upper/top layer 6502 to resilient support pad 6650 that is in turn adhered to the central area of heel arch support portion 6312 of base layer 6402, preferably is effected to prevent one or more particles 2330 from being disposed between the top surface of elevated resilient support pad 6650 and the bottom of adhesive strip 6730 and/or between the top surface of adhesive strip 6730 and the bottom surface of upper/top layer 6502.

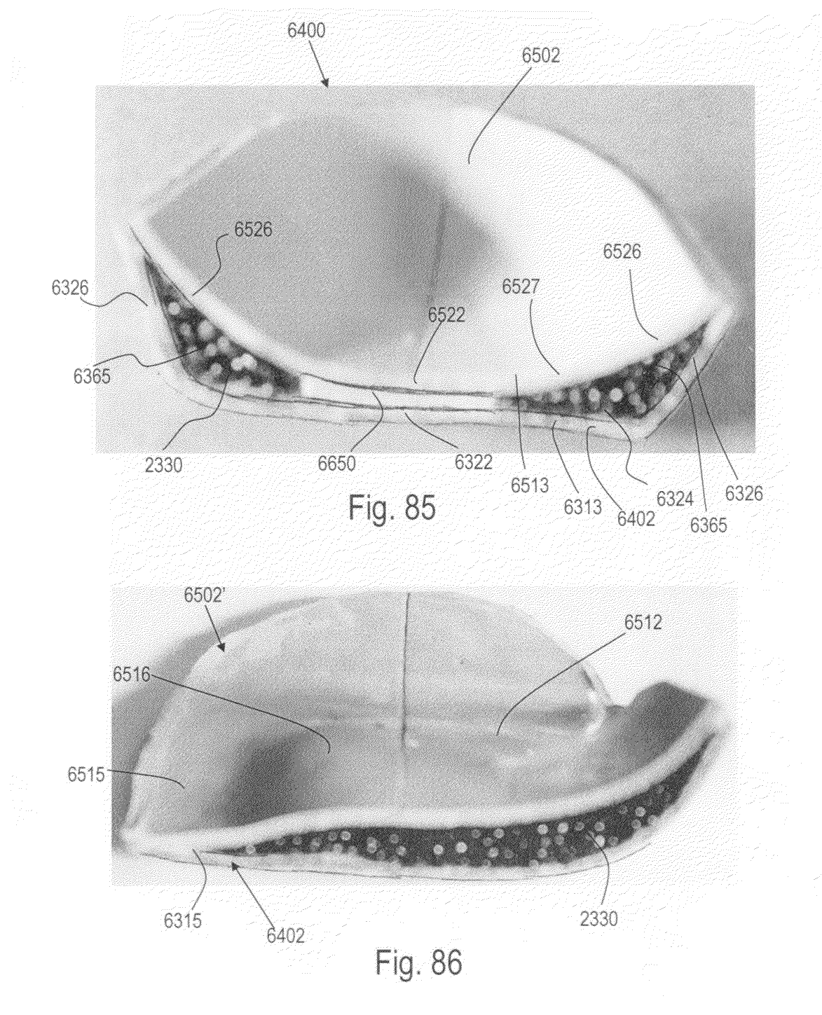

FIG. 85 is a front perspective view of a vertical section taken across the heel support portion of insole 6400 of FIGS. 83 and 84. More particularly, FIG. 85 shows base layer bottom wall 6313 whose central area 6322 has an elevated resilient support pad 6650 adhered thereto and whose peripheral area or contains particles 2330 contained in cavity 6365 formed by base layer peripheral area 6324 and peripheral wall 6326, and by the radius of curvature of the peripheral area or 6527 of heel bottom wall 6513 and the radius of curvature of the peripheral wall 6526 of upper/top layer 6502. The central area 6522 of upper/top wall is secured, preferably adhered, to the top surface of resilient support pad 6650, which pad provides shock absorption, prevents particles from getting under the wearer's heel and with appropriate thickness selection can compensate for leg length variance. Cavity 6365 containing particles 2330 extends about the periphery of the heel support portion of insole 6400.

Particles 2330 can be deposited in the peripheral areas or portions of base layer 6400 by any suitable means, for example, by manual or mechanical vibration, dispersement or distribution, in which cases, preferably larger particles are disposed first on an adhesive on base layer 6402, followed by disposition of smaller particles which preferably have been coated or doped with a lubricant, preferably a tacky, viscous lubricant, sealant or material, for example a high viscosity polytetrafluoroethylene type composition having non-hardening, binding adhesive properties, to tackify the particles and allow some limited movement, adjustment or slippage, but not excessive movement or migration of the non-adhered particles in the cavity. The use of particles or beads desirably provide heel shock dissipation, that is, they dissipate heel shock forces in directions other than upward into the wearer's heel. It has been found that the presence of particles 2330 in peripheral cavity 6365 is advantageous in that the particles in cavity 6365 adjust and the peripheral walls of the heel support portion also adjust to accommodate and support wearer's heels of different widths and arches of different heights. More particularly, when a wearer having a narrow heel (and high arch) applies weight to an insole such as 6400 that has a peripheral cavity 6365, lubricated or doped particles will displace or shift radially outward and upward. They will rise in the cavity, allow the heel to sink deeper into the underlying particles and cause the rear, lateral and medial sides of peripheral wall 6526 of upper/top layer 6502 to move radially inward and its upper portions more tightly engage and support the wearer's heel (and high arch). When a wearer having a wide heel and a low arch applies weight to such an insole, lubricated or doped particles will move radially outward and cause the lateral and medial sides of peripheral wall 6526 of upper/top layer 6502 to move radially outward to accommodate and support the wearer's wider ankle and lower arch. Instead of or in addition to lubricating and/or doping particles 2330 in cavity 6365, the interior surfaces of the cavity wall may be coated with a tacky, viscous, preferably highly viscous, lubricant, sealant or material having non-hardening binding adhesive properties.

FIG. 86 is a front perspective view of a vertical section taken across the arch support portion of an embodiment of an insole of this disclosure. More particularly, FIG. 86 shows a relatively flattened heel portion 6512 of an upper/top layer 6502′ whose lateral arch support portion 6515 is adhered to the underlying lateral arch support portion of base layer 6402. Particles 2330 are shown disposed and maintained between upper/top layer 6502′ and base layer 6402 each of which has a corresponding built-in metatarsal arch support portion 6516 (shown) and 5316 (not shown) having a domed contour. The use of the preferred tacky, highly viscous lubricant, sealant or material, preferably having non-hardening, particle or footwear binding adhesive properties desirably permits some desired, forced initial migration of particles, but will maintain, secure or adhere the coated or doped particles in the desired position(s) in the article(s) of footwear of the disclosure.

In FIGS. 85, 86 and 87, preferably, though not shown, the upper edges of peripheral walls 6526 of top layer 6502 and 6326 of base layer 6402 are skived to smoothen the adjoined surfaces for the wearer's comfort.

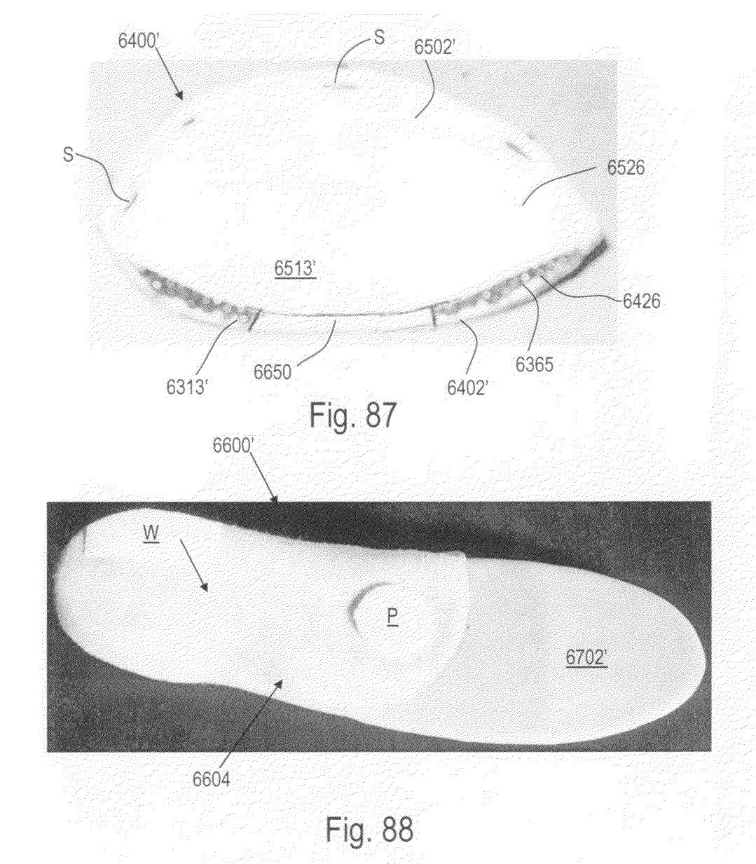

FIG. 87 a front perspective view of a vertical section taken across the heel support portion of an embodiment of an insole 6400′ in accordance with this disclosure. FIG. 87 shows the heel support portion in which the bottom walls 6513′ and 6313′ and peripheral walls 6526 and 6426 of both the upper/top layer 6502′ and base layer 6402′ have a radius of curvature and are moderately bowl-shaped. The heel support portion has a centrally located resilient support pad 6650 to which upper/top layer 6502′ and base layer 6402′ are secured. Particles 2330 are disposed on the base layer in the peripheral area surrounding resilient support pad 6650. FIG. 87 shows that the top edge portions of peripheral walls 6526 and 6426 can be stitched together by stitches S. The space between stitches can be used to allow air to escape therethrough and/or to allow particles 2330 to migrate from a lower position in cavity 6365 to a higher position in the cavity in response to the weight of a wearer's foot placed on the heel of the insole 6400′.

FIG. 88 is a plan view of the bottom surface of an embodiment of a full length insole 6600′ comprised of a ⅔rds length insole/orthotic portion 6604 having particles maintained therein by a full length top layer or overlayer 6702′ that extends from the proximal heel portion of the interior of the base layer (not shown) to the forward edge of the toe portion of full length insole 6600′. FIG. 88 shows that the ⅔rds insole/orthotic 6600′ has a medial heel patch or wedge W applied to the exterior bottom surface of the heel portion of the insole, and a metatarsal support pad P applied to the concavely domed or arched exterior bottom surface portion of the ⅔rds length portion of the insole. Wedge W and pad P support the insole and preferably they are removable from the insole.

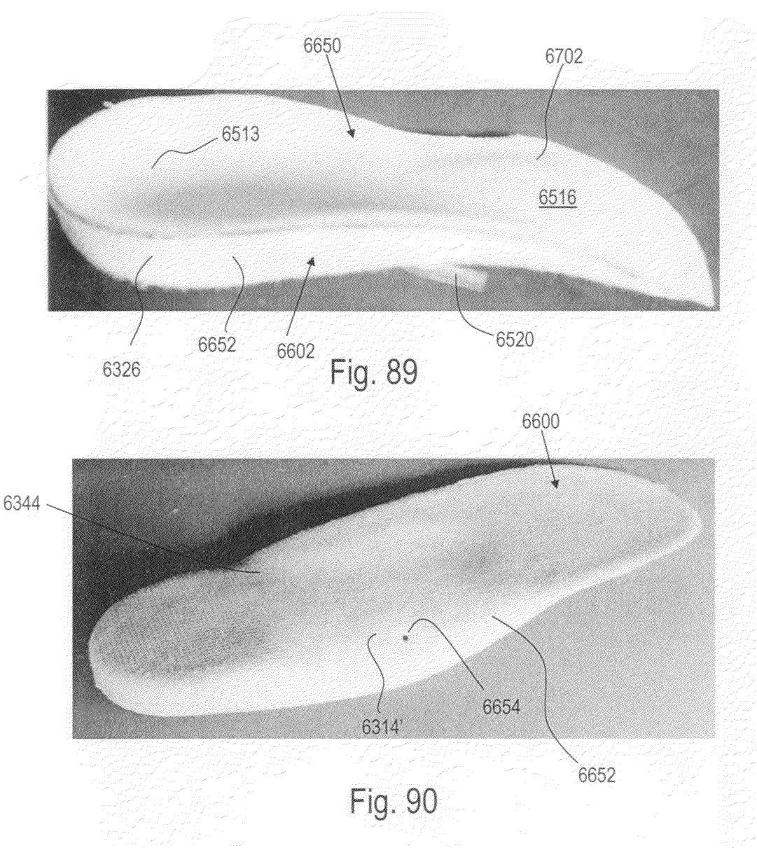

FIG. 89 is a side perspective view of the bottom surface of an embodiment of a ⅔rds length orthotic 6650 with particles sealed inside and with anatomical contours built-in. Semi-rigid base support layer 6602 has a built-in raised domed metatarsal arch support portion 6316 (not shown) and is secured to an overlying ⅔rds top or overlayer 6702 having a corresponding superimposed built-in raised domed metatarsal arch support portion 6516. Top or overlayer 6702 has a radiused arcuate bottom wall 6513 and a radiused peripheral wall 6526 which form a bowl shaped heel support portion 6512. Peripheral wall 6326 of the heel support portion of base layer 6602 is substantially vertical, and, with radiused peripheral wall 6526, forms a cavity 6365 for holding particles (neither shown). Although FIG. 89 shows that a ⅔rds length and/or full length insole can have an air line 6520, plugged or not plugged, and/or a one-way valve in communication with ambient atmosphere and the interior of insole 6650 between base layer 6402 and overlayer 6702, preferably none of these members are employed. FIG. 89 shows that the bottom surface and/or the upper surface of the full length, ⅔rds length and/or ⅓ length embodiments of the insoles and midsoles of the disclosure preferably are, but need not be, covered or coated with a layer 6652 of a man-made fiber, e.g. nylon, reinforced cloth or cotton fibrous material. This material can be coated with a fiberglass resin to strengthen the material, insole and/or midsole.

FIG. 90 shows an embodiment of a full length insole/midsole 6600 of the disclosure whose bottom surface is covered with a layer 6652 of a cloth or cotton fibrous mesh material as employed and shown in FIG. 89. FIG. 90 shows the bottom surface of the built-in or molded-in contoured, here, concavely shaped (as here viewed from above the bottom surface) metatarsal arch support portion 6316, cuboid support portion 6344 and medial arch support portion 6314′. The rear and forward portions of covered base layer 6402 are substantially flat, while the central portion has built-in concavely contoured portions 6344 and 6316.

FIG. 90 also shows that insole/midsole 6600 can have an air hole 6654 through its medial arch support portion 6314′, or through another portion, which hole communicates with the particle-containing interstitial portion of the insole/midsole between its top layer or over layer (not shown) and base layer 6402 (not shown).

Air hole 6654 allows air in and out of the interstitial portion. Preferably, air hole 6654 is small, e.g., about 1/32 to about 1/16^{th} or ⅛^{th} inch in diameter, and preferably slows entrance of air into the interstitial portion, yet allows air to escape at a faster rate when the weight of a wearer's foot is applied to the top layer 6502 or to over layer 6702 (neither shown).

Although not shown, the inside surface of base layer 6402 has particles thereon over desired portions thereof, for example, over its entire length or only about the certain locations, features or contours of the base layer, e.g., the periphery of bottom wall heel support portion, and/or its cuboid, transverse and/or metatarsal arch support portions. Particle containing base layer 6402 can be covered, preferably at least on its outer surface with a preferably thin layer of, for example, cloth or cotton. The cotton layer can be reinforced with a strengthening material or layer of, e.g., nylon fibers or fiberglass resin. The upper or inside surface of medial arch support portion 6314′ of base layer 6402 that includes air hole 6654 can be covered with a screen or fine mesh or other type of water resistant membrane to prevent particles (not shown) from passing therethrough, while allowing air to pass therethrough.

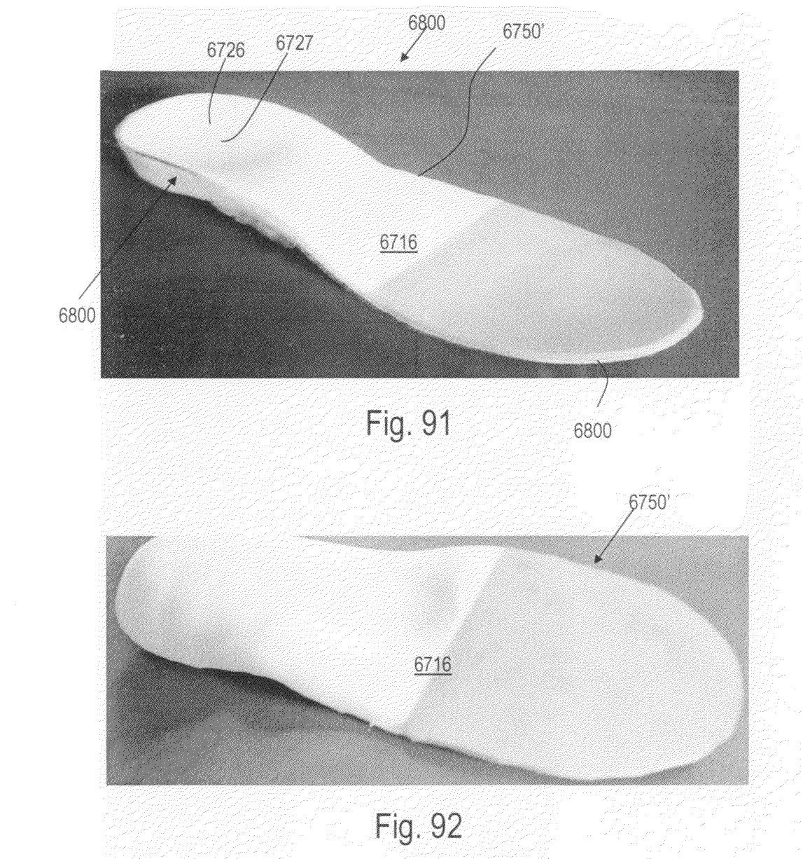

FIG. 91 is an upper front side perspective view of an embodiment of a full length insole 6800 of the disclosure having a dual hardness top layer or overlayer 6750′ secured to base support layer 6800 with particles therebetween. The proximal or rear approximate ⅔rds portion of top layer 6750′ has a first hardness, having a durometer of from about 40 to about 50 on the A-scale, while the distal or forward approximate ⅓^{rd} portion of the top layer is secured to the forward ⅓_{rd} portion of the base layer and has a second hardness, having a durometer of from about 30 to about 40 on the A-scale. Top layer 6750′ can be made from any suitable material(s) and by any suitable method, for example, co-injection molding. FIG. 91 shows that top layer 6750′ has built-in contours, including a radiused bottom wall heel support portion 6727, radiused peripheral wall portion 6726, and upwardly contoured convex metatarsal arch support portion 6716.

FIG. 92 is an upper side perspective view of the bottom surface of the full length dual hardness top layer 6750′ of the insole shown in FIG. 91. FIG. 92 shows downwardly contoured concave metatarsal arch support portion 6716 that corresponds to upwardly contoured convex metatarsal arch support portion 6716 of base layer 6800. FIG. 92 also shows a radiused heel.

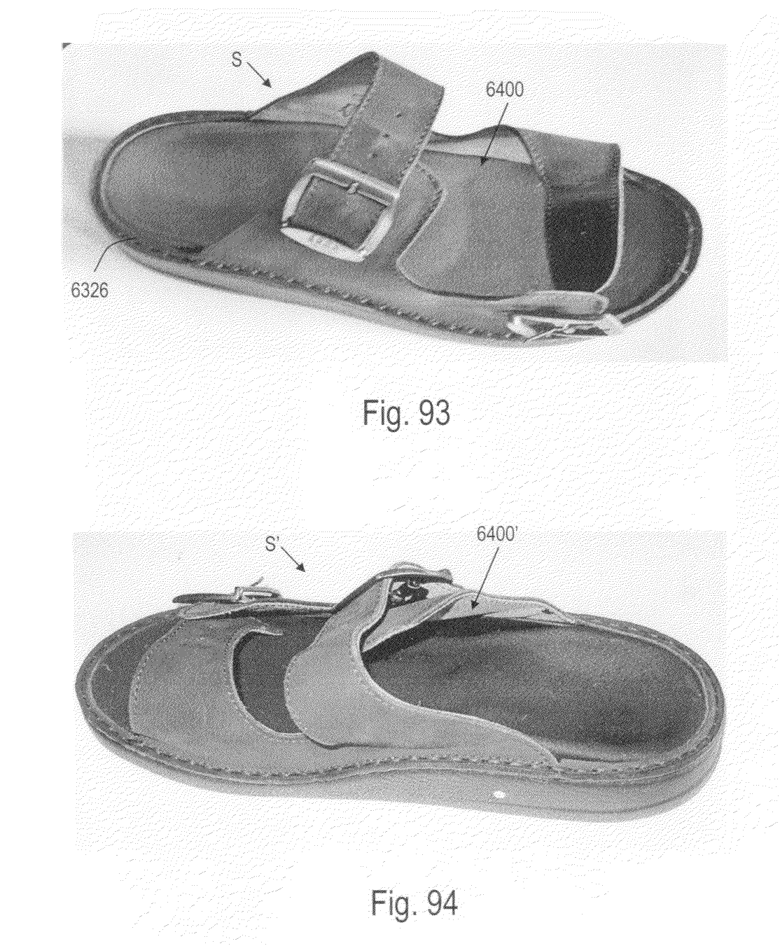

FIG. 93 is a top perspective view of an embodiment of a particle containing finished insole/orthotic 6400 in an article of footwear in accordance with the disclosure and here shown as a sandal S. The forward section of the insole/orthotic is flat and the rear section, from the peripheral wall 6326 to the forward edge of the metatarsal arch support portion contains particles. Sandal S need not but can include an airline.

FIG. 94 is a top perspective view of an embodiment of a particle containing finished insole/orthotic or midsole 6400′ as an article of footwear in accordance with the disclosure and here shown as a sandal S′. Sandal S′ has but need not have an air line with a plug therein and on the medial outer side of the custom made insole/orthotic or midsole 6400′.

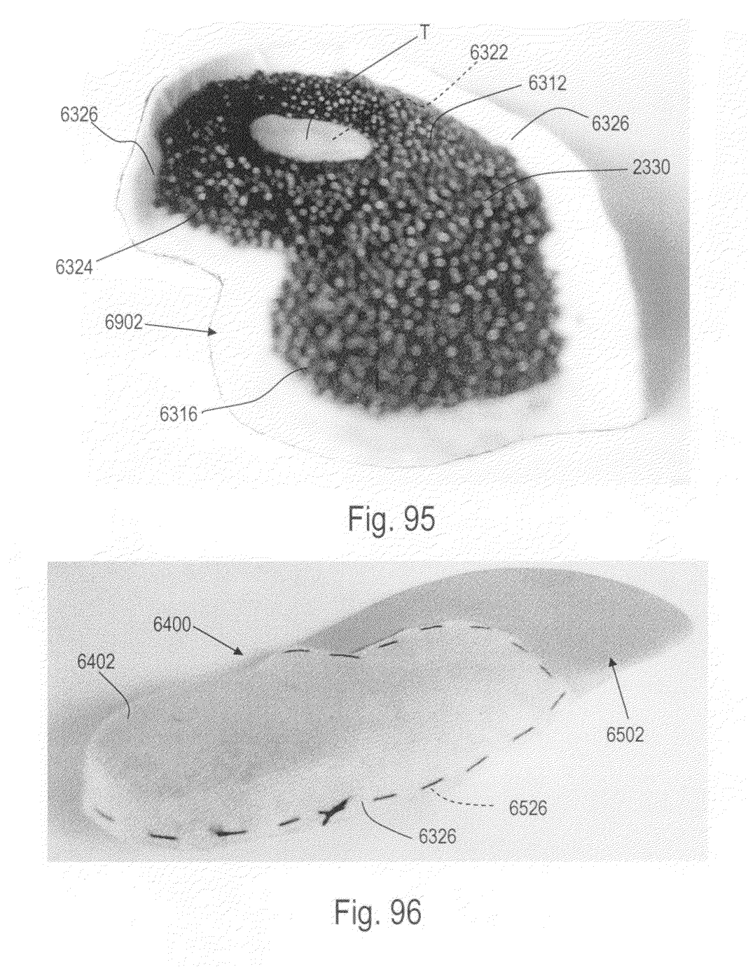

FIG. 95 is a front perspective view of an embodiment of a ⅔rds length base shell support layer, also referred to herein as a base layer 6902, partially filled or layered with particles 2330 in accordance with this disclosure. FIG. 95 shows base layer 6902 with part of its lateral side cut away from the area of support for the fifth metatarsal shaft of a wearer's foot. Central area 6322 of heel support portion 6312 includes an adhesive member, preferably a two-sided adhesive tape T, adhered to central area 6322 of the inside surface of heel bottom wall 6313′ (not shown) and having an upwardly facing adhesive surface preferably covered by a removable peel-away layer of paper or the like. With the upper surface of adhesive member exposed, or with the peelable layer removed from tape T in bottom wall central area 6522, the central area of the bottom surface of top layer, e.g., 6502, can be secured to the adhesive member and to heel support portion 6312 of base layer 6902. Particles 2330 cover bottom wall peripheral area 6324 and extend to the forward edge of metatarsal arch support portion 6316. FIG. 95 shows that the upper inside edges of peripheral wall 6326 can be covered or partially covered with adhesive or with a two-sided adhesive tape to secure the corresponding upper edges or edge portions of a top layer 6502 which can be ⅔rds length or full length.

FIG. 96 is an upper side rear perspective view of the bottom surface of an embodiment of a full length insole/orthotic comprised of a ⅔rds length insole/orthotic 6400 preferably stitched to a full length top layer 6502 in accordance with this disclosure. Thus, as shown, rather than using an adhesive or adhesive tape T as in FIG. 95, the top or upper edges or edge portions of peripheral walls 6326 and 6526 and the frontal metatarsal edge of the base layer 6402 and of the corresponding area or edge of full length top layer 6502 respectively can be and preferably are stitched, or sewn, although they can also or alternatively be glued or otherwise secured together.

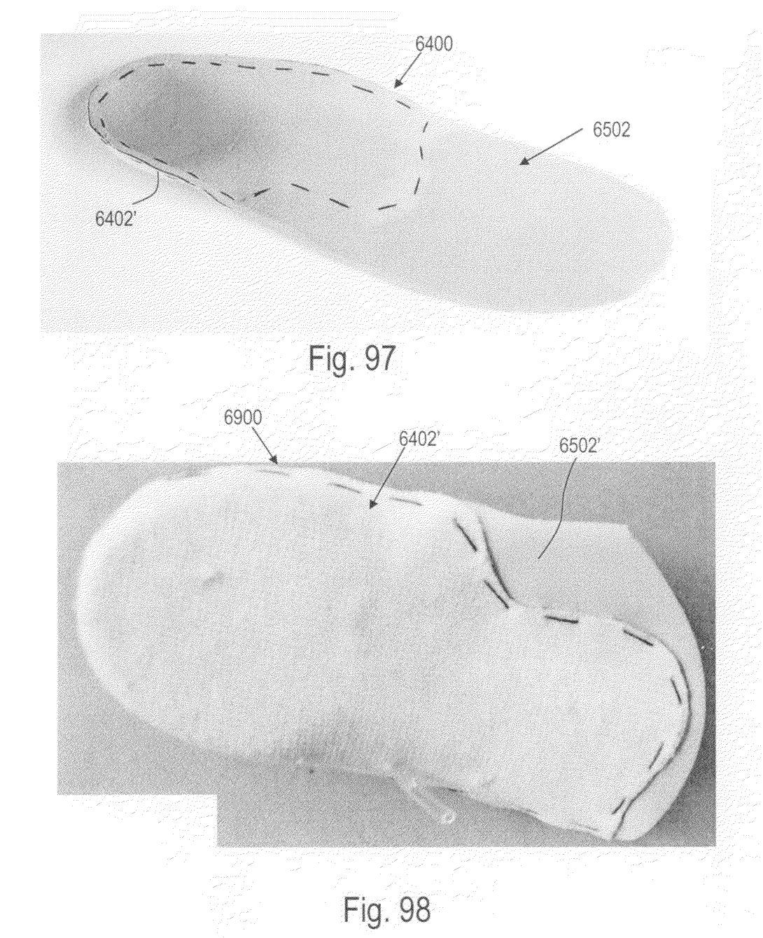

FIG. 97 is an upper side perspective view of the upper surface of the finished particle containing full length insole/orthotic shown in FIG. 96. Although not shown and not needed or preferred, in FIG. 96 or 97, and as shown in FIG. 98, a single two-way check valve, and/or a single air line as shown in previous Figures can be attached to the ⅔rds length insole support base frame or layer, e.g., 6402′ to communicate with the particle containing interstitial area between top layer, e.g., 6502′ and base layer e.g., 6402′.

FIG. 98 is a plan view of the bottom surface of an embodiment of a particle-containing contoured ⅔rds insole/orthotic 6900 whose base shell support or base layer 6402′ has particles retained therein and whose lateral side portion that would support a wearer's fifth metatarsal has been removed. Although an air line is shown, such need not be employed.

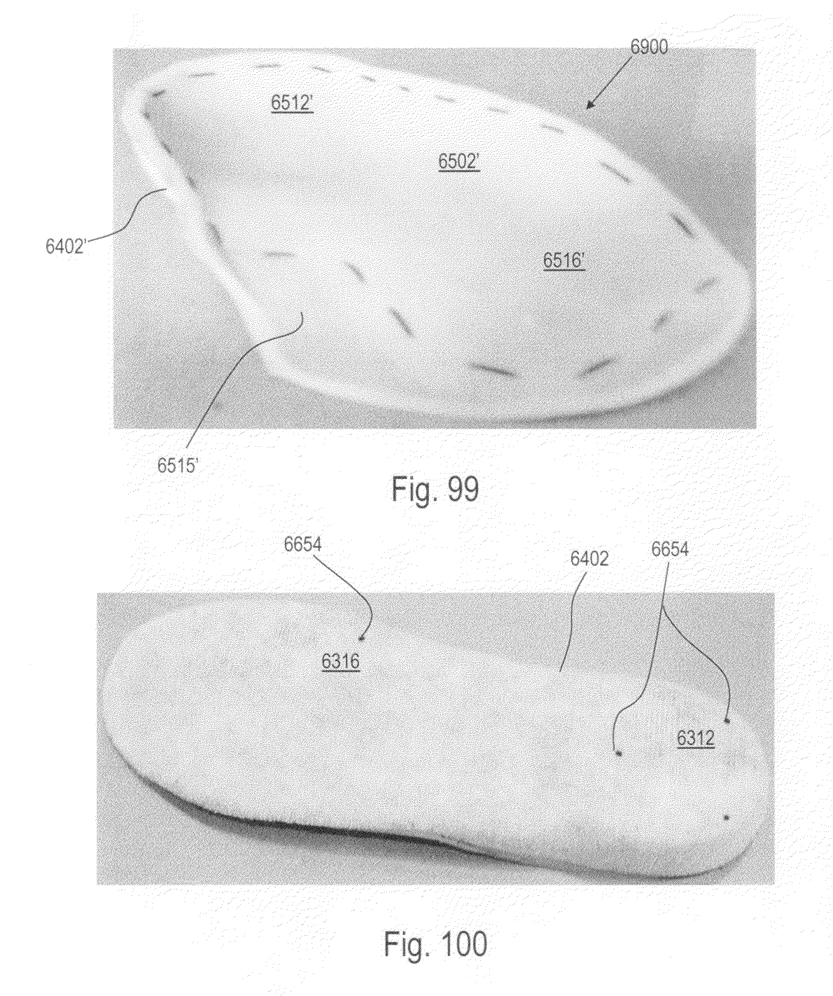

FIG. 99 is an elevated front perspective view of an embodiment of a particle-containing contoured ⅔rds length insole/orthotic similar to that shown as 6900 in FIG. 98 wherein a ⅔rds length contoured top layer 6502′ is stitched or otherwise secured, e.g., adhered, to a correspondingly contoured, particle containing ⅔rds length base shell support layer 6402′. The contours include a radiused heel support portion 6512′, a metatarsal arch support portion 6516′ and a lateral arch support portion 6515′.

FIG. 100 is a top perspective view of the bottom surface of an embodiment of a full length base support shell layer 6402, the bottom surface having at least one, preferably a plurality of water drain holes 6654, there being three in the heel which can drain peripheral cavity 6265 (not shown) or heel support portion 6312 and one adjacent the metatarsal arch support portion 6316 (not shown). These drain holes are useful for draining water that has entered the interior of the base support shell, for example, during washing or submerging.

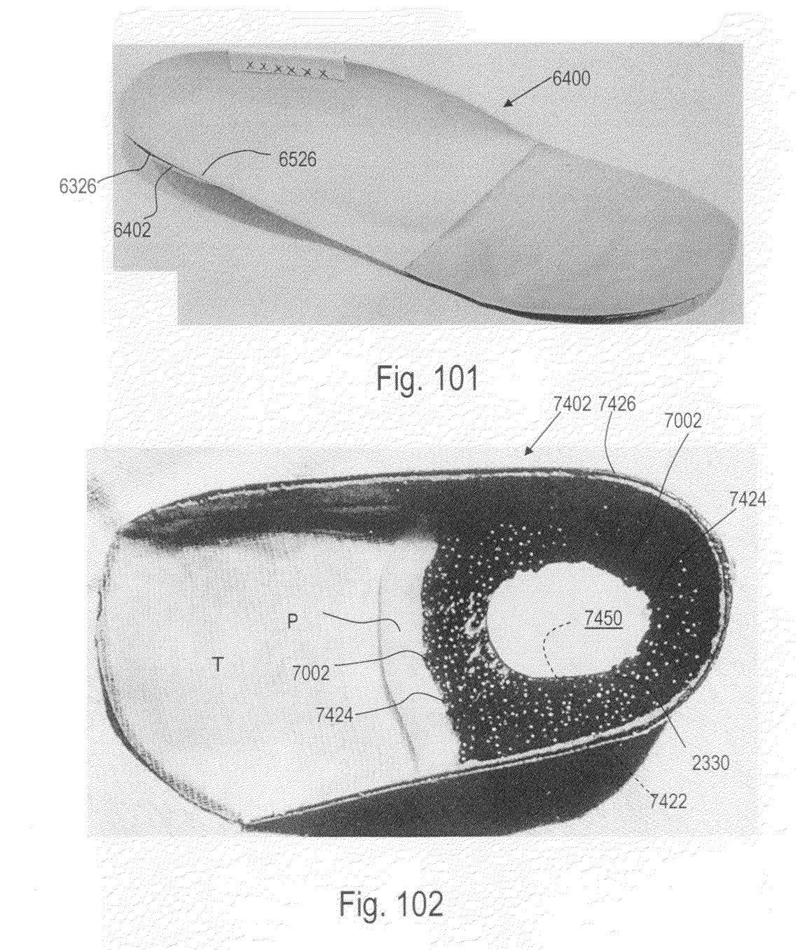

FIG. 101 is an elevated side perspective view of the inside surface of an embodiment of a particle containing full length base support shell layer 6402 in accordance with this disclosure. FIG. 101 shows a permanent or removable tab, marked with XXXX's which can represent or be used to identify a manufacturer's or seller's logo, and/or which can be removed to allow addition or removal of particles to or from cavity 6365 or the peripheral area of heel support portion 6312 (neither shown). Feeding or removing particles can be effected between the upper edge portions of the peripheral walls 6326 and 6526 of the insole or midsole 6400.

Peripheral wall 6526 of top layer 6502 of a full or partial length insole preferably extends higher than does peripheral wall 6326 of the heel area of the base layer of the insole to prevent chafing to the wearer's foot or ankle caused by rubbing against the upper edge of base layer peripheral wall 6326. Having the upper portion of peripheral wall 6526 of top layer 6502 higher also helps keep particles from migrating, leaking or being forced out between the upper portions of the walls and getting under the wearer's foot.

FIG. 102 is a top perspective view of an embodiment of a base support shell layer 6402 or 7402 for forming a customizable particle-containing ⅔rds of a wearer's foot length heel cup, generally designated 7000 (not shown), for permanent or removable placement in or on an article of footwear (not shown) to support the planter surface of a wearer's foot. Heel cup base layer support housing or frame 7402 supports at least the heel of a wearer's foot. Base layer 7402 and heel cup 7000 can extend from the proximal end of the heel distally forward about ⅔rds of the full length of a wearer's foot. FIG. 102 shows particles 2330 disposed in an annular pattern 7002 (when seen in top plan view) about peripheral area 7424 of heel support portion 7412 (not shown). Particles 2330 preferably surround and do not cover or overlie central area 7422 or a resilient support pad 7450 disposed on the central area of the heel support portion. Although a resilient support pad need not be employed, especially when the top or upper layer is comprised of a firm material, preferably a resilient support pad is employed. Resilient support pad 7450 can cover the entire upper surface of the bottom wall of the heel support portion of base layer 6402 or 7402. Resilient support pad preferably covers only the central area of the heel support portion. Support pad 7450 preferably is, but need not be adhered to base layer 7402 and it preferably has, but need not have an upwardly facing adhesive layer thereon for adhering or securing an upper layer or top layer 7502 to base layer 6402 or 7402.

While it is preferred that the upper surface of the central area of the heel support portion, or of a cushion layer, resilient support pad 7450 or firm spacer layer be substantially devoid of particles, there can be embodiments of the disclosure in which there are some particles on one or more of those surfaces. In such embodiments, it may be desirable to prevent the particles from being uncomfortably felt by the wearer of the insole/midsole or orthotic. For example, the size of the particles can be kept fine or small, e.g., from below or about 0.25 mm to about 0.5 mm or 1 mm, relative to or dependent upon the thickness and/or firmness of the one or more overlying or top layers, so that the particles are not felt by the wearer's foot through such layer(s). Also, or alternatively, the particles can be evenly dispersed or spread over the surface, or they can be employed in a mixture, e.g., with other, larger, particles, e.g., 1 mm or 2 mm, or with or in a matrix, binder, paste or lubricant with adhesive properties, as discussed elsewhere herein, and secured to their directly underlying surface.

FIG. 102 also shows that embodiments of the heel cup of the disclosure can have a longitudinal axis LA extending forward from the proximal end of the heel portion, and can have an elongated wall, path or boundary B, here shown for example as a layer of a foam material, preferably about ¼ inch wide, that, as shown, can be secured to an underlying adhesive layer and, for example, can extend widthwise forward from under or over the particles and/or from under or over boundary layer B and intersect the longitudinal axis LA to hold or maintain particles 2330 in heel support portion 7412 of a heel cup.

Base layer 7402 for a heel cup of FIG. 102 has a peripheral wall 7426 that extends about the heel support portion of the heel cup and typically has a height of from about ⅝ths to 1 inch to about 1¼ to about 1½ inch and is substantially perpendicular to the bottom wall of a ⅔rds foot length base support layer 7402. One or more portions or all of the inside surface of the upper edge of the peripheral wall may, but need not have an adhesive surface (not shown) for securing the same to one or more portions or all of the outer upper edge of the top or an upper layer. The aforementioned adhesive portion(s) need not be employed, as the respective peripheral walls of the base layer and a top or upper layer may be secured by a friction fit obtained by the weight of the wearer's heel. Alternative methods of securing the upper portions of the respective peripheral walls to each other include, but are not limited to stitching, sewing, stapling, riveting, bonding, adhering, gluing, welding, pining, buttoning, tab in slit, tongue or edge in groove, etc. For example, the upper edge of the peripheral wall of a base layer can be located and held within a formed groove or folded over portion at or along the upper edge of the peripheral wall of a top layer. The upper surface of base layer 7402 (hidden) is fully or, as shown, partly covered by a layer of double-sided adhesive tape T. The preferred use of an adhesive on the top surface of support pad 7450 and on base layer 7402 secures an upper or top layer to the base layer 7402 for a heel cup 7000. According to an embodiment of an insole/midsole of the disclosure, the upper edge of peripheral wall, e.g., 6326, of base layer, e.g., 6402, and/or of the adjoining top layer can be skived to smoothen the junction of the upper edges of the respective peripheral walls 6326 of top layer 6526 and of base layer 7402. To trap excess beads and prevent them from moving fully upward and beyond the top edge of peripheral wall 6326, e.g., midway or higher up the outside surface of peripheral wall 6326 of base layer 7402 may be provided with one or more radially inwardly extending grooves molded or formed therein and running along the length or portions of the length of peripheral wall.

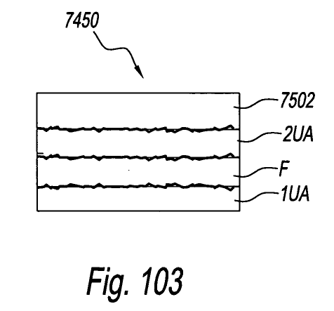

As shown in FIG. 103, an embodiment of a heel support pad 7450 of the disclosure can, for example, be comprised of a first upper adhesive layer 1UA, an optional layer of firm material F above and adhered to the first upper adhesive layer, a second upper adhesive layer 2UA having its lower surface adhered to the layer of firm material, and its upper surface adhered to the bottom surface of the flexible upper layer or to top layer 7502 of the insole. The layer of firm material F is not needed if the top layer or an upper layer 7502 is comprised of a firm material which is sufficient to prevent a stray particle or particles disposed on the central area 7422 or on the upper layer of a support pad from being felt by the wearer's heel.

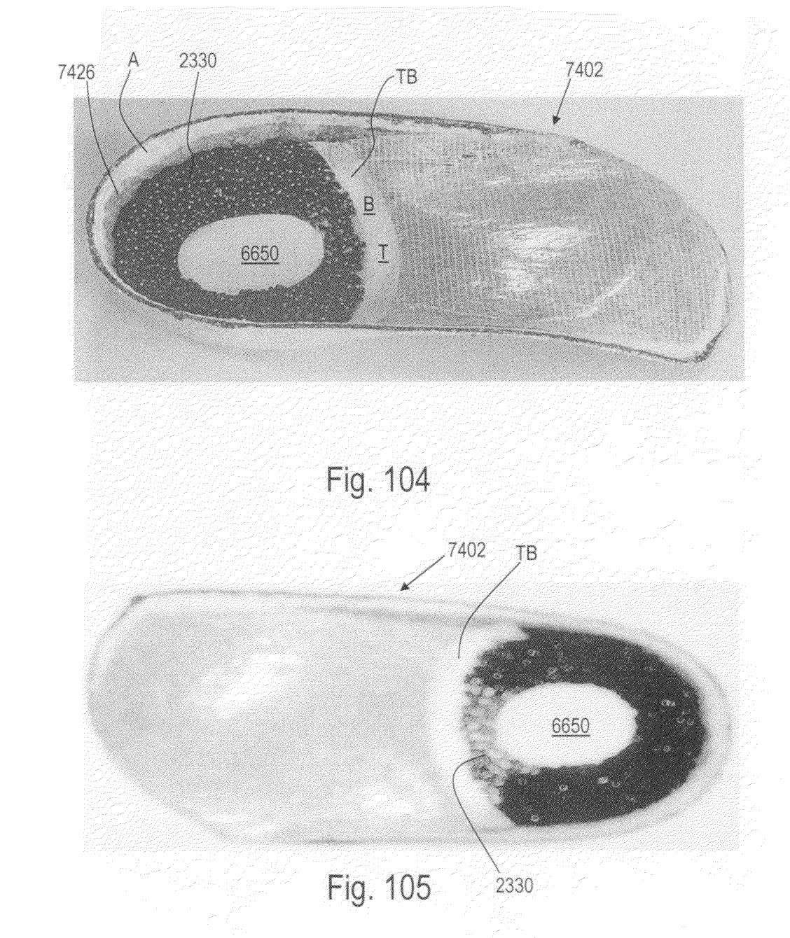

FIG. 104 shows a base layer 6402 or 7402 like that of FIG. 102 or 104, for forming a heel cup 7000, except that in FIG. 104, boundary B just forward of the forward edge of particles 2330 is a one or two adhesive sided tape band TB to maintain particles 2330 in the heel support portion, and an adhesive surface A is employed along the inside upper edge of peripheral wall 7426 of base layer 6402 or 7402 to secure the peripheral wall of a top or upper layer (not shown) thereto.

FIG. 105 shows a base layer 6402 or 7402 for forming a heel cup like that shown in FIG. 104 that has layered beads in the heel support portion, and the forward edge portion, about ⅓^{rd} inch, being covered with a tape band TB whose underside is plain sided to allow particles to migrate slightly or sufficiently to customize the heel fit and support. In FIG. 105, the forward portion of the annular array of particles is very sparse or thin to ease the transition from the heel support portion to the metatarsal support portion.

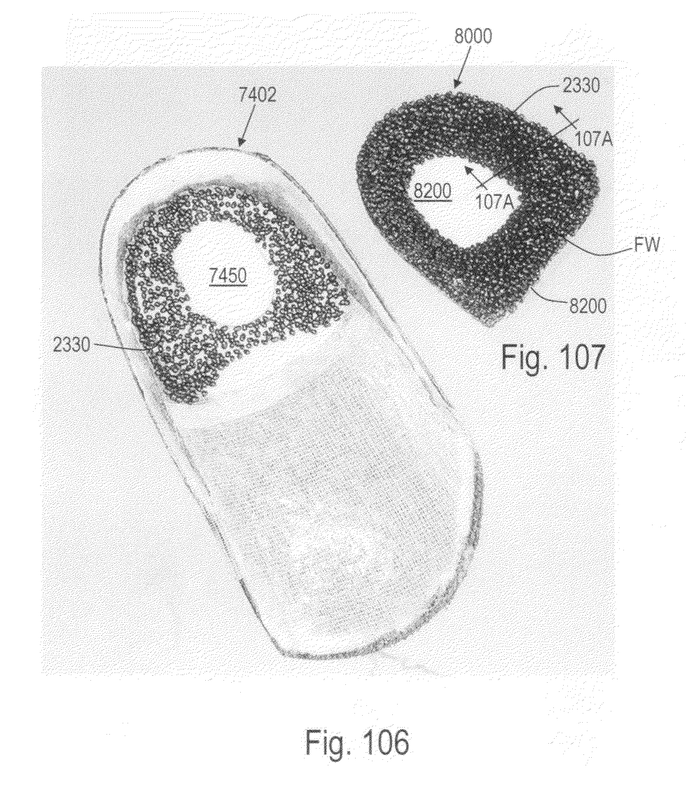

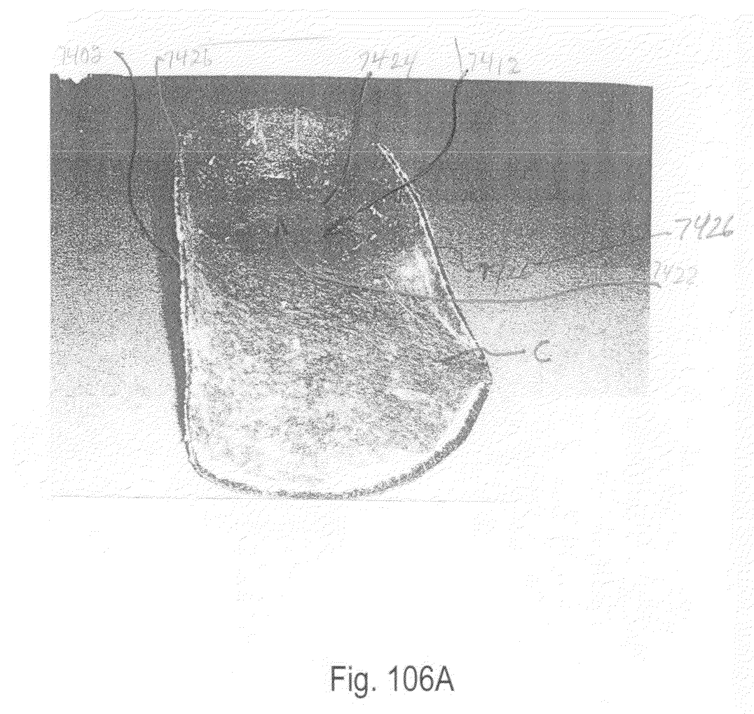

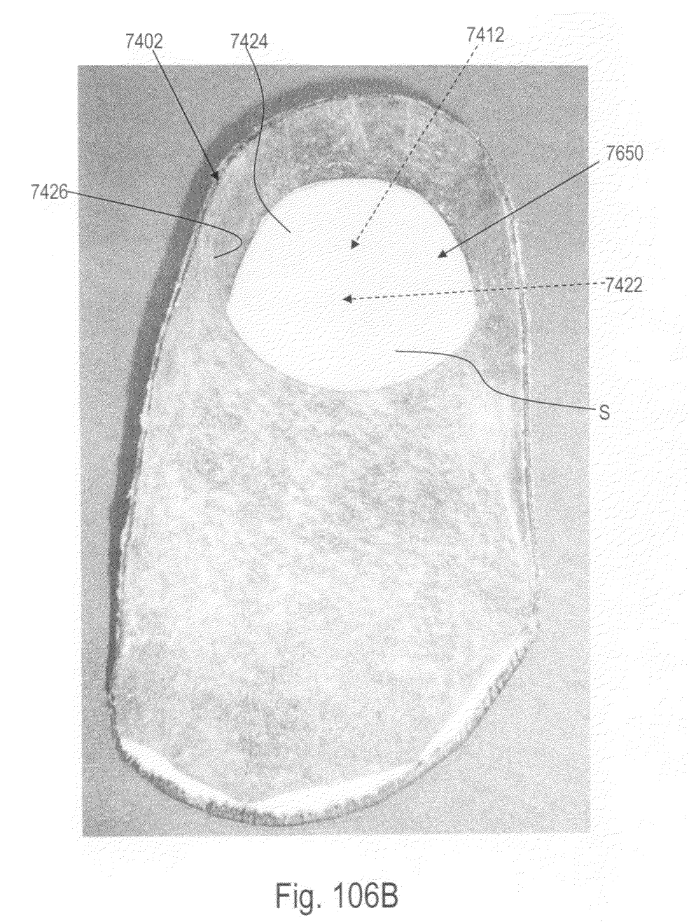

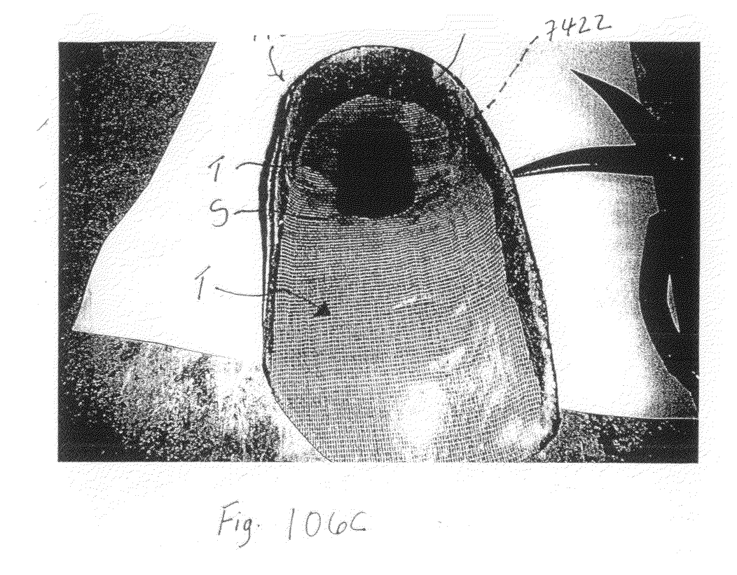

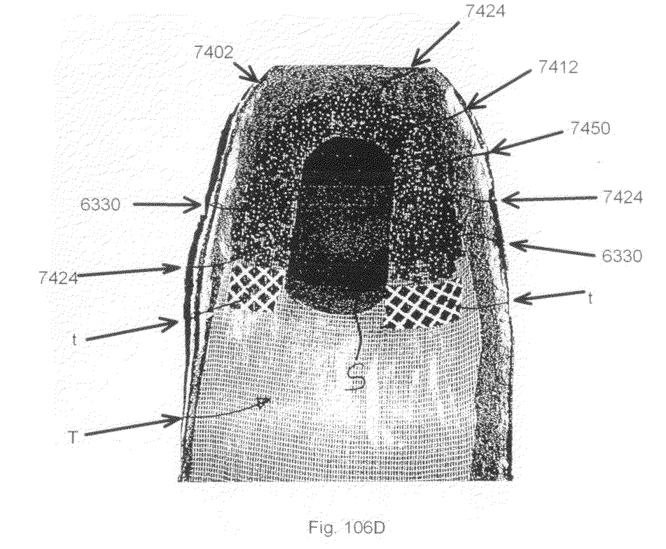

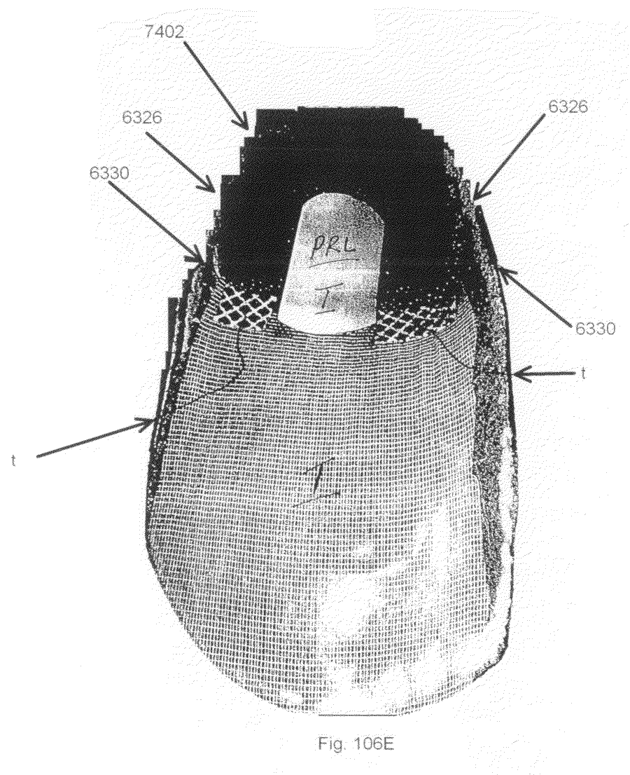

FIG. 106 shows a base layer 6402 or 7402, like that of FIG. 102 or 104, for forming a heel cup 7000″ (not shown), except that in FIG. 106, there is a sparse amount or thin layer of spread particles, and support pad 7450 has side walls tapered from a wide, higher top or upper surface to a reduced diameter lower surface that engages or is adhered to base support layer 7402. Boundary B just forward of the center forward edge of particles 2330 is uncovered. Particles 2330 in the peripheral area surrounding support pad 7450 are adhered to base layer 7402. The forward portion of heel support portion 7412 (not shown) can be skived or tapered to rise or descend as it extends in the forward direction such that the forward edge portion of the particles is tapered to smoothly join with the forward portion of the heel of, and/or the transverse and/or metatarsal arch portion of the base layer.

In the heel cups shown in FIGS. 102 and 104 through 106, particles 2330 are disposed along the mid-portion of the heel cups, axially, radially and transaxially forward from the forward edge of the respective boundaries to cover the metatarsal arch support portion of the base layer to its forward edge. The top surface of the boundary area or material preferably has an adhesive surface to secure the top layer or an upper layer to base layer 6502 or 7402. Also, preferably the forward portion of the annular pattern of particles has fewer particles or a smaller thickness than say the medial and lateral sides of the pattern of particles, to provide a smoother surface transition of the base layer from the heel portion to the transverse and/or metatarsal arch portion.

Referring to FIGS. 106A through 106E, there is disclosed a preferred method for forming preferred embodiments of insoles/midsoles of the disclosure for placement in or on an article of footwear to support all or a portion of a wearer's foot. Although the base shell support layer, also referred to herein for example as base layer 6402 or 7402, is suitable for forming a ⅔^{rd} length insole/midsole, it is to be understood that it is also suitable, with appropriate length adjustments, shortening the length for forming ⅓rd length insole or heel cup, or increasing the length for forming full length insoles/midsoles according to the disclosure.

Referring more particularly to FIG. 106A, the preferred method involves providing a base shell support layer, e.g., 6402, or 7402, that preferably is semi-rigid and has an upper surface that includes a heel support portion 6312 or 7412. The base shell support layer can be of any desired length. For example, the length can be a full foot length, a ⅔rds foot length, a heel cup length or ⅓ foot length. As formed, the base layer is a single layer or multilayer sheet devoid of particles. The base support layer can be formed of any suitable material or materials. It can have one or more built-in or molded-in anatomical contours. It can be or comprise a plastic, thermoplastic or elastomer, or it can have a plastic, thermoplastic or elastomeric core. Preferably it is made of a suitable polymeric material or blend of materials, for example, polyolefins such as polyethylene and/or polypropylene, or e.g., polyethylene terephthalate. It is contemplated that the base layer can be made from or comprise natural, synthetic or man-made materials, rubber or cork, or rubber or cork-binder, or adhesive or polymer blends. It is also contemplated that the base layer can be an expanded or blown material, for example, a foamed polymer or polymeric material, e.g., foamed polyethylene or propylene or styrofoam Preferably, the base layer is an as molded single layer sheet of polypropylene. It can be formed by any suitable forming or molding method, including but not limited to, e.g., compression molding, injection molding, extrusion molding, vacuum forming, solid phase pressure forming, or the like. Preferably, it is formed by injection molding. As formed, the base layer provides or includes at least a heel support portion, e.g., 7412. Preferably, the heel support portion also provides or includes a central area, e.g., 7422, a peripheral area 7424 substantially surrounding central area 7422, and a peripheral wall 7426 substantially surrounding peripheral area 7424.

The peripheral wall about the heel support portion can be from about 90 degrees to about 110 degrees or more, measured from the upper surface of the heel support portion. The extension of the peripheral wall along the medial arch support portion can be at a suitable wider angle, for example 135 degrees from the adjacent upper surface of the base layer. As formed, base layer 7402 preferably also is formed to include the upwardly extending convexly arched built-in or molded-in contour of one or a combination of arch support portions, that is, including any one or combination of, depending for example on the length of the base layer, a transverse arch support portion 6313, a medial longitudinal arch support portion 7414, a lateral arch support portion 7415, and a metatarsal arch support portion 7416 (none shown in FIG. 106A).

As an alternative but preferred step, the top and/or bottom surfaces, preferably at least the bottom surface of the as formed base layer 7402 can be provided with, e.g., impregnated with (while the base layer is in the near molten state), or coated or covered with a thin, lightweight, natural or man-made layer of cotton or cloth C (only top layer thereof shown). Cloth layer C preferably is molded-in or adhered to base layer 7402. As a further alternative but preferred step, the upper surface cloth layer, or the bottom surface cloth layer, or both, in their entirety or in specific selected areas, can be coated or covered with a fiberglass resin to increase the strength of base layer 7402, overall or in the selected areas. As formed, base layer 7402 can be any suitable thickness. Typically, the as formed base layer is from about ½ mm to about 1 mm thick. The as-formed base layer typically has an impregnated layer of cotton or cloth C thereon. A single resin coating usually is about ½ mm. Thus, the as formed base layer with the resin coated cotton or cloth layer typically is from about 1½ to about 2 mm thick.

After having provided the base layer that includes a heel support portion, the method preferably includes disposing a plurality of preferably substantially rigid particles on the heel support portion, preferably about the peripheral area of the base layer. This can be done by any suitable method or article, including by hand, by aid of a vibrator or device, e.g., through a tube or straw, or by providing the particles in a flexible package, assembly or unit, preferably shaped like or having the contour of the peripheral area of the heel support portion. Preferably, at least a portion of the plurality of the particles is secured, i.e., held, directly or indirectly to the upper surface of the heel support portion, preferably to the peripheral area of the base layer. The securing of at least a portion of the plurality of the particles to the heel support portion can be effected by applying to the particles or to adjoining surfaces, such as to the heel support portion, a lubricant, sealant or material that has non-hardening, binding adhesive properties. Preferably, the lubricant, sealant or material is a thick one, as discussed previously herein, that adds sticky, non-hardening, pressure-yielding, cushioning and/or support properties, as well as position-maintaining or securing properties to the particles. The material can be a sticky silicon caulking type of material. The securing of at least a portion of the plurality of the particles indirectly to the heel support portion or its peripheral area or portion can be effected by providing the particles in a flexible package that preferably is shaped like the peripheral area of the heel support portion, and securing the flexible package to the heel support portion or peripheral area of the base layer.

Preferably after disposing a plurality of the substantially rigid particles on the heel support portion or on its peripheral area and securing at least a portion of the particles to the base layer, the method includes providing a flexible upper layer of footwear material that is sized to fit within the base shell support layer, and securing the upper layer to the base layer in a manner that includes maintaining the particles in an area between the upper layer and the base layer.

According to an embodiment of the disclosure, as shown in FIG. 106B, a resilient pad or cushion layer generally designated 7450 can be placed on and adhered to underlying central area 7422 (dashed line) of base layer 7402, and as shown desirably also to all or a portion of peripheral area 7424 of heel support portion 7412. The unskived portion of cushion layer 7450 can be about 1 mm thick. The forward edge S of cushion layer 7450 preferably is skived, thinned, shaved or tapered to gradually increasingly thin the cushion layer, if needed, to provide a smooth thinned knife edge finish or transition from heel support portion 7412 to its forward transition area.

Referring to FIG. 106C, a layer of an adherent, preferably a two-adhesive sided tape T is applied and adhered to the entire top surface of the base layer 7402, including over cushion layer 7450 (not shown).

A second resilient pad or cushion layer 7450′ preferably is placed over and adhered to central area 7422 of two-adhesive sided tape T. The forward edge S of cushion layer 7450′ can also be skived to provide a smooth transition from the forward edge. The unskived portion of second cushion layer 7450′ also can be about 1 mm thick. Preferably, a paper release layer-covered double-adhesive sided tape T is applied, that is, adhered to the top surface of second cushion layer 7650′.

Referring to FIG. 106D, a thin layer of unlubricated particles, preferably pre-measured, is disposed, e.g., spread or sprinkled, onto the top surface of the exposed portions of two-sided tape layer T that extend about the rear and side portions of peripheral area 7424 of heel support portion 7412 of FIG. 106C. Particles 6330 can be but preferably are not disposed on second cushion layer 7450′. The so-disposed thin layer of particles is thus adhered to previously exposed underlying adhesive layer of double adhesive sided tape T.

FIG. 106D shows two checkered adhesive tape portions “t”, one located to either side of second cushion layer 7450′, and each covering the forward or distal end of a respective leg of a U- or C-shaped disposition of particles 6330. The checkered adhesive tape portions “t” provide a skiving effect to smoothen the transition of particles 6330 from heel support portion 7412 to transverse arch support portion 7413 (not shown). In embodiments in which particles 2330 do not extend forward under tape portions “t”, that is, tape portions “t” are not placed on particles 2330 but rather are employed forward of the particles' forward edge, the two checkered adhesive tape portions “t” would still provide the aforementioned skiving effect.

Referring to FIG. 106E, a top paper release layer (PRL)-covered double-sided adhesive tape T having basically the same shape as second cushion layer 7450′ (hidden) is adhesively applied directly onto second cushion layer 7450′ without removing the top paper release layer PRL.

A preferably pre-measured second layer of particles 6330 that has been lubricated, doped or treated with a non-hardening, binding adhesive material is applied onto the first layer of secured non-lubricated, doped or treated particles 6330, and the second layer of particles is smoothed out or moved about such that they are provided in the desired contour. The binding adhesive material provides tackiness or stickiness to the particles. It allows the second layer of particles to be deposited on the first particles and readily moved about to the desired positions at which the tacky particles resist further movement until downward pressure is applied, for example, by a wearer's heel when it is initially positioned on the particles and forces them to move. The tacky particles are forced to move into a desirable, comfortable, supportive position where the particles will remain for that wearer's heel. Alternatively, the second particles can be non-lubricated, non-doped and non-treated when they are applied to the first particles, and once the particles are manipulated or moved to the desired position, the lubricant can be added to provide the desired adhesiveness. A suitable lubricant or material is a Teflon™ based sealant that is non-toxic and basically non-melting in that it can be employed within a wide range of temperatures of from about 0 degrees to about 425 degrees F. Such a lubricant is commercially available from the Aladdin Equipment Company of Sarasota, Fla., under the trade designation Magic Lube®.

FIG. 106E also shows two checkered adhesive tape portions “t”, one located to either side of top paper release layer (PRL)-covered double-sided adhesive tape T, and each covering the forward or distal end of a respective leg of a U- or C-shaped disposition of particles 6330. As stated above, the checkered adhesive tape portions “t” provide a skiving effect to smoothen the transition of particles 6330 from heel support portion 7412 (not shown) to transverse arch support portion 7413 (also not shown). Prior to securing an upper layer, e.g., 6502 or 7502, to base layer 7402, paper release layer PRL is removed to expose the underlying layer of tape for securing upper layer 7502 thereto. Upper layer 6502 or 7502 is also secured to the other exposed double adhesive sided tape portions T of the base layer. In accordance with the disclosure, these portions can include the forefoot area of the insole/midsole and the inside surface portions of peripheral wall 6326.

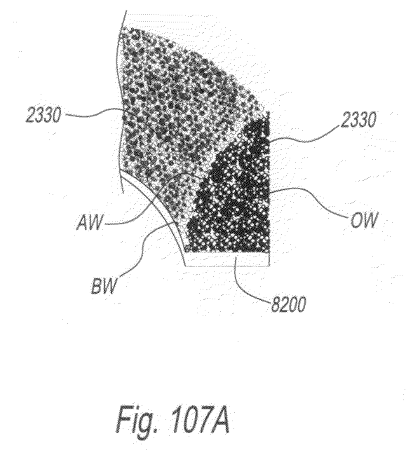

FIG. 107 shows an embodiment of a pre-packaged or pre-assembled particle heel support assembly or unit, generally designated 8000, for simplified and rapid placement or assembly into the heel support portion 6312 of a base shell support layer (usually referred to herein as a base layer, e.g. base layer 6300, 6402 or 7402), to customize the heel portion of full, ⅔ and/or ⅓^{rd} length embodiments of this disclosure. More particularly, heel support unit 8000 preferably is but need not be of ⅓^{rd} of a foot length and is comprised of a substrate 8200 on or to which is secured an annular pattern of a plurality of particles generally designed 2330. Substrate 8200 can be any suitable substrate such as a layer or disk of a flexible, semi-rigid, rigid or composite material suitable for adhering particles 2330 thereto. Substrate 8200 can have any suitable shape or configuration. It can be an annular pattern, herein understood to include a D-shaped, U-shaped or C-shaped pattern when seen in top plan view, for example, to match the top plan view pattern or shape of the particles that are secured to or supported by the substrate. Substrate 8200 can be a single or multilayer film or sheet. It can be or include a firm or resilient single or multilayer support pad. Particles 2330 can be disposed on substrate 8200 in an annular D-shaped pattern as shown. An annular pattern in this disclosure is understood to include a ring, doughnut or D shape, or other suitable fully enclosed or enclosing patterns, or partly enclosed or enclosing patterns, for example, those of a C-, U-, or horseshoe shape, or triangular shape, when seen in top plan view.

Particles 2330 preferably are secured to substrate 8200 by any suitable means, for example, by having a lower level of larger particles adhered to the upper surface of the substrate, and upper levels or layers of particles comprised of smaller or finer particles that are coated with a suitable viscous material with adhesive properties as disclosed herein, such as a Teflon® liquid material which is slippery enough to allow the finer particles to migrate and adjust to customize the heel fit and heel support, and sticky enough to prevent excessive migration, and allow and maintain customization.

As shown in FIG. 107A, a vertical sectional view as would be seen along line 107A-107A of FIG. 107 through the pattern of particles of FIG. 107. Preferably, the shape or pattern or profile of the particles, at least that of the particles of the unit that are adjacent and generally correspond to the peripheral wall, e.g., 6326, of base layer 6402, can be that of a particle-filled right triangle, the outer wall surface OW and back wall (not shown) of which being substantially vertical to the bottom wall BW, and the angular wall (hypotenuse) AW being at an acute angle to the respective side and bottom walls. The angle of the forward wall FW of the unit of FIG. 107 can be more gradual or tapered than the angle of angular wall AW to provide a gradual comfortable transition to the medial arch support portion of base layer 6402 in which the heel support unit is located. In FIGS. 107 and 107A, substrate 8200 is a disc that can extend across the open central area of the D-shaped pattern, and extend to the outer peripheral edge of that pattern. Particles can be deposited on the or a disc that extends across the open central area of the D-shaped pattern.

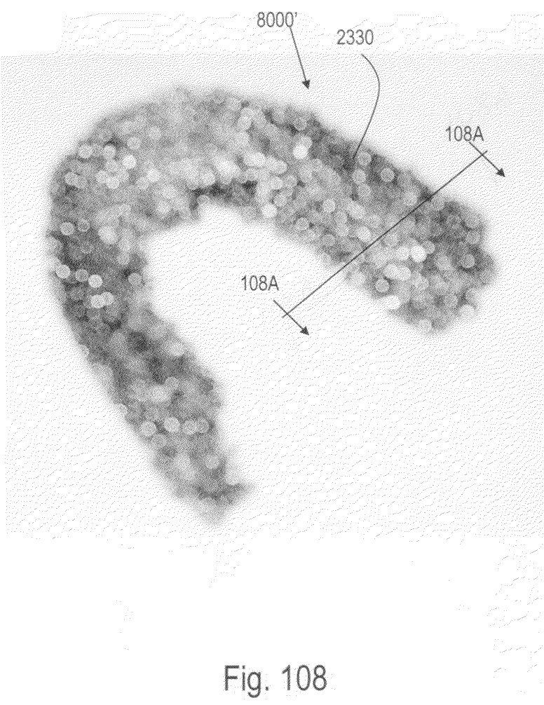

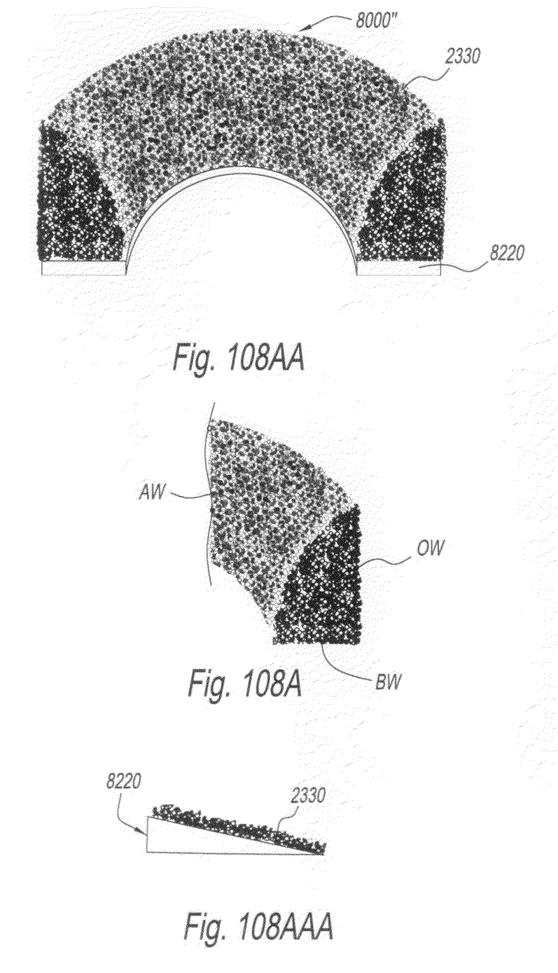

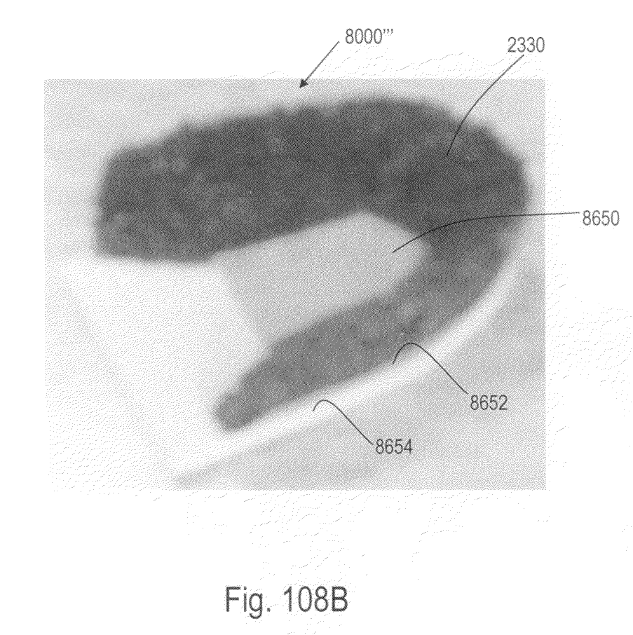

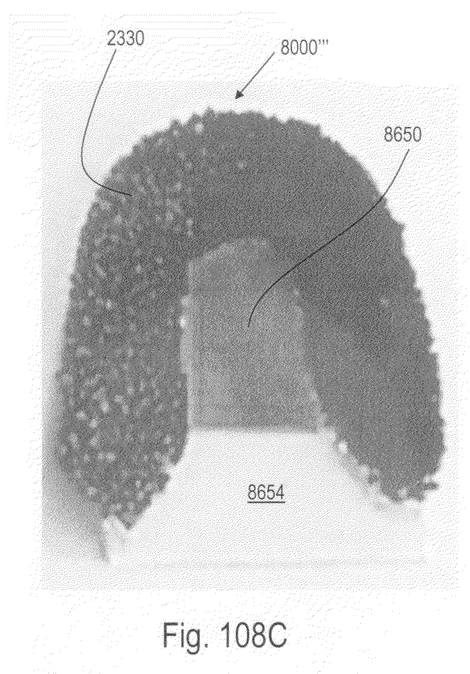

FIG. 108 shows another embodiment of pre-packaged or pre-assembled particle heel support assembly or unit, here shown as 8000′, whose pattern when seen in top plan view has a C- or U- or horseshoe shape, and whose cross sectional profile can be similar to that shown in FIG. 107A. While each of units 8000 and 8000′ can include one or more substrates as explained above, it is to be noted that, as shown in FIGS. 108 and 108A, neither needs to have a substrate. It is contemplated that each unit can be an integral unit of agglomerated particles that are held together temporarily until customizing or another desired time, and then or previously treated, for example, as by the application of heat and/or an applicable solvent or material to selectively loosen a portion, for example the upper levels of doped particles, especially along angular wall AW, to allow them to migrate or move to accommodate, fit and support the wearer's heel before and/or when it is forced into the unit, before or when the unit is positioned or secured in the heel portion of the base layer of the insole or midsole of an article of footwear, for example, in accordance with the disclosure. A vertical section taken through the outer wall of support unit 8200 of FIG. 108 preferably would also look like that shown in FIG. 107A.

FIG. 108A is a vertical sectional view as would be seen along line 108A-108A through the pre-packaged or pre-assembled heel support unit 8000′ of FIG. 108. As discussed above, support unit 8000′ need not have, and, as shown, does not have a substrate or underlying support layer.

FIG. 108 AA is a vertical section as would be seen through another embodiment of a pre-packaged or pre-assembled heel support assembly or unit, assembly or heel cup 8000″ that has a support or substrate layer 8220 or layers that has or have or correspond to the overall C-shape of the pattern of particles (as would be seen in top plan view).

FIG. 108AAA shows a side elevational view of a substrate or base 8220′ that can be comprised of a resilient or malleable material such as a gel or an air bladder, inflatable or not, which supports or to which a plurality of particles 2330 may be adhered.

FIGS. 108B and 108C show another embodiment of a pre-packaged or pre-assembled heel support assembly or unit 8000″ comprised of a C, U- or horseshoe shaped relatively loosely designed agglomeration of particles 2330 held together temporarily as desired by any suitable means, including by a flexible or semi-rigid package described elsewhere herein. Preferably, the particles are secured to a substrate, e.g., at least to a centrally located member, such as resilient pad 8650, and/or to a still larger diameter substrate 8652 (FIG. 108B), and/or to a still larger diameter underlying spacer layer 8656 which in turn is secured to an underlying possibly even larger substrate layer 8654, the entirety of which can be deposited into and preferably but not necessarily secured to the heel support portion 6312 of a full, ⅔rds or ⅓ heel cup base layer (not shown). The forwardly extending portions of spacer layer 8652 and preferably also shock absorbing substrate layer 8654 are tapered or skived for comfort to the wearer's foot in the transitional area from the heel support portion to the transverse or other arch support portion. The more central portion of the heel support assembly or unit can have any suitable compilation or number of layers. The substrate shock absorbent layer can be about 3 mm thick and the resilient support or cushioning pad 8650 can be about 1 mm thick.

Although the preferred vertical sectional profiles for the annular patterns of particles for embodiments of the heel support, assemblies or units of this disclosure are triangular, it is contemplated that other suitable shapes can be employed. For example, the vertical sectional profile may be circular, oblong ovular, or annular or rectilinear such that a portion or portions of the particles or other provided or packaged matter, e.g., gels or air particles or bladders, in or on the peripheral area of the heel support portion of the base layer of whatever size will accommodate and move and adapt to fit and support the wearer's heel.

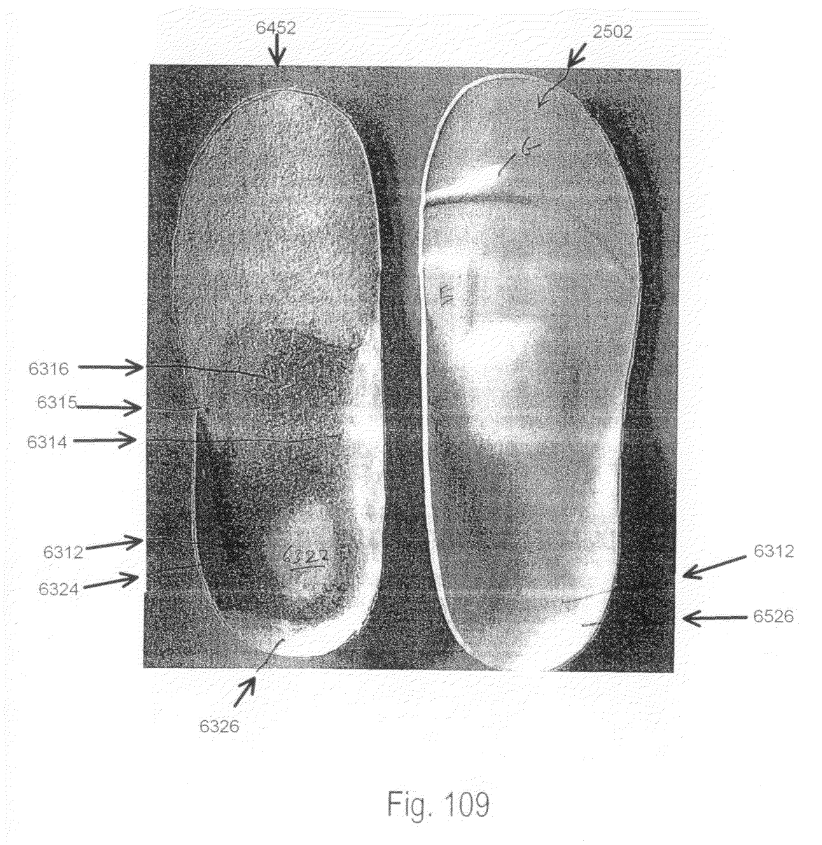

FIG. 109 shows, on the left side of the Figure, a full length base shell support housing, often referred to herein as base layer, e.g., 6402, having particles disposed in an annular pattern or in the peripheral area 6324 of heel support portion 6312, and extending axially forward and covering the lateral arch support portion and upwardly contoured medial arch support portion, 6315 and 6314, as well as the upwardly contoured metatarsal arch support portion 6316 of base layer 6204. Base layer 6204 is shown covered by an upper layer of cotton or cloth that is coated in the proximal ⅔rds portion with a fiberglass resin for stiffening base layer 6402. FIG. 109 shows that base layer 6204 has an upwardly extending peripheral wall 6326 that is substantially perpendicular to heel support portion 6312. The central area 6322 of heel support portion 6312 is substantially devoid of particles.

The right side of FIG. 109 shows a formed top layer 6502 having a built-in toe grip G and a first metatarsal elevation E to act as a guide for placement of extra support of pads, springs, etc. in a manner described herein, if desired. The right side of FIG. 109 also shows that resilient top layer 6502 has built-in contours, for example, a metatarsal support dome shape, that correspond to those of base layer 6402. FIG. 109 also shows that top layer has a radiused heel portion 6312 and a peripheral wall portion 6526 that form a bowl-like configuration.

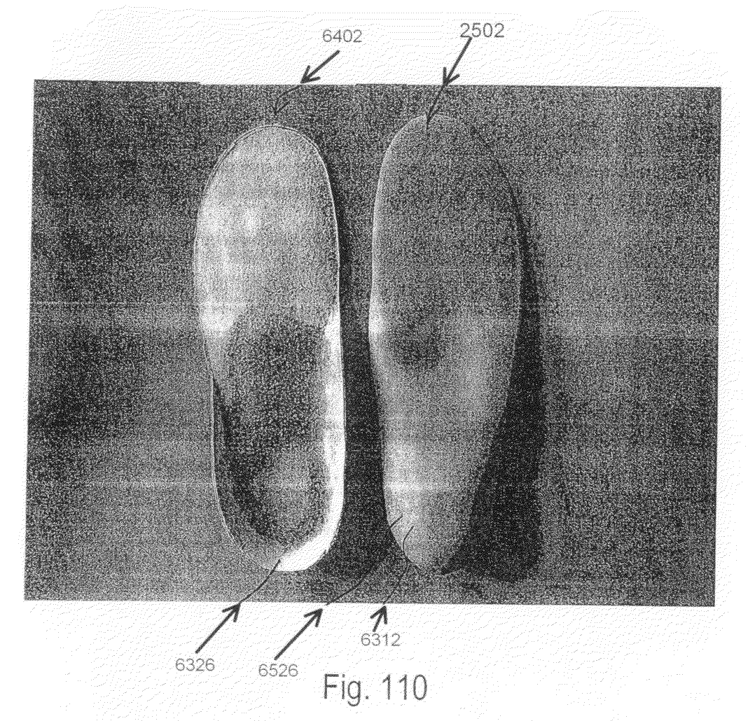

FIG. 110 shows, on the left side, the full length base layer 6402 shown in FIG. 109, and on the right side, the bottom surface of a resilient top layer 6502 that is similar to the top layer shown in FIG. 109, particularly with respect to its built-in contours and the radiused heel portion.

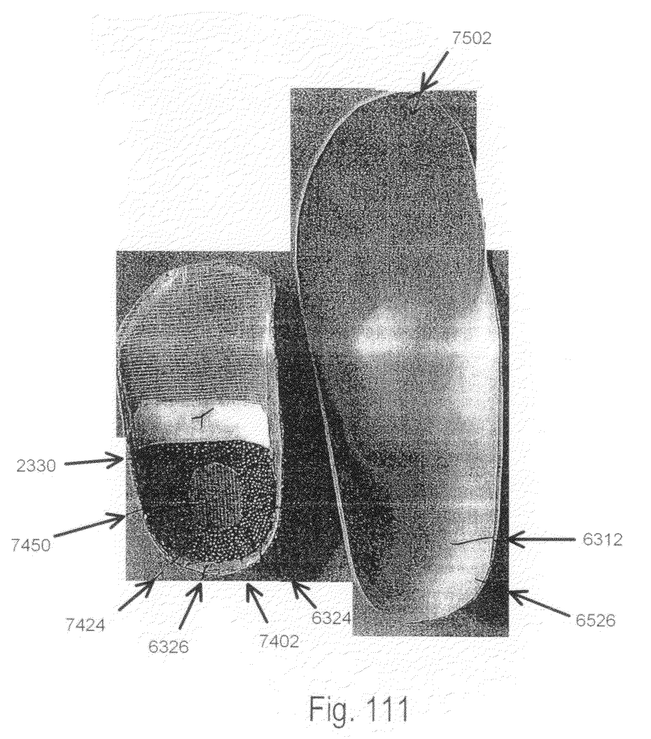

FIG. 111 shows an embodiment of a base layer 7402 for forming a ⅔rds or ⅓^{rd} insole/midsole or heel cup 7000′″ (not shown) that is similar to previous base layers 7402 for forming ⅔rds or ⅓^{rd} insoles/midsoles or heel cups, except that base layer 7402 has particles 2330 disposed more densely in an annular pattern in peripheral area 6324 about a heel support pad 7450 having an adhesive top surface and a plain top sided strip of opaque tape T adhering the forward edge of particles 2330 and the rear edge of the particles covered by two-adhesive sided tape adhered to base layer 7402. FIG. 112 shows the top surface of a resilient contoured top layer 7502 having a radiused heel support portion, similar to that shown in FIG. 109. Tape T functions as a band B (not shown). Tape T helps to smooth the transition of the forward edge portion of particles 2330 that extend toward the transverse arch, and/or the medial arch and/or the metatarsal arch.

FIG. 112 is similar to FIG. 111 except that it shows on the right side the bottom surface of the resilient full length contoured top layer 7502 shown to the right side in FIG. 111.

FIG. 113 shows a striped cloth top layer 2502 of a finished full length insole/midsole 6400. The oval area shown in the heel area can be used to display the company brand or logo, and to provide extra cushioning.

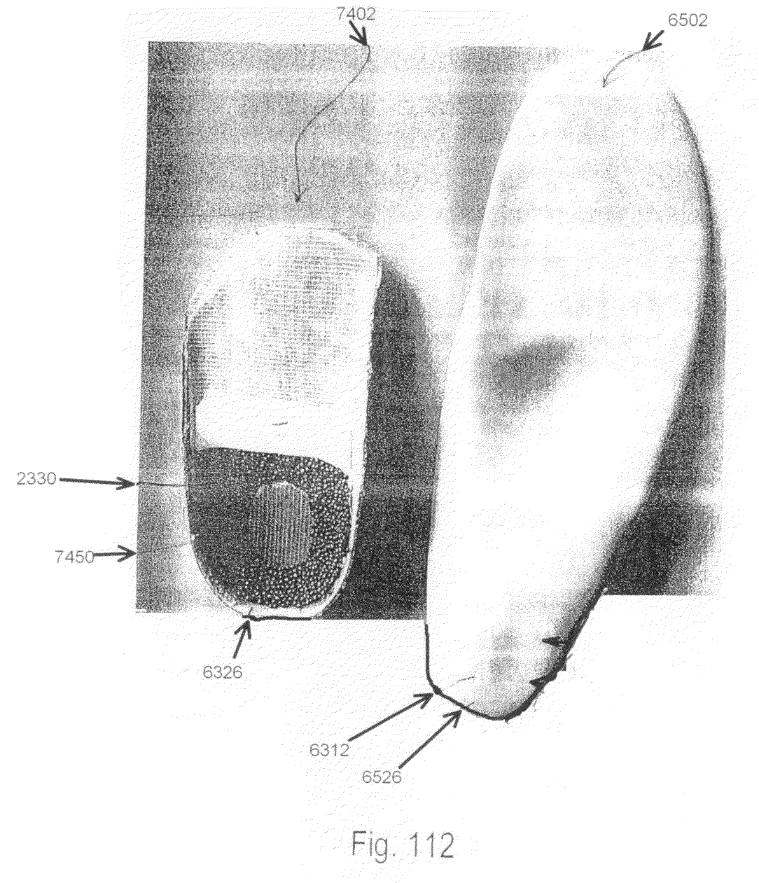

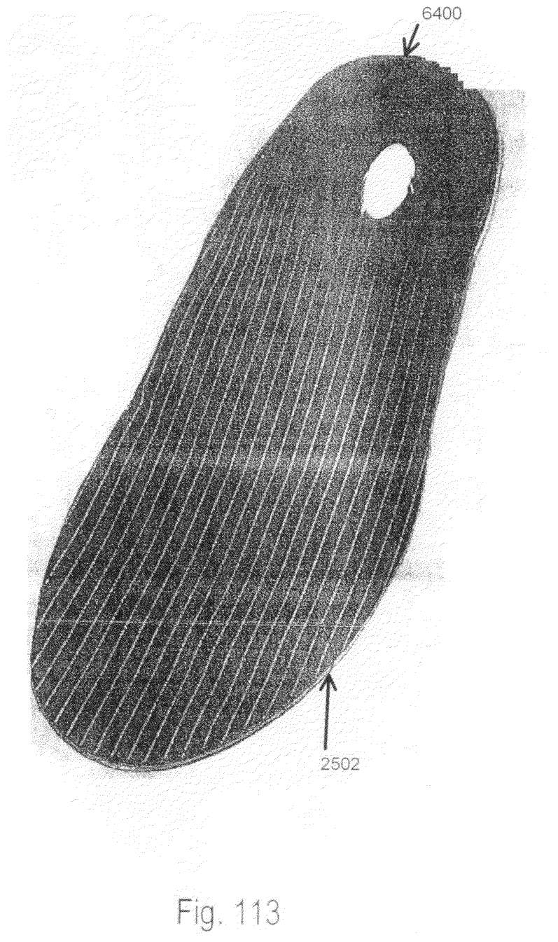

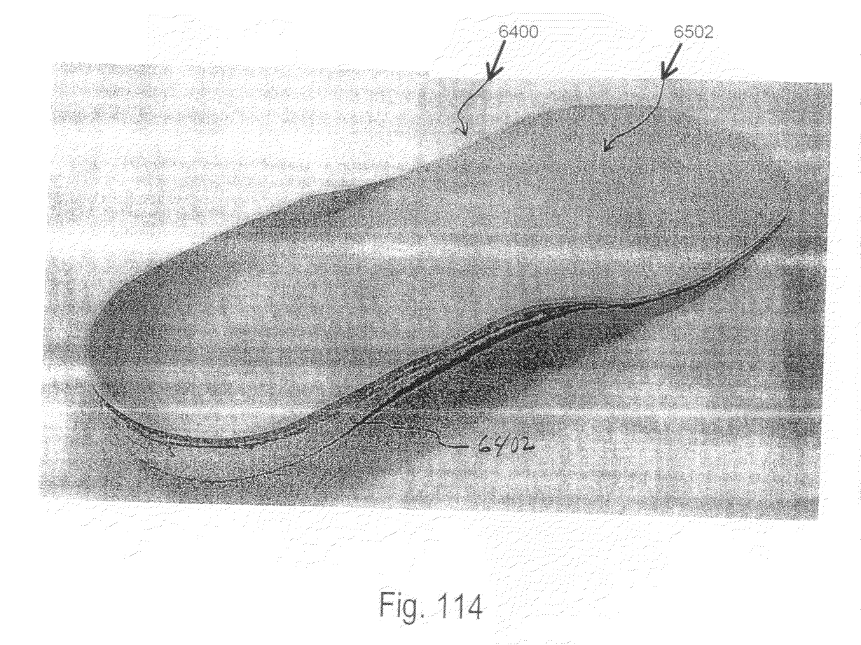

FIG. 114 shows a finished full length insole/midsole having a resilient top layer 6502 secured to a full length base layer 6402 in accordance with this disclosure.

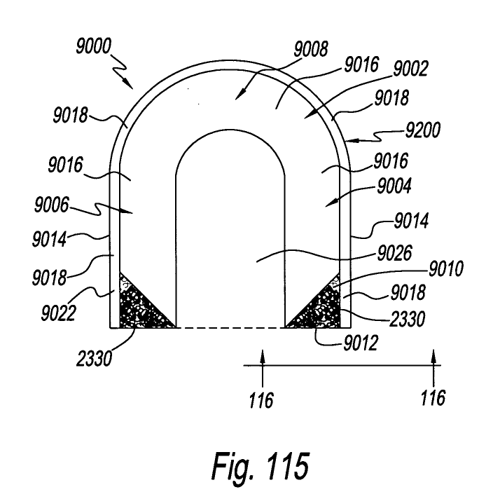

FIG. 115 through FIG. 122 show schematic views of a package 9000, preferably a flexible package, for containing a plurality of particles 2330 therein, comprised of a main body 9200 in turn comprised of a flexible film 9002 and having an annular shape, preferably a substantially C-shape, when seen in top plan view. Main body 9200 is comprised of two distally extending arms 9004, 9006 and a proximal connecting portion 9008 that communicates with the arms, the two arms and connecting portion forming a channel 9010 running therethrough for containing the plurality of particles 2330 therein. Preferably, the two arms 9004, 9006, connecting portion 9008 and channel 9010 need not be, but preferably each are substantially triangularly shaped when viewed in vertical section.

Package 9000, has a bottom wall 9012, an upwardly extending outer side wall 9014 that communicates with the bottom wall, and an upwardly extending angular inner side wall 9016 that communicates with the upwardly extending outer side wall and the bottom wall. The upper portion of the upwardly extending outer side wall 9014 and the upper portion of the angular inner side wall 9016 cooperate to provide an open passageway 9018 having an elongated top opening 9022 for ingress and egress of particles to and from the triangularly shaped channel 9010. The triangular shape of the main body 9200 and channel 9010 when viewed in vertical section can be substantially that of a right, obtuse or acute triangle. The shape of the channel can be any suitable shape, including rectilinear, circular or ellipsoidal. As shown, channel 9010 contains a plurality of particles 2330.

Embodiments of package 9000 can be heel support assemblies or units 8300. For example, package 9000 can have a central area 9026 (FIG. 115) that is defined by arms 9004 and 9006 and connecting portion 9008. Central area 9026 can include a web or sheet (not shown) that may serve as a substrate that communicates, supports or is integral with the arms and connecting portion, and extends across central area 9026. The web or sheet can support particles across the central area. The web or sheet can be single or multiple layers, and it can be a flexible single or more layer package or pouch that contains particles. The package or pouch can be freely deposited on and/or secured to the substrate or it can be part of the package 9000. The web or sheet can also extend radially outward under where it can be secured to the bottom wall 9012.

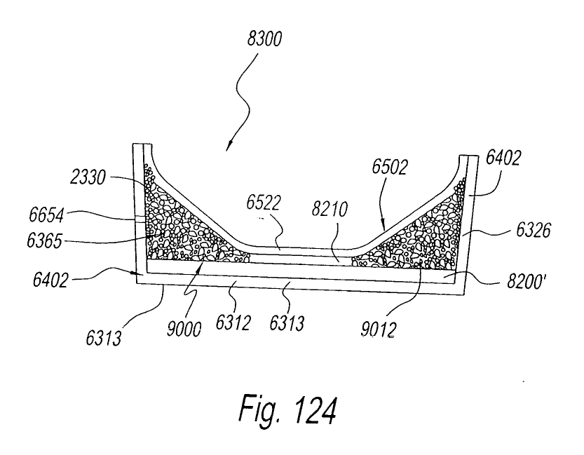

Package 9000, and thus assemblies or units 8300 can include a resilient shock absorbing layer such as shown as 8200′ in FIG. 124 whose upper surface can be secured to the bottom surface of the bottom wall 9012 and/or 9026 or the web of the package or unit. As in FIG. 124, resilient shock absorbing layer 8200′ can have a lower surface of adherent material. Package 9000 or unit 8300 can have a central area defined by arms 9004 and connecting portion 9006, and the resilient shock absorbing layer 8200′ can extend across central area 9026 of the package or unit.

Package 9000, and thus assemblies or units 8300, can include a spacer heel elevation layer 8210′ (not shown in FIG. 115), as such as designated 8210 in FIG. 124, that is secured to the upper surface of resilient shock absorbing layer 8200′ so that the spacer heel elevation layer 8210′ extends across central area 9026 of the package and preferably under bottom wall 9012 of package 9000 per se or of the unit. Spacer heel elevation layer 8210′ can be comprised of a firm material having a Durometer of from about 70 to about 80 on the C-Scale. Resilient shock absorbing layer 8200′ can have the shape, including the outer peripheral shape or the specific shape of the outer periphery, of the bottom wall 9012 or the shape of the package or unit when the package or unit is viewed in top plan view.

In package 9000, the material of the package adjacent the junction of bottom wall 9012 and the angular inner side wall 9016 of the package preferably is firm enough to prevent particles from migrating into the central area of the package and indenting into the peripheral side edges of the resilient shock absorbing layer.

In package 9000, the substantially C-shaped main body includes a pair of terminal distal end walls or panels 9024, one at the end of each arm 9004, 9006, each terminal end wall or panel being angled from a relatively proximal upper portion of the arm to a thinner lower distal end portion of the arm.

In package 9000, the walls that form the open passageway can include a closure seal (not shown) that is secured to the package for sealing the particles in the package.

Package 9000 can be comprised of any suitable flexible single or multi-layer sheet or film, for example a plastic or elastomeric material. Suitable sheets and films can be comprised of, for example, an ethylene or propylene polymer or copolymer or blend thereof. A suitable material is an ethylene vinyl acetate.

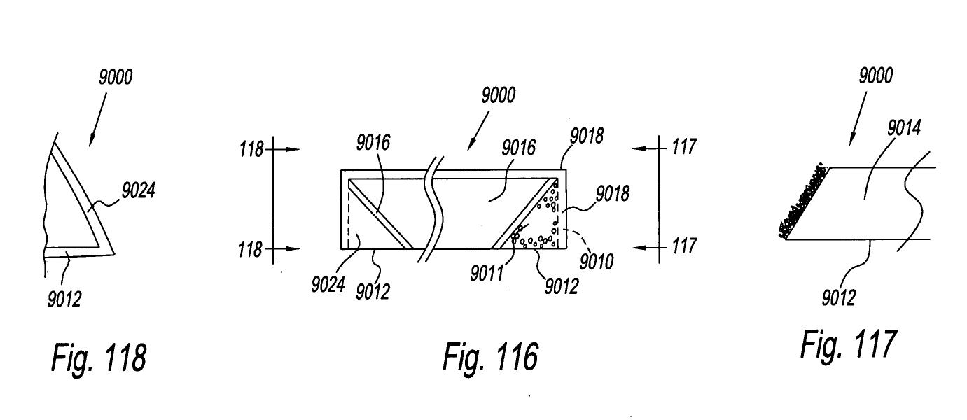

FIG. 116 is a front elevational view of the front of package 9000 as would be seen along line 116-116 of FIG. 115. The right side of the FIG. 116 shows triangular channel 9010 having an open end 9011 with particles 2330 therein. The left side of the Figure shows that optionally, the forward end of channel 9011 can be fully closed by a full panel 9024, or partly closed by a smaller sized panel (not shown).

FIG. 117 shows that the front open end of package 9000 may be slanted rearwardly, e.g., from the forward edge of bottom wall 9012 to the top edge of the package. It may instead be slanted forwardly from the bottom wall to the top edge or adjacent to the top edge of the package.

FIG. 118 is similar to FIG. 117 except that the side elevational view is along line 118-118 of FIG. 116, and that the front end is covered by a panel 9024 that is slanted rearwardly, e.g., from the forward edge of bottom wall 9012 to the top edge of the package.

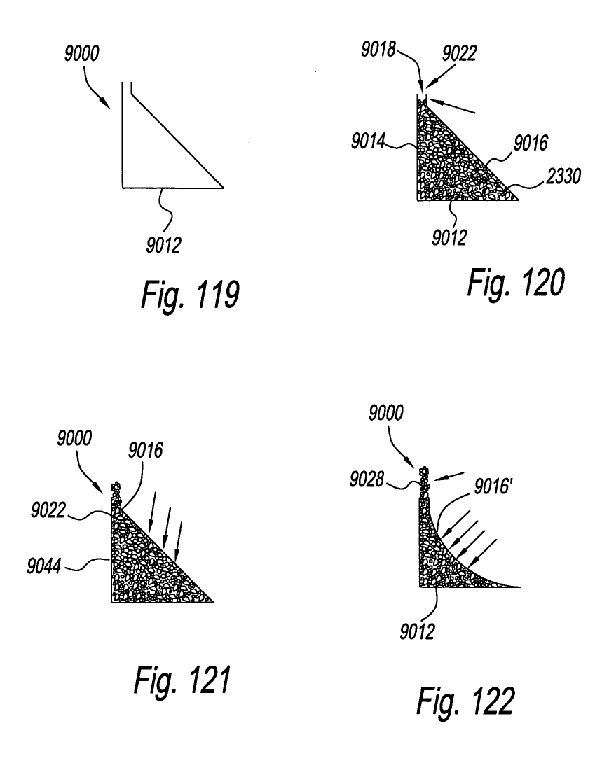

FIG. 119 schematically shows a vertical section through a triangular main body wall of an empty flexible package 9000 that preferably is self supporting, that is, it supports itself in an upright position when resting on its bottom wall 9012. The outer side wall 9014 of the package can be made of a semi-rigid material for this purpose.

As also seen in FIG. 120, the top edge of the plurality of particle filled package is open, preferably in the form of an open passageway 9018 having an elongated top opening 9022, that preferably is in the form of an elongated funnel, to allow beads to move upward and, if necessary, escape from the package, for example when a wide heel of a foot presses downward onto the package, usually onto its upwardly extending angular inner wall 9016. Open passageway 9018 can be used to receive a tube, straw or hand (not shown) to feed particles into and/or withdraw particles from channel 9010. It is contemplated that, if desired, elongated top opening 9022 can be used to fill the channel and then opening 9022 can be sealed by means of a sealable or releasable and resealable adhesive. FIG. 120 shows package 9000 before the weight of a wearer's body is applied through the wearer's heel.

FIG. 121 shows particles moving or moved upward through top opening 9022 when weight is applied by the heel in the downward direction of the arrows.

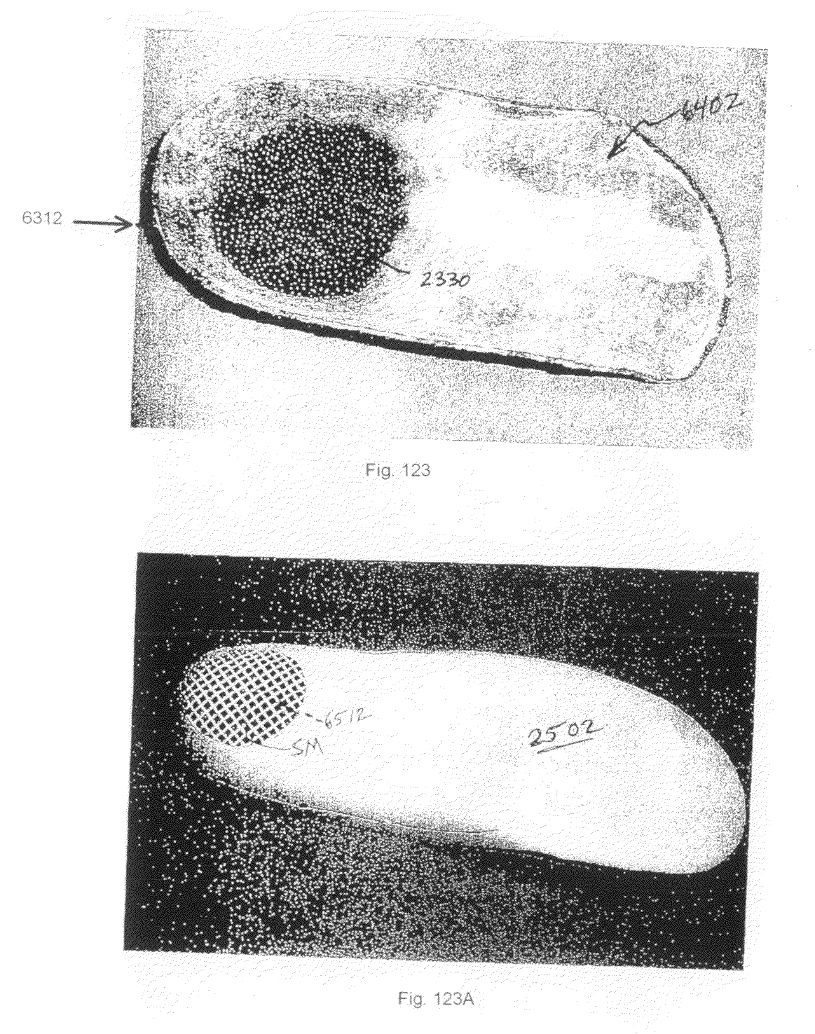

FIG. 122 shows particles moving or having moved upward through top opening 9022 as or after the heel is placed on and moved downward with pressure onto inner angular wall 9016 thereby forcing wall 9016 to take on a radiused or bowl-like shape 9016 that conforms to the shape of and supports the heel.

With respect to FIGS. 120 through 122, package 9000 is suited to perform as described especially in the presence of restraining members or walls, for example, a rigid or semi-rigid heel support portion 6312 of a heel bottom wall 6313′, and a package side wall-engaging peripheral wall 6326 of a semi rigid base shell support layer or base layer, e.g., 6402.

Suitable materials for the manufacture of package 9000 include polyolefinic materials, for example, a polyethyene or polypropylene or blend thereof for the side, inner angular and bottom walls 9014, 9016 and 9012. It may be beneficial to employ an inner angular wall material that is relatively flexible to allow the material and layer to conform to the shape of the wearer's heel, but that also has sufficient stiffness or firmness to prevent particles in the package from indenting the underside of the heel portion of a top layer, e.g., 6502, that may be made of a soft or resilient material, thereby preventing the formation of convex mounds on or in the upper surface of the top layer and possible consequent heel discomfort.

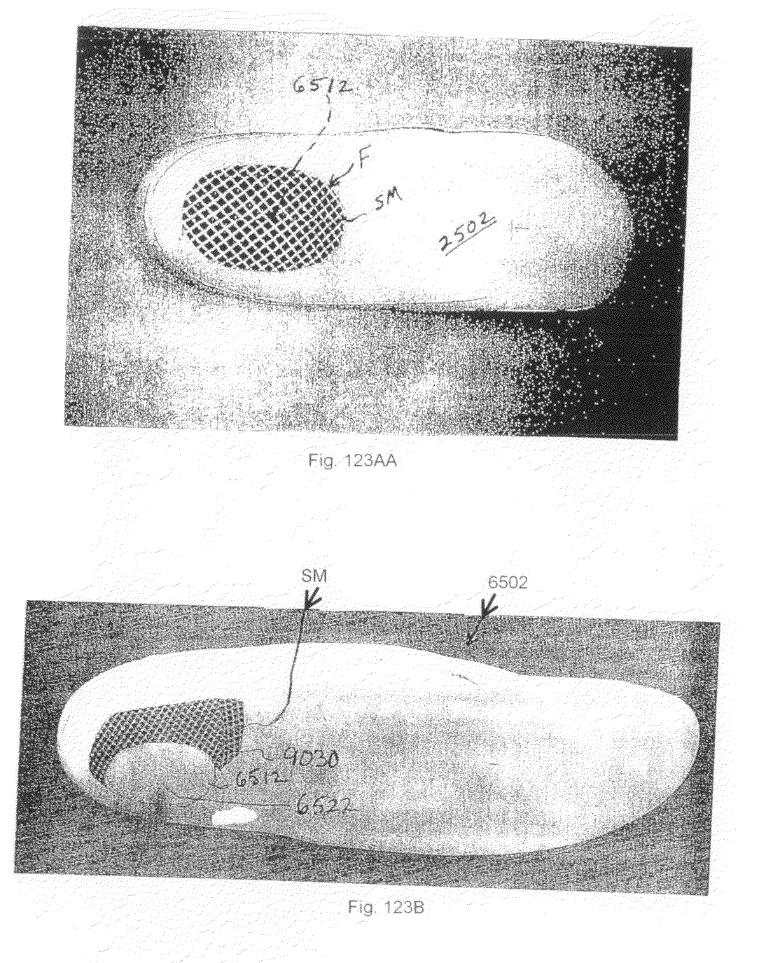

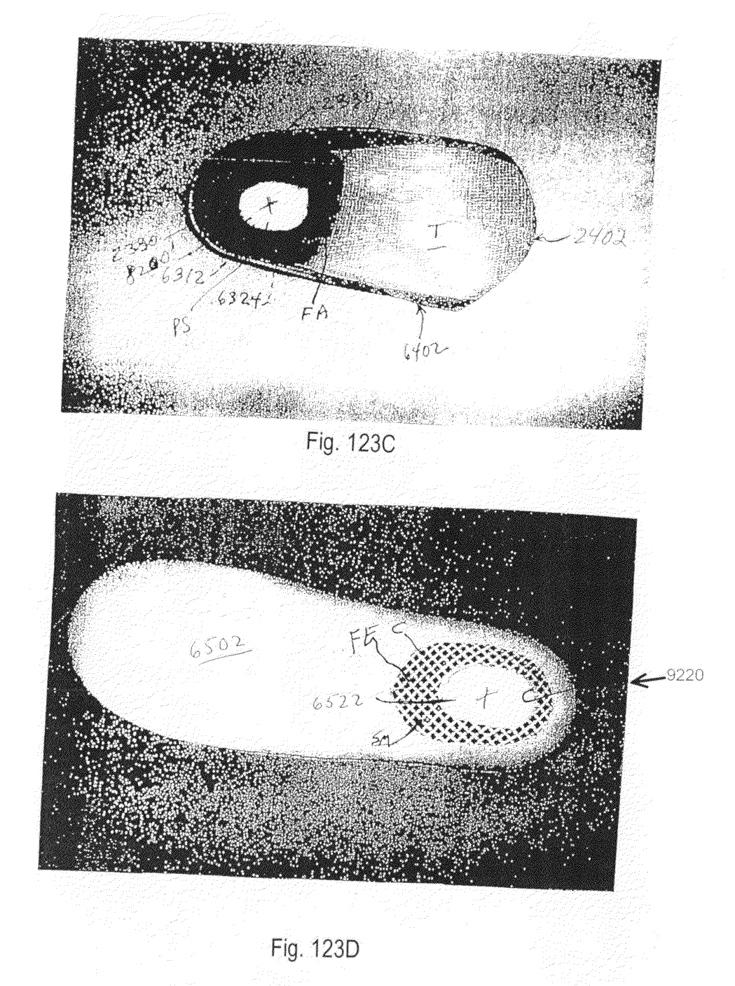

FIG. 123 shows an embodiment of a base support layer for an insole/midsole or heel cup substantially as described in FIG. 106A of the disclosure. More particularly, FIG. 123 shows a base support layer 6402 or 7402 basically the entirety of whose heel support portion 6312 (dashed line) or 7412 is covered with particles 2330. In this embodiment, particles 2330 can be directly or indirectly on or secured to base support layer 6402. There can be included a resilient or cushioning spacer pad or layer 8210′ (not shown) on a portion of or that covers the heel support portion of base layer 6402, and particles 2330 are disposed on or secured to the upper surface of cushioning spacer pad or layer 8210′. In another embodiment of the disclosure, there can be a layer of a firm or stiffening yet moderately dense and flexible material SM, e.g., cardboard, e.g., between the resilient cushioning pad or layer 8210′ and particles 2330. Of course, although a ⅔rds length base support layer is shown, the base layer could also be of full or ⅓^{rd} length.

FIG. 123A shows the undersurface of a full length upper or top layer 2502 or 6502 suitable for being laid over and secured to a full length or ⅔rds length base support layer 6402 in accordance with the disclosure. More particularly, FIG. 123A shows that if the material of top layer 2502 or 6502 is soft or resilient, and/or if it is desired to eliminate or not use a firm or stiffening yet moderately dense and flexible material SM, for example, to not use a cardboard layer as referred to above in connection with FIG. 123, all or a portion or portions of the undersurface of heel support portion 6512 of upper or top layer 6502 can have secured, e.g., adhered, thereto a layer, disc or patch (shown as cross-hatched) of a stiffening, or firm anti-particle indenting material SM. For example, as shown in FIG. 123A, the disc of stiffening material SM can be located to prevent particles from protruding into top layer 6502 in the area of the plantar facia ligament attachment area of the wearer's heel. The anti-particle indenting material preferably is moderately dense, has some flexibility and is about ½ mm thick. Alternatively, for example, the patch of stiffening material SM can cover the entirety or substantially the entirety of the area of base support layer 6402, or of heel support portion 6312 or of the particular area where there are or potentially could be protruding particles, for example, but not limited to, the area of particles shown in FIG. 123.

Alternatively, as shown in FIG. 123M, the layer, disc or patch can be an oval or egg or egg-like shaped and can be cross-hatched patch of stiffening material SM on the bottom surface of top layer 6502. The layer disc or patch can be designed and positioned to cover desired portions or areas of particles 2330, for example, those located on central area 6322 and all or a portion of peripheral area 6324 of heel support portion 6512 of the base support layer 6402. The forward or distal portion generally designated F of the cross hatched patch of stiffening material, when overlayed on and secured to base layer 6402, will extend forward or distal of or beyond the forward edge of central area 6322 of heel support portion 6312 of base support layer 6402. Generally, the shape of the layer, disc or patch of crosshatched stiffening material can take the pattern or shape, e.g., the U- or substantially U-shaped, doughnut, ring or other configuration of the particles disposed on the base layer, usually but not limited to, on or on a portion or portions of its heel support portion.

FIG. 123B shows the undersurface of another embodiment of a soft or resilient top layer 6502 of the disclosure, this one having collar-shaped layer, disc or piece of anti-indenting stiffening material SM placed along the medial side and slightly rear and forward of central area 6522 of heel support portion 6512. Such a designed layer, disc or patch would protect a wearer's sensitive medial peripheral heel area while not protecting heel central area 6522, or the lateral heel support area. An example of a suitable, preferred anti-indenting stiffening material SM is a two adhesive sided tape 9030 and/or a firm spacer layer, disc or patch, e.g., cardboard. Examples of other suitable stiffening materials SM are canvas, leather, polymeric, thermoplastic, elastomeric, cloth, cork, cork blends, duck tape, plumber's or electrician's tape and like materials that are firm enough to protect wearer's heels from uncomfortable irregular or uneven surfaces caused by underlying particles. Suitable stiffening materials preferable are flexible enough to allow the insole/midsole, etc., to flex for the purposes intended.

FIG. 123C shows a ⅔rds length base support layer 2402 having its forward portion covered with two-adhesive sided tape T and having a portion of its underlying heel support portion 6312 (dashed line) covered by particles 2330. The particles are disposed in a substantially U-shaped configuration, here shown as a ring or doughnut, with particles 2330 disposed on and about peripheral area 6324 of heel support portion 6312, while leaving a surface overlying central area 6322 of the heel support portion not covered with particles. Some of particles 2330 are disposed on base layer 2402 in or on a forward area, generally designated FA, that is, an area that is forward of heel support portion 6312. In the embodiment of FIG. 123C, the top portion of particles extending into forward area FA can but need not be skived. Instead of being skived, the layer or top portion of these particles can be fine particles. In the central area marked with an X, there is an underlying spacer layer of resilient or cushioning material such as 8200′ (dashed line). Layer 8200′ can be from about 1 mm to about 2 mm thick. The forward edge of spacer layer 8200′ (not visible in FIG. 123C) can be skived to smooth, for the wearer's foot, the transition from the forward edge to particles 2330. The top layer or portion of particles 2330 can be skived to smooth the transition of particles from the forward portion of peripheral area 6324 to and beyond the forward edge of the heel support portion to or beyond transverse arch support portion 6313. In FIG. 123C, on top of underlying cushioning layer 8200′ there can be a spacer layer 8210 (not shown) of anti-particle indenting firm or stiffening material SM, e.g., cardboard, (not shown) covered on each of its surfaces with adhesive. The lower surface of adhesive is adhered to the underlying cushioning layer 8200′ and the upper layer of adhesive is covered by a releasable paper strip PS that is marked with an X.

FIG. 123D shows the bottom surface of a full length top layer 6502 that is ready to be joined to a full length, or ⅔^{rd} length base support layer such as shown in FIG. 123C. More particularly, FIG. 123D shows an ellipsoidal shaped collar C of cross hatched firm or stiffening material SM, preferably a two-adhesive sided tape, that is secured to the bottom surface of top layer 6502. Collar C has a carved out central opening 9220 through which is exposed the bottom surface of top layer 6502. Collar C is configured to surround the heel support central area 6522 of top layer 6502 when the bottom surface of top layer 6502 is secured to base support layer 6402. Top layer 6502 can be comprised of an ethylene vinyl acetate material that is exposed through central opening 9220. After removing paper strip layer PS of FIG. 123 C from the central portion of base layer 6402, top layer 6502 can be inverted (heel to toe) and adhesively secured to base support layer 6402. This can be accomplished by placing the respective central areas or portions of the heels of the top layer and base layer in interfacing X-X adhesive contact and placing the forward portion of top layer 6502 on and adhesively securing it to the adhesive tape-covered forward portion of top layer 6502. The ellipdoidal shape of firm, stiffening adhesive collar C will lie over and secure the ring or doughnut-shaped configuration of beads 2330. The forward portion of the beads of the ring or doughnut of base layer 2402 will be covered by the forward portion of collar C, thereby providing a smooth transition forward from an area containing beads to an area of no beads. The skiving of beads would not be needed, especially if fine beads are suitably used in the forward area of the ring or doughnut.

Thus, it is contemplated that a patch, e.g., an egg-like shaped patch can be employed to stiffen and protect from a wearer's foot, for example, an entire or portion of a heel support portion, and/or of a peripheral area 6324, and/or of a substantially U-shaped portion, and/or other desired specific area(s), and the patch can be shaped to extend forward of and beyond the specific portion, e.g., the heel support portion and help provide a smooth transition from it to, for example, a transverse arch.

It is contemplated that layers, pieces, discs, patches, collars, etc., of stiffening material SM can be provided in any desired shape or configuration and employed in or at any desired location(s), to protect or benefit entire or specific heel and/or other portion(s) of the wearer's foot.

The above mentioned and other suitable firm or stiffening materials SM and layers, pieces, discs, patches, collars, etc. achieve an objective of the disclosure, that is, to prevent particles from protruding upwardly into the undersurface of and/or from the upper surface of the heel support portion 6312 of a top layer and from being uncomfortable to the wearer's heel. It is understood that if top layer 6502 is itself comprised of a stiff or firm material SM, then special patches or pieces may not be needed to stiffen the top layer material.

FIG. 124 is a vertical section through the heel support portion 6312 of a base layer 6402 having a peripheral wall 6326 that preferably is substantially vertical to a base bottom wall 6313. FIG. 124 shows a heel cup assembly or unit 8300, which can be comprised of a flexible package 9000 as shown in FIGS. 115 and 119 through 122. In this embodiment, flexible package 9000 has a substrate layer of a bottom resilient shock absorbing layer 8200′ whose bottom surface preferably is adhered to heel support portion 6312 of base bottom wall 6313 of a base layer 6402 and whose top surface preferably is adhered to an optional overlying elevating spacer layer 8210. The upper surface of spacer layer 8210 is secured, preferably adhered by an adhesive layer to the bottom surface of the central area 6522 of top layer 6502 which can be of any foot length, including ⅓^{rd} length. Spacer layer can be from about 1 mm to about 3 mm thick and can have a Durometer of for example from about 70 to about 80. Spacer layer 8210 preferably is firm to prevent particle indentation into the bottom surface of a resilient top layer. Spacer layer 8210 may not be needed or may be resilient if the top layer itself is firm, or the undersurface of heel support central area 6522 of the top layer is patched with a firm or stiffening material, as discussed in connection with FIGS. 123A, 123M, 123B and 123D. Shock absorbing layer 8200′ can be any suitable thickness, for example, from about 1 to about 2 mm.

FIG. 124 shows that top layer 6502, which can be of any suitable foot length, including ⅓^{rd} length, has its central area 6522 adhered to spacer layer 8210, and also has portion(s) of the upper edge of its peripheral wall secured, preferably adhered to portions of peripheral wall 6326 of base layer 6402. Preferably, the mid-height areas of peripheral wall have an air vent hole 6654 to vent the cavity 6365 of heel cup assembly or unit 8300. By vacuum forming a top layer 6502 of soft material, one can obtain a radiused or bowl-like heel portion while retaining its softness and thereby facilitating movement and adaptation of particles within the channel of package 9000 to fit and support the wearer's heel. In heel cup assemblies and units, neither the peripheral wall 6326 of base layer 6402 nor the outer wall of package 9000 need be substantially perpendicular.

The insole/midsole of the disclosure permits adaptation and customization of the insole/midsole to the wearer's foot. An aspect of this relates to arch elevation in a wearer's foot. Generally, the base layer molded-in or built-in dome contoured metatarsal arch support is designed and allowed to lower to the arch elevation of the wearer's foot. A foot with a high arch places very little downward force on the built-in domed contoured metatarsal arch and therefore the dome contour remains high. A foot with a medium height arch places relatively more downward force on the molded-in domed contoured arch support. A foot with a low arch places relatively more downward force on the molded-in domed contoured arch support, and the domed support lowers to a lower level. According to the disclosure, for each of the levels, the wearer has the option of securing to the bottom surface of the contoured dome arch support of the base layer, a bottom support post that corresponds to the size and shape of the particular concave dome and that has the desired resistance needed, to prevent the molded-in arch from lowering below the wearer's natural arch elevation, unless it is desired to be allowed under certain circumstances such as running or carrying heavy weights.

Another aspect of this disclosure is that the heel support portions and peripheral sidewalls of insoles/midsoles can be customized to heel widths and the height of the arches of the wearer's foot. For example, because the particles disposed on the heel support portion of the base layer migrate or move outward and upward when subjected to foot pressure, high peripheral walls above the heel support portion can be employed to accommodate particles in the peripheral area of the heel support portion that are forced radially outward and upward by wide heels and for example, low arches. The higher sidewalls allow space for the forced particles to move upward between the peripheral walls of the base layer and of the upper layer of the insole/midsole. High peripheral walls about the heel support portion can be about 32 or 33 mm high, while the peripheral wall portion about the medial arch can be about 30 mm high. Such high peripheral wall portions accommodate high arches, and adjust downward to adapt for mid and lower arch elevations. This provides improved heel/particle contouring. For feet with narrow heels and high arches, fewer particles will be forced outward and upward and, therefore, the peripheral walls will provide the narrow heel with a snug, high fit. For the medium width heel with a medium height medial arch, only those particles that experience pressure will migrate outward and upward, but not to the extent that occurs with a wide heel and a low arch.

In manufacturing an insole/midsole, it is contemplated that a generic dummy foot shape preferably having a narrow heel will be used to initially establish the contour of the particles disposed in the heel support portion. In the preferred approach, small air evacuation holes are provided through the peripheral walls to allow air to be forced out when a wearer first steps into the insole/midsole. Because the preferred particles will be coated or doped with lubricant, sealant or material with bibdibg adhesive properties as disclosed, it is envisioned that depending on the selected quantity of particles, the amount of lubricant used and their respective locations relative to the air holes, the holes will be exposed and air will enter or reenter them, or the holes will be blocked and air will not enter or reenter the holes. By “small” it is meant, for example, holes having a diameter of from about 1/32 to about ⅛ inch.

Another aspect of the adaptation and customization of the insole/midsole to the wearer's foot is that the insole/midsoles of the disclosure preferably have one or any combination of built-in or molded-in arch support contours, preferably with, or without, particles disposed thereon, to support the one or combination of transverse, medial, lateral and/or metatarsal arches of the wearer's foot. It is estimated that for a base layer initially 1 mm thick having cloth or cotton upper and bottom surfaces coated with fiberglass resin and therefore, having a 1½ to 2 mil thickness, a downward pressure of about 1 lb. results in about a 1 mm downward movement of a dome contoured metatarsal arch support. It is estimated that the addition of resin coated cloth layers renders the coated base layer from about 200 to 300% stronger. At about 2 pounds of pressure from the arch plantar surface, there is continued downward deflection of the domed anatomical contour of the medial arch support of the base layer. For feet with low arch profiles, the dome contoured medial arch support of the base layer engages the low medial arch profile sooner, and with the application of about 2 to 3 or 4 pounds of pressure, the dome contoured support yields and continues to deflect downward with from about 10 to about 20 pounds of pressure until the applied force ceases and the arch support resistance equals the downward force exerted. For higher arched feet, little downward force is applied to the dome contoured medial arch support. When the foot with a medium to low arch applies additional downward force to from about 10 to 20 lbs., such as during running or carrying weights, the base arch support will yield further. When the force is removed, the domed contour springs upward to its normal or initial shape.

In a further aspect of the disclosure, the respective one or combination of arch support portions can be reinforced with one or more calibrated, selected resilient supports, support blocks or patches having an appropriate resistance or strength to provide the correct or desired support and comfort. The use of supports, e.g., support blocks, or patches can help built-in or molded-in contour arch supports retain or return to their original or near original contour and can protect the contoured arch supports from stress fatigue. With respect to another embodiment of the insole/midsole of the disclosure, it has been determined that for a base support layer having built-in or molded-in one or a combination of transverse, medial, lateral and/or metatarsal arch support portions, one support block or patch placed centrally under the longitudinal medial outer edge arch will effectively support all of the aforementioned arch supports. Generally, built-in or molded-in arch support contours for feet with low arches may require more support than feet with high arches would require. It is understood that in addition to utilizing one or more selected supports to return arch supports to their original or near original contours, one can also or instead employ a more rigid or stiff base layer or dome material.

Thus, the base layer arch support portions with or without particles or additional applied supports, can be designed to provide a built-in or molded-in dynamic effect that provides controlled deflection or spring return support and comfort as desired. In accordance with the disclosure, for example, a domed medial or metatarsal arch support can be designed to have 100% memory return upon removal of the foot pressure, or to lower to a weighed down level where it will remain upon removal of foot pressure, or to lower a wearer's arch elevation to a selected level determined and achieved by one or more selected bottom surface base layer support portions. The beads custom fit the heel, keeping it in a natural position. In doing so, the wearer's arch is held higher, thereby taking downward pressure off of the anatomical arch support. This helps prevent or reduce medial pronation.

In an embodiment of this disclosure, particles are disposed on the heel support portion of a base support layer of an insole/midsole that may or may not have has any one or combination of built-in or molded-in transverse, medial, lateral and/or metatarsal arch support portions.

In another embodiment of the disclosure, the heel support portion of the base layer does not have particles disposed thereon, but any one or combination of the transverse, medial, lateral and/or metatarsal arch support portions will be supported by particles disposed thereon or adjacent thereto. In such an embodiment, it is contemplated that the heel support can be provided by a non-particulate approach such as a cushion of gel or air.

In an embodiment of a heel cup of the disclosure, it has been found preferable that the base layer for the heel cup include a built-in or molded-in transverse arch support portion. If a base layer for the heel cup is not provided with a built-in or molded-in transverse arch support, particles deposited in the peripheral area of the heel support portion may be extended forward of the lateral heel portion to support all or a portion of the transverse arch support. The particles that are extended forward to the lateral transverse arch can also be extended slightly further forward to also support the lateral arch. A combination of both particles on a built-in or molded-in arch support would compliment the transverse arch support.

This disclosure contemplates a heel cup that also includes a portion, albeit a small portion of the medial arch. It is contemplated that by adding the aforementioned extra support, the immediate controlling motion of the heel would be greatly improved.

Extending the base layer of the heel cup beyond ⅓ rd of a foot length, and including portions of the forward metatarsal arch would cause the base layer to be considered too long to be a heel cup, but appropriate for a ⅔ foot length base layer.

In embodiments of the disclosure, particles disposed about the peripheral area of the heel support portion of a base layer can be extended forward toward the forward edge of the heel support portion and/or adjacent to or on the transverse arch. In these embodiments, the forward edge of the dispersed particles can comprise a reduced number of particles and/or very small particles, or the particles can be at least partly covered by a band, tape or caulking, or like or sufficient material to smooth out or skive, thin or taper the forward edge of the particles in their transition to, for example, the surface of a built-in or molded-in arch support portion. Skiving can be effected in any suitable manner to any suitable portion(s) of the insole/midsole or heel cup of the disclosure to blend or smooth the surface of particles with adjacent particles or an adjacent surface or portion of a base layer or adjacent cushion layer or spacer. The band, tape or caulking or like material also helps prevent forward movement of the particles.

In a preferred embodiment of a base layer of the disclosure, the base layer is made of a 1.5 mm thick polypropylene that is vacuum formed with a heel support portion and anatomical arch support contours, and with a cloth layer laminated to both surfaces of the base layer. For insoles, usually only the inside surface layer of cloth is coated with a fiberglass or polyurethane resin. For midsoles that are part of the main shoe or footwear construction, it is possible that one or more portions or the entire bottom surface of the base layer can also be coated with fiberglass resin.

In embodiments of the disclosure, the base layer can also be made of polyethylene, injection molded or sheet type, vacuum formed; a graphite material, vacuum formed; or various suitable plastic(s) material(s). If sheet material is used, preferably it is cloth coated so that it can be fiberglass coated for extra strength. It is desirable that a cloth coating or layer be provided on the inner surface of at least the peripheral wall of a base layer made of, for example, polypropylene, because adhering the outer surface of the peripheral wall of a top layer to the cloth coating or layer on the inner surface of the base layer is easier and provides better adhesion to the cloth layer than to an uncoated, bare polypropylene surface.

In embodiments of the disclosure, the junction of the peripheral wall and heel support portions of the base layer can be formed with a suitable curvature, formed by a radius that can range from 0 to about 25 mm, more preferably from about 0 to about 12 mm, and most preferably from about 0 to about 7 mm.

In an embodiment of the disclosure, the upper surface of the heel support portion of the base layer can be lower by from about ⅛ inch to about 3/16 inch than the upper surface of the base layer that supports the ball of the wearer's fore foot. This allows for deposition of a backfill of about 3/16 inch or 3 mm of particles or of a spacer of cushioning material onto the upper surface of the heel support. As a result, the backfill level of the heel support portion is level with the ball of the wearer's fore foot. Without starting with the aforementioned lower initial level of the heel support portion deposited particles would raise the level of the heel above that of the fore foot and raise the foot arch off of the shell arch support portion.

In embodiments of the disclosure, any one or combination of built-in anatomical arch support contours can be formed by particles alone, e.g., to form an arch support portion, e.g., to form a transverse or other arch support portion that was not molded into a base layer when the base layer was initially formed, or by particles disposed adjacent to or about molded-in contours, which particles strengthen the portion of the base layer bearing the particles, and/or strengthens or increases the size of the molded-in contour. With respect to the use of particles in connection with molded-in anatomical contours, it is preferred that the particles that are employed should be employed leading to, adjacent to or on or about, but not fully covering the top of the molded-in contours. It is understood that built-in and/or molded-in anatomical contours, whether or not formed or strengthened by particles, can be strengthened or rendered more resistant to or more recoverable from deflection by use of block supports, supports, patches, cushions, etc. secured, removably or not, to the chosen bottom surface of the base layer, or contoured portion. The material, size, yield, rigidity, stiffness or thickness and other properties of the support(s) can be chosen according to the application.

Although it is preferred to have the central area, e.g., 6322, of a base support layer, e.g., 6402, devoid of particles to prevent particles from protruding through the heel portion of a soft or resilient top layer, e.g., 6502, and possibly causing discomfort to the wearer's heel, in embodiments of the disclosure, there can be particles in the central area of base support layer. Preferably, the particles there are not exposed on or their shape does not protrude into or through the top surface of the uppermost member or layer located in the central area. To this end, the particles can be covered with a cushioning layer, or with a firm or stiffening spacer layer to prevent protrusion from the upper surface of the uppermost member or layer. Preferably, the particles present in or on the base layer, whether exposed or unexposed, are small, or fine, e.g., about 0.5 mm. Alternatively, discs, pieces or layers of stiffening material SM, e.g., double sided adhesive tape, can be adhered in select locations to the bottom surface of the soft top layer 6502 so that when the top layer is joined to the base layer, the piece of material SM will be aligned with and secured in protective interfacing contact with the exposed or protruding particles on the top surface of the member on the heel portion of the base layer. Alternatively, a firm rather than soft top overall layer 6502 with requisite moderate flexibility can be employed to prevent the exposed particles or protruding surfaces from affecting the wearer's comfort.

In embodiments of the disclosure, it is contemplated that particles can be deposited directly on the top surface of the heel support portion of a base support layer (see, for example, FIG. 65), or particles can be deposited or occur about or around or on support pads and/or spacer pads, it is preferred that the top surface of such pads be clear of particles. It is also contemplated that such pads, can be under, on or surrounded or partly or substantially surrounded by particles and can be resilient or firm and/or can include resilient or firm layers.

In embodiments of the disclosure, a smooth transition can be provided from a pad, card board or other member, or from a beaded or particle area, to an adjacent area in several ways. The transition edge of the pad or member can be skived, shaved, thinned or tapered to smoothly transition from the thicker portion to the thinner portion. To effect smooth transition from a beaded or particle area to an area of less or no beads or particles or to a structural surface such as a transverse arch support portion of a base member, the beads or particles can likewise in effect be skived, shaved, thinned or tapered. For example, the amount or thickness of the beads can be reduced to less or none or their size can be reduced from one or more larger diameters to one or more smaller diameters or fine beads or particles. For example, with respect to a ⅔rds foot length base layer 7402, such as shown in FIG. 106D, and having a layer of moderately sized particles 6330 disposed about peripheral area 7424 and extending to either side of pad layer 7450′ (or for example to either side of a card board center strip (not shown)) and toward the forefoot portion of the base layer, instead of having crosshatched portions of tape, could have smaller diameter particles there, to provide a smooth transition from the denser layer of moderately sized particles on the peripheral area to sparser amount of smaller sized or fine particles forward of heel support portion 7412. Further with regard to providing a smooth transition, a band or tape such as the crosshatched tape shown on FIG. 106d can be laid over the particles in the transition area or edge to secure the particles in the desired smooth transition effect.

In embodiments of the disclosure, ribs, preferably longitudinally extending and disposed along the bottom surface of the base layer, can be employed to provide strength and/or memory to the base layer. The ribs can be parallel, at any angle or angles to the longitudinal axis, or they could be disposed in a radial, sunburst, arcuate or crossing or other suitable pattern or combination of patterns.

The claims appended hereto complement and further disclose the teachings of the present invention. The entirety of the application is to be considered regarding the scope, intent and disclosure of the present application. For instance, the method of the present invention for measuring a plantar contour of a foot and the method of obtaining a 3-D contour of a subject object in general include all of the various aspects of the disclosed devices. That is, the methods of the present invention are completely and fully compatible with the devices of the present invention. The term particles includes, but is not limited to, beads, fibers, and strands.

What is claimed is:

1. An insole for placement in or on an article of footwear to support all or a portion of a wearer's foot, comprising:
a base shell support layer having an upper surface, wherein the base layer includes a heel support portion,
a plurality of substantially rigid particles disposed on the heel support portion, and
an upper layer, the upper layer overlying and being secured to the base layer, the upper layer overlying the particles and maintaining them in an area between the upper layer and the base layer.

2. The insole of claim 1, wherein the heel support portion includes
a central area,
a peripheral area substantially surrounding the central area, and
a peripheral wall substantially surrounding the peripheral area,
wherein the plurality of particles are disposed on the peripheral area of the heel support portion.

3. The insole of claim 2, wherein the central area is substantially devoid of particles.

4. The insole of claim 1, wherein the base layer includes, forward of the heel support portion, any one or combination of
a transverse arch support portion, a medial arch support portion, a lateral arch support portion and a metatarsal arch support portion, and the plurality of particles is also disposed on the any one or combination of arch support portions.

5. The insole of claim 4, wherein the any one or combination of arch support portions has a built-in anatomical contour.

6. The insole of claim 5, wherein the base layer has an undersurface, and a support is mounted to the undersurface in the area of the transverse arch support.

7. The insole of claim 2, wherein some of the plurality of particles are disposed directly on the peripheral area of the heel support portion and are adhered to the heel support portion.

8. The insole of claim 7, wherein some of the plurality of particles disposed on the peripheral area of the heel support portion are coated with a tacky viscous material having non-hardening, binding adhesive properties and are disposed on the plurality of particles that are adhered to the heel support portion.

9. The insole of claim 1, wherein the insole is the full length of the wearer's foot.

10. The insole of claim 1, wherein the insole is ⅔rds the length of the wearer's foot.

11. The insole of claim 1, wherein the insole is the ⅓rd the length of the wearer's foot.

12. The insole of claim 1, wherein the base shell support layer is semi-rigid and comprised of a polyolefin.

13. The insole of claim 12, wherein the base shell support layer has an outer surface, the polyolefin is polypropylene and the outer surface of the polypropylene is covered with a cloth layer that is coated with a fiberglass resin.

14. The insole of claim 2, wherein the peripheral wall includes one or more small air vent holes therethrough.

15. The insole of claim 14, wherein there is a plurality of the holes through the peripheral wall and the holes are spaced from each other and located up to about mid-height of the peripheral wall.

16. The insole of claim 15, wherein there is at least one hole through the respective medial, rear and lateral sides of the peripheral wall.

17. The insole of claim 1, wherein the peripheral wall of the heel support portion of the base layer is substantially vertical relative to the upper surface of the heel support portion of the base layer.

18. The insole of claim 1, wherein the peripheral wall of the heel support portion of the base layer is disposed at an angle of from about 90 degrees to about 110 degrees relative to the upper surface of the heel support portion of the base layer.

19. The insole of claim 1, wherein the peripheral wall of the heel portion of the base layer extends upwardly and has an upper edge, and the peripheral wall of the heel portion of the upper layer extends upwardly and has an upper edge that is higher than the upper edge of the peripheral wall of the base layer.

20. The insole of claim 19, wherein the height of the peripheral wall of the upper layer is from about 1 inch to about 1½ inch measured from the upper surface of the heel support portion of the upper layer.

21. The insole of claim 20, wherein the height of the peripheral wall of the base layer is from about ⅝ inch to about 1¼ inch measured from the upper surface of the heel support portion of the base layer.

22. The insole of claim 17, wherein the upper layer of the insole has a heel support portion, the heel support portion of the upper layer has a bottom wall and an upwardly extending peripheral wall,
the bottom wall and/or the peripheral wall of the upper layer has or have a radius of curvature and is or are bowl-shaped when viewed in vertical section, and
the substantially vertical peripheral wall of the base layer and the bowl shape of the bottom wall and/or peripheral side wall of the upper layer are secured together to form a cavity therebetween.

23. The insole of claim 22, wherein the peripheral wall of the heel support portion includes a plurality of small air holes open to ambient atmospheric pressure and which communicate with the cavity.

24. The insole of claim 2, wherein the peripheral area has particles disposed thereon, it is substantially C-shaped, and the open portion of the C-shape faces toward the metatarsal arch support portion of the insole.

25. The insole of claim 2, wherein the peripheral area has particles disposed thereon and has an annular shape.

26. The insole of claim 2, wherein the central area includes a resilient support pad that is adhered to the upper surface of the base layer.

27. The insole of claim 1, wherein the base layer has one or both a bottom surface and a top surface, and one or both surfaces has a layer of cloth thereon.

28. The insole of claim 27, wherein one or both cloth layers includes a fiberglass resin.

29. An insole for placement in or on an article of footwear to support the planter surface of a wearer's foot, comprising:
a base shell support layer having an upper surface, wherein the base layer includes one or a combination of a heel support portion, a medial arch support portion, a lateral arch support portion, and a metatarsal arch support portion,
a plurality of particles disposed on one or more of the arch support portions of the base layer, and
a semi-flexible upper layer having a bottom surface, the upper layer overlying and being secured to the base layer, the upper layer overlying the particles and maintaining them in an area between the upper layer and the base layer.

30. The insole of claim 29, wherein the particles are selected from the group consisting of rigid, substantially rigid, semi-rigid, and resilient.

31. The insole of claim 29, wherein the plurality of particles are substantially rigid, they are disposed on the peripheral area of the heel support portion, there is included a transverse arch support portion and there is a smooth transition from the particles of the peripheral area to the transverse arch support portion.

32. The insole of claim 31, wherein the plurality of particles has a forward area and the smooth transition from the forward area of the particles of the peripheral area to the transverse arch support portion is provided by a tape in contact with the forward area of the particles.

33. The insole of claim 29, wherein the particles are disposed on the heel support portion and on the one or combination of the arch support portions,
wherein the particles disposed on the heel support portion of the base layer cover at least a portion of the upper surface of the heel support portion, and continuously extend forward from the heel support portion along the longitudinal axis of the base layer and cover the metatarsal arch support portion to either side of the longitudinal axis of the base layer.

34. The insole of claim 33, wherein the particles disposed on the heel support portion of the base layer cover the upper surface of the peripheral and forward area of the heel support portion.

35. The insole of claim 29, wherein the base layer has a bottom surface and a resilient foam cushion having reinforcing ribs is secured to the bottom surface of the base layer.

36. The insole of claim 29, wherein the one or combination of arch support portions of the base layer has a built-in raised domed contour.

37. The insole of claim 24, wherein the particles disposed on the peripheral area of the heel support portion are contained in a sealed flexible package that resembles the peripheral area of the heel portion, to facilitate disposition of the particles in the periphery of the heel portion.

38. A heel cup for placement in or on an article of footwear, comprising:
a base shell support layer having an upper surface and having
a heel support portion in turn having:
a central area,
a peripheral area substantially surrounding the central area, and a peripheral wall surrounding a portion of the peripheral area,
a plurality of particles disposed on and held to the peripheral area of the heel support portion, and
an overlayer secured to the base layer and overlying the plurality of particles in at least the peripheral area of the heel support portion and maintaining the plurality of particles in an area between the overlayer and the base layer.

39. The heel cup of claim 38, wherein the central area includes a resilient support pad having an upper adherent layer and having a bottom surface that is adhered to the upper surface of the central area.

40. The heel cup of claim 23, wherein the heel cup includes a transverse arch support portion, there is a plurality of particles disposed on and held to the transverse arch support portion, and there is a smooth transition from the particles of the peripheral area to the particles of the transverse arch support portion.

41. The heel cup of claim 38, wherein the smooth transition from the forward area of the particles of the peripheral area to the transverse arch support portion is provided by a tape material.

42. The heel cup of claim 38, wherein the heel cup is ⅓rd the length of the wearer's foot.

43. An insole for placement in or on an article of footwear to support the planter surface of a wearer's foot, comprising:
a base shell support layer having an upper surface and a bottom surface, wherein the base layer upper surface includes one or more built-in anatomical contours to support the wearer's foot,
a plurality of particles disposed directly or indirectly on the upper surface of the base layer, and
a flexible upper layer,
wherein the upper layer overlies and is secured to the base layer and maintains the particles in an area between the upper layer and the base layer, and wherein the plurality of particles are selectively disposed and provide the one or more built-in anatomical contours.

44. The insole of claim 43, wherein the particles are substantially rigid.

45. The insole of claim 43, wherein the insole includes one or more of a built-in peripheral heel support portion, a built-in medial arch support portion, a built-in lateral arch support portion, a built-in transverse arch support portion, and a built-in metatarsal arch support portion, and wherein one or more of these built-in support portions is or are provided by the particle-provided built-in anatomical contours.

46. An insole for placement in or on an article of footwear to support the planter surface of a wearer's foot, comprising:
a semi-rigid base shell support layer having an upper surface and a bottom surface, wherein the base layer upper surface includes one or more built-in, molded anatomical contours to support the wearer's foot,
a plurality of substantially rigid particles disposed directly or indirectly on the upper surface of the base layer, including on or adjacent the one or more built-in, molded anatomical contours,
a flexible upper layer,
wherein the upper layer overlies and is secured to the base layer and maintains the particles in an area between the upper layer and the base layer, and wherein the selectively disposed plurality of particles customize the one or more built-in molded anatomical contours.

47. The insole of claim 46, wherein the insole includes one or more of a built-in molded peripheral heel support portion, a built-in molded transverse arch support portion, a built-in molded medial arch support portion, a built-in molded lateral arch support portion and a built-in molded metatarsal arch support portion, and wherein the selectively disposed plurality of particles are disposed on and customize the one or more built-in molded anatomical contours.

48. The insole of claim 46, wherein the insole includes a built-in molded peripheral heel support portion, and the plurality of particles are selectively disposed on and customize the built-in molded peripheral heel support portion.

49. The insole of claim 43, wherein one or more supports is or are added to the bottom surface of the base shell under the one or more the built-in anatomical contours to strengthen the one or more the built-in anatomical contours.

50. The insole of claim 43, wherein the one or more supports is a solid material to prevent compression of the one or more built-in anatomical contours imparted by downward pressure of the wearer's foot.

51. The insole of claim 43, wherein the one or more supports is a semi-flexible material applied to selectively control the amount of compression, by allowing some but limited compression.

52. The insole of claim 46, wherein one or more supports is or are added to the bottom surface of the base shell under the one or more of the built-in molded anatomical contours to strengthen the one or more of the built-in molded anatomical contours.

53. A flexible package for containing a plurality of particles therein, comprising:
a main body comprised of a flexible film and having a substantially annular-shape when seen in top plan view, the main body having a channel running therethrough for containing the plurality of particles therein.

54. The flexible package of claim 53, wherein the channel is triangularly shaped when viewed in vertical section.

55. The flexible package of claim 53, wherein the channel contains a plurality of particles.

56. A heel cup for placement in or on an article of footwear, comprising:
a base shell support layer having an upper surface,
a heel support portion including
a central area,
a peripheral area substantially surrounding the central area, and
a peripheral wall substantially surrounding the peripheral area,
a flexible package including:
a main body comprised of a flexible film having a substantially annular shape when seen in top plan view, the main body forming a hollow channel running therethrough and that contains a plurality of particles, the main body being disposed on the peripheral area of the heel support portion, and
an upper layer, the upper layer overlying and being secured to the base layer, the upper layer overlying the flexible package of particles and maintaining them in an area between the upper layer and the base layer.

57. The heel cup of claim 56, wherein the main body of the flexible package is substantially triangularly shaped when viewed in vertical section.

58. The heel cup of claim 56, wherein the height of the peripheral wall of the base layer around the periphery of the heel support portion is from about ⅝ inch to about 1¼ inch measured from the upper surface of the heel support portion.

59. The heel cup of claim 58, wherein the height of the peripheral wall of the upper layer around the periphery of the heel support portion of the upper layer is from about 1 inch to about 1½ inch, measured from the upper surface of the heel support portion of the upper layer.

60. The heel cup of claim 59, wherein the particles are semi-rigid.

61. An insole for placement in or on an article of footwear to support all or a portion of a wearer's foot, comprising:
a semi-rigid base shell support layer having an upper surface, and a heel support portion, the heel support portion including
a central area,
a peripheral area substantially surrounding the central area, and
a peripheral wall substantially surrounding the peripheral area,
wherein the base layer includes, forward of the heel support portion, any one or combination of
a transverse arch support portion,
a medial arch support portion,
a lateral arch support portion, and
a metatarsal arch support portion, and
a plurality of particles disposed on the any one or combination of the arch support portions, and
an upper layer, the upper layer overlying and being secured to the base layer, the upper layer overlying the particles and maintaining them in an area between the upper layer and the base layer.

62. The insole of claim 61, wherein the peripheral area of the heel support portion includes a cushion of gel or air.

63. A method for forming an insole for placement in or on an article of footwear to support all or a portion of a wearer's foot, comprising:
providing a base shell support layer having an upper surface that includes a heel support portion,
disposing a plurality of substantially rigid particles on the heel support portion,
securing at least a portion of the plurality of particles directly or indirectly to the heel support portion,
providing a flexible upper layer that is sized to fit within the base shell support layer, and
securing the upper layer to the base layer in a manner that includes maintaining the particles in an area between the upper layer and the base layer.

64. The method of claim 63, wherein the providing of the base shell support layer includes
providing heel support portion with
a central area,
a peripheral area substantially surrounding the central area, and
a peripheral wall substantially surrounding the peripheral area, and
disposing the plurality of particles on the peripheral area of the heel support portion.

65. The method of claim 63, wherein the providing of the base shell support layer includes
providing a cloth layer secured to the outer surface of the base layer, and
coating the cloth layer with a fiberglass resin.

66. The method of claim 63, wherein the securing of at least a portion of the particles directly or indirectly to the heel support portion is effected by applying to the particles and/or to the heel support portion a tacky viscous lubricant that has non-hardening binding adhesive properties.

67. The method of claim 64, wherein the securing of the particles directly or indirectly to the heel support portion is effected by
providing the particles in a flexible package shaped like the peripheral area, and
securing the flexible package to the peripheral area of the heel support portion.

68. A method for custom fitting an insole for placement in or on an article of footwear to support a wearer's foot, comprising:
providing a base shell support layer having an upper surface and an undersurface, the upper surface including a heel support portion with a peripheral area, and the undersurface including any one or combination of upwardly extending molded-in convex anatomically contoured arch support portions to support the arch portions of the wearer's foot,
modifying the upper surface of the base layer by
disposing a plurality of particles on the peripheral area of the heel support portion,
securing a first portion of the plurality of particles directly or indirectly to the peripheral area of the heel support portion, and
disposing a second portion of the plurality of the particles onto the first portion of the particles, the second portion of particles being coated or doped with a tacky viscous material having non-hardening binding adhesive properties, to allow the second portion of particles to migrate to fit the contour of the wearer's heel upon the application of heel pressure onto the plurality of disposed particles, to conform to and custom fit the heel support portion to the heel of the wearer's foot, and
modifying the undersurface of the base layer by
securing one or more supports to the undersurface(s) of the any one or combination of upwardly extending molded-in convex anatomically contoured arch support portions of the base layer, to selectively support, strengthen and custom fit the molded-in anatomically contoured arch support portions to the one or more contours of the arch portions of the wearer's foot.

69. The method of claim 68, wherein the plurality of particles are substantially rigid.

70. The method of claim 1, 29, 38, 43, 56, 63, or 68, wherein the base shell support layer is semi-rigid.

71. The method of claim 63, wherein the securing of at least a portion of the particles directly or indirectly to the heel support portion is effected by applying to the particles and/or to the heel support portion a tacky viscous material having non-hardening binding adhesive properties.

72. The insole of claim 8, wherein the tacky viscous material is a lubricant.

73. The insole of claim 8, wherein the tacky viscous material is a sealant.
